(19) United States
(12) Patent Application Publication
(10) Pub. No.: US 2025/0168578 A1
(43) Pub. Date: May 22, 2025

(54) HIGH IMPEDANCE TISSUE MOUNTING OF IMPLANTABLE TRANSDUCER

(71) Applicant: COCHLEAR LIMITED, Macquarie University, NSW (AU)

(72) Inventors: Wim BERVOETS, Macquarie University (AU); Patrik KENNES, Macquarie University (AU); Guy FIERENS, Macquarie University (AU); Carl VAN HIMBEECK, Macquarie University (AU); Tiago ROCHA FELIX, Macquarie University (AU); Antonin RAMBAULT, Macquarie University (AU)

(21) Appl. No.: 18/833,023

(22) PCT Filed: Feb. 2, 2023
(86) PCT No.: PCT/IB2023/050915

§ 371 Date: Jul. 25, 2024

Related U.S. Application Data
(60) Provisional application No. 63/435,203, filed on Dec. 23, 2022.
(60) Provisional application No. 63/348,219, filed on Jun. 2, 2022.
(60) Provisional application No. 63/306,010, filed on Feb. 2, 2022.

(51) Int. Cl. H04R 25/00; H04R 17/00

(52) U.S. Cl. CPC H04R 25/606; H04R 17/00; H04R 2225/67

(57) ABSTRACT

An apparatus including an actuator, such as a piezoelectric actuator, and a first tissue interface device and a second tissue interface device spaced away from the first tissue fixation device, wherein the apparatus is at least a partially extra-middle ear cavity dual bone interface force based implantable tissue stimulation portion of a hearing prosthesis.

### CROSS-REFERENCE TO RELATED APPLICATIONS

This application claims priority to U.S. Provisional Application No. 63/306,010, entitled HIGH IMPEDANCE TISSUE MOUNTING OF IMPLANTABLE TRANSDUCER, filed on Feb. 2, 2022, naming Wim BERVOETS as an inventor. This application also claims priority to U.S. Provisional Application No. 63/348,219, entitled HIGH IMPEDANCE TISSUE MOUNTING OF IMPLANTABLE TRANSDUCER, filed on Jun. 2, 2022, naming Wim BERVOETS as an inventor. This application also claims priority to U.S. Provisional Application No. 63/435,203, entitled HIGH IMPEDANCE TISSUE MOUNTING OF IMPLANTABLE TRANSDUCER, filed on Dec. 23, 2022, naming Wim BERVOETS as an inventor. The entire contents of each application being incorporated herein by reference in their entirety.

### BACKGROUND

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In an exemplary embodiment, there is an apparatus, comprising an actuator, a first tissue interface device and a second tissue interface device spaced away from the first tissue interface device, wherein the apparatus is at least a partially extra-middle ear cavity dual bone interface force based implantable tissue stimulation portion of a hearing prosthesis.

In an exemplary embodiment, there is an apparatus, comprising a piezoelectric actuator, a first tissue fixation device and a second tissue interface device spaced away from the first tissue fixation device, wherein actuation of the actuator moves the first tissue fixation device relative to the second tissue interface device, the first tissue fixation device is attached to a first portion of skull bone of a recipient of the actuator, the second tissue interface device abuts a second portion of skull bone that is fixed relative to the first portion of skull bone and at least one of: the first portion of the skull bone and the second portion of the skull bone is a same part of the skull; the first tissue fixation device is above a natural outer surface of the skull or within 10 mm of the natural outer surface of the skull; all of the apparatus is located at least 5 mm away from a cochlea of the recipient; or the bone to which the first tissue fixation device is attached and/or the bone to which the second tissue fixation device abuts has a thickness of at least 4 mm directly beneath the respective devices.

In an embodiment, there is an apparatus, comprising an actuator, a first tissue interface device and a second tissue interface device spaced away from the first tissue fixation device, wherein the apparatus is an implantable portion of an active transcutaneous bone conduction device configured to operate over an output range up to at least 10 kHz, when the apparatus is in free space, the first tissue interface device moves relative to the second tissue interface device when the actuator is actuated, the second tissue interface device is a bone penetrating component, the second tissue interface device being a front end interface device relative to the actuator, and output of the actuator is between the first tissue interface device and the second tissue interface device.

In an embodiment, there is a method, comprising capturing ambient sound with a sound capture device and actuating an actuator assembly implanted in a human based on output of the sound capture device that is based on the captured ambient sound, wherein the actuation of the implanted actuator evokes a hearing percept in the human by applying force to two separate high impedance portions of the human's skull without using a seismic mass and without an airgap between the two portions.

In an embodiment, there is a bone conduction implant, comprising an actuator including a housing and a piezoelectric component configured to generate force in a longitudinal direction in d33 mode, the piezoelectric component being located in the housing, the housing being flexible so that the force generated by the piezoelectric component can be transferred out of the housing, a first tissue interface device in the form of a plate and/or a bone penetrating component, and a second tissue interface device in the form of a plate and/or a bone penetrating component spaced away from the first tissue fixation device, wherein the bone conduction implant is at least a partially extra-middle ear cavity dual bone interface force based implantable tissue stimulation portion of a bone conduction implant, and the bone conduction implant is an implanted portion of an active transcutaneous bone conduction device.

In an embodiment, there is a method, comprising capturing ambient sound with a sound capture device; and actuating an actuator assembly implanted in a human based on output of the sound capture device that is based on the captured ambient sound, wherein the actuation of the implanted actuator evokes a hearing percept in the human by applying force to two separate portions of the human's skull in a direction at least generally parallel to a surface of the skull.

In an embodiment, there is a bone conduction implant, comprising an actuator including a housing and a piezoelectric component configured to generate force in a longitudinal direction in d33 mode, the piezoelectric component being located in the housing, the housing being flexible so that the force generated by the piezoelectric component can be transferred out of the housing a first tissue interface device in the form of a plate and/or a bone penetrating component and a second tissue interface device in the form of a plate and/or a bone penetrating component spaced away from the first tissue fixation device, wherein the bone conduction implant is at least a partially extra-middle ear cavity dual bone interface force based implantable tissue stimulation portion of a bone conduction implant, and the bone conduction implant is an implanted portion of an active transcutaneous bone conduction device.

In an embodiment, there is an apparatus, comprising a piezoelectric actuator, a first tissue device interface, and a second tissue device interface spaced away from the first tissue device interface, wherein actuation of the actuator moves the first tissue device interface relative to the second tissue interface device, the first tissue device interface abuts a first portion of skull bone of a recipient of the actuator, the second tissue device interface abuts a second portion of skull bone that is fixed relative to the first portion of skull bone, and
at least one of:
   the entirety of the actuator is within eight mm of an upper surface of the skull bone;
   the movement of the first tissue device interface relative to the second tissue device interface is at least generally parallel to the upper surface of the skull bone; or
   the first tissue device interface and the second tissue device interface are respective bone penetrating components that extend generally normal to a direction of actuation of the actuator.

### BRIEF DESCRIPTION OF THE DRAWINGS

Some embodiments are described below with reference to the attached drawings, in which:

FIG. 1 is a perspective view of a section of the interior of a head of a human;

FIGS. 2A and 2B are schematic diagrams illustrating exemplary middle ear implants according to some exemplary embodiments;

FIG. 3 depicts an example of an implanted tube microphone utilized in conjunction with a cochlear implant;

FIGS. 4A and 4B illustrate some exemplary stroke actuators (these can be electromagnetic actuators and/or piezoelectric actuators);

FIGS. 5 and 10 depict implantation of the stroke actuator of FIG. 4B;

FIGS. 6-9 and 11 depict examples of an active transcutaneous bone conduction device;

FIGS. 12-13A and 14B depict exemplary excavations for exemplary embodiments;

FIGS. 14, 14A, 14C, 14D, 15, and 15A and 16 depict exemplary actuator implantations according to some exemplary embodiments;

FIGS. 17A-18B depict exemplary embodiments of actuator assemblies and/or components thereof;

FIG. 18C depicts an exemplary cell phone according to an exemplary embodiment;

FIGS. 19-21 and 22A-22F depict exemplary embodiments of fixation embodiments of embodiments of some actuator assemblies;

FIG. 22 depicts an implantation scenario according to an exemplary embodiment;

FIGS. 23 and 24 depict an alternate embodiment of an actuator assembly;

FIGS. 24A-24F and FIGS. 24H-24L depict yet further alternate embodiments;

FIG. 24G depicts a control/counter example;

FIGS. 25-33 depict an implantation scenario and implant embodiments;

FIG. 34 depicts an alternate embodiment of an actuator assembly;

FIGS. 35-37J depict alternate embodiments of actuator assemblies and implantation regimes thereof;

FIG. 38 depicts an alternate embodiment of an actuator assembly;

FIGS. 39-41 depict schematics having utility to describe bone growth; and

FIG. 42 is a flowchart for an exemplary method.

### DETAILED DESCRIPTION

Merely for ease of description, the techniques presented herein are sometimes described herein with reference to an illustrative medical device, namely a bone conduction device. However, it is to be appreciated that the techniques presented herein may also be used with a variety of other medical devices that, while providing a wide range of therapeutic benefits to recipients, patients, or other users, may benefit from setting changes based on the location of the medical device. For example, the techniques presented herein may be used with other hearing prostheses (at least in combination therewith), including acoustic hearing aids, bone conduction devices, middle ear auditory prostheses, direct acoustic stimulators, other electrically simulating auditory prostheses (e.g., auditory brain stimulators), etc. Some embodiments include the utilization of the teachings herein to treat an inner ear of a recipient that has and/or utilizes one or more of these devices. The techniques presented herein may also be used with vestibular devices (e.g., vestibular implants), visual devices (i.e., bionic eyes), sensors, pacemakers, drug delivery systems, defibrillators, functional electrical stimulation devices, catheters, seizure devices (e.g., devices for monitoring and/or treating epileptic events), sleep apnea devices, electroporation, etc. In further embodiments, the techniques presented herein may be used with air purifiers or air sensors (e.g., automatically adjust depending on environment), hospital beds, identification (ID) badges/bands, or other hospital equipment or instruments.

The teachings detailed herein can be implemented in sensory prostheses, such as hearing implants specifically. However, it is to be understood that the teachings herein can be applied to non-medical device components, such as, for example, cell phone or smart phone vibrators that provide an indication of an incoming call or message without sound. Thus, any disclosure herein of an actuator assembly for a prosthesis corresponds to an alternate disclosure of a cell phone and smart phone having the actuator technology herein to provide an indication of a call or message without sound but through tactile notification.

Thus, merely for ease of description, the first illustrative medical device is a hearing prosthesis. Any techniques presented herein described for one type of hearing prosthesis or any other device disclosed herein corresponds to a disclosure of another embodiment of using such teaching with another device (and/or another type of hearing device including other types of bone conduction devices (active transcutaneous and/or passive transcutaneous), middle ear auditory prostheses (particularly, the EM vibrator/actuator thereof), direct acoustic stimulators), etc. The techniques presented herein can be used with implantable/implanted microphones (where such is a transducer that receives vibrations and outputs an electrical signal (effectively, the reverse of an EM actuator), whether or not used as part of a hearing prosthesis (e.g., a body noise or other monitor, whether or not it is part of a hearing prosthesis) and/or external microphones. The techniques presented herein can also be used with vestibular devices (e.g., vestibular implants), sensors, seizure devices (e.g., devices for monitoring and/or treating epileptic events, where applicable), and thus any disclosure herein is a disclosure of utilizing such devices with the teachings herein (and vice versa), providing that the art enables such. The teachings herein can also be used with conventional hearing devices, such as telephones and ear bud devices connected MP3 players or smart phones or other types of devices that can provide audio signal output, that use an EM transducer. Indeed, the teachings herein can be used with specialized communication devices, such as military communication devices, factory floor communication devices, professional sports communication devices, etc.

By way of example, any of the technologies detailed herein which are associated with components that are implanted in a recipient can be combined with information delivery technologies disclosed herein, such as for example, devices that evoke a hearing percept, to convey information to the recipient. By way of example only and not by way of limitation, a sleep apnea implanted device can be combined with a device that can evoke a hearing percept so as to provide information to a recipient, such as status information, etc. In this regard, the various sensors detailed herein and the various output devices detailed herein can be combined with such a non-sensory prosthesis or any other non-sensory prosthesis that includes implantable components so as to enable a user interface, as will be described herein, that enables information to be conveyed to the recipient, which information is associated with the implant.

By way of background, a related technology but one different from the invention herein but with features that can be used to implement the teachings herein include features related to an implantable component of a middle ear hearing prosthesis. A middle ear transducer is operationally coupled to a receiver-stimulator, and a transducer fixation mechanism is connected to (in some embodiments, is an integral part of) the transducer, and extends from the transducer into the middle ear cavity.

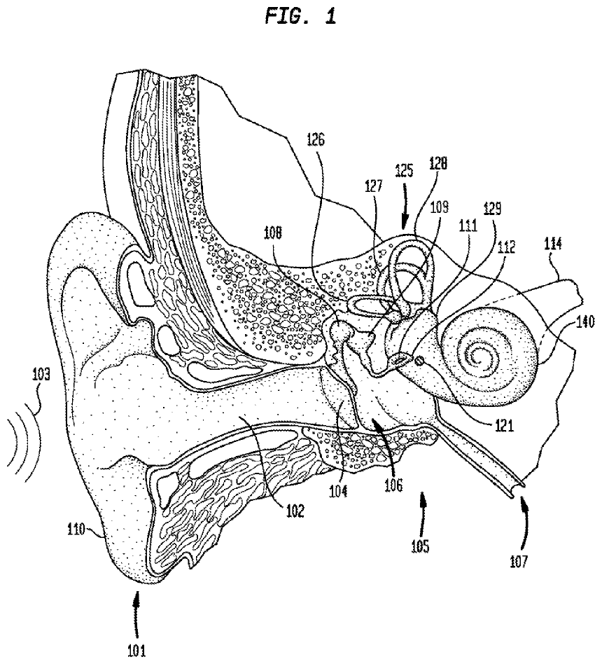

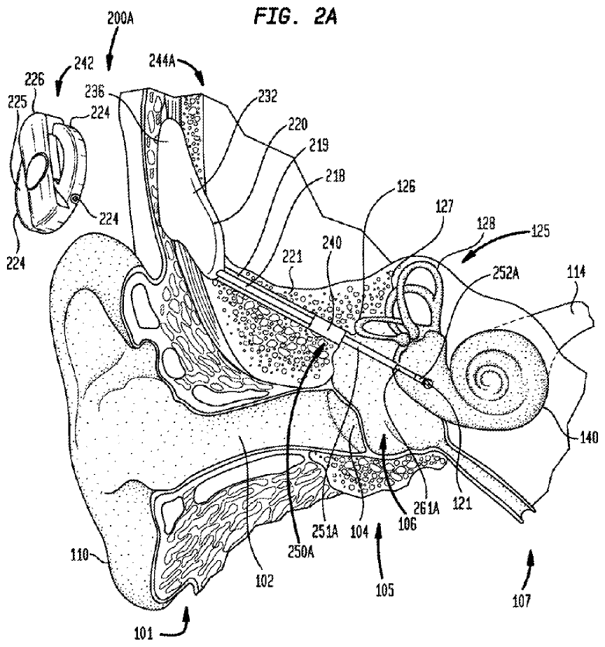

FIG. 1 is a perspective view of a human skull showing the anatomy of the human ear. As shown in FIG. 1, the human ear comprises an outer ear 101, a middle ear 105, and an inner ear 107. In a fully functional ear, outer ear 101 comprises an auricle 110 and an ear canal 102. An acoustic pressure or sound wave 103 is collected by auricle 110 and channeled into and through ear canal 102. Disposed across the distal end of ear canal 102 is a tympanic membrane 104 which vibrates in response to sound wave 103. This vibration is coupled to oval window or fenestra ovalis 112, which is adjacent round window 121. This vibration is coupled through three bones of middle ear 105, collectively referred to as the ossicles 106 and comprising the malleus 108, the incus 109, and the stapes 111. Bones 108, 109, and 111 of middle ear 105 serve to filter and amplify sound wave 103, causing oval window 112 to articulate, or vibrate in response to the vibration of tympanic membrane 104. This vibration sets up waves of fluid motion of the perilymph within cochlea 140. Such fluid motion, in turn, activates hair cells (not shown) inside cochlea 140. Activation of the hair cells causes nerve impulses to be generated and transferred through the spiral ganglion cells (not shown) and auditory nerve 114 to the brain (also not shown) where they cause a hearing percept.

As shown in FIG. 1, semicircular canals 125 are three half-circular, interconnected tubes located adjacent cochlea 140. Vestibule 129 provides fluid communication between semicircular canals 125 and cochlea 140. The three canals are the horizontal semicircular canal 126, the posterior semicircular canal 127, and the superior semicircular canal 128. The canals 126, 127, and 128 are aligned approximately orthogonally to one another. Specifically, horizontal canal 126 is aligned roughly horizontally in the head, while the superior 128 and posterior canals 127 are aligned roughly at a 45 degree angle to a vertical through the center of the individual's head.

Each canal is filled with a fluid called endolymph and contains a motion sensor with tiny hairs (not shown) whose ends are embedded in a gelatinous structure called the cupula (also not shown). As the orientation of the skull changes, the endolymph is forced into different sections of the canals. The hairs detect when the endolymph passes thereby, and a signal is then sent to the brain. Using these hair cells, horizontal canal 126 detects horizontal head movements, while the superior 128 and posterior 127 canals detect vertical head movements.

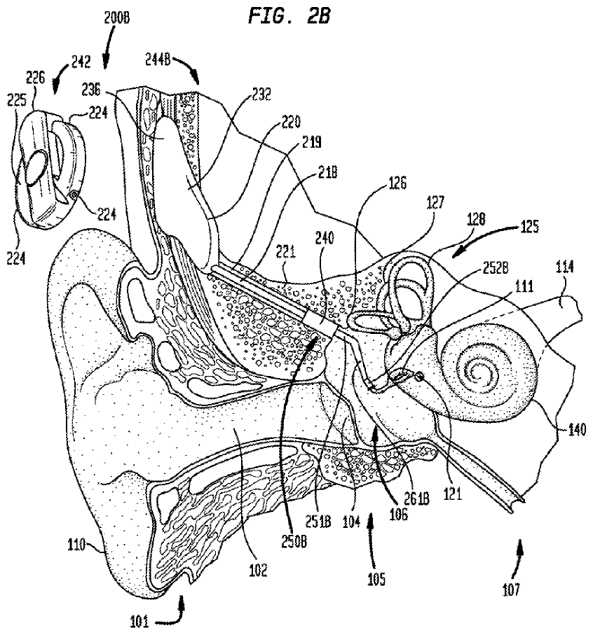

FIG. 2A is a perspective view of an exemplary direct acoustic cochlear stimulator 200A that includes features that the present invention can utilize. (Sometimes herein, this is referred to as a middle ear implant.) Direct acoustic cochlear stimulator 200A comprises an external component 242 that is directly or indirectly attached to the body of the recipient, and an internal component 244A that is temporarily or permanently implanted in the recipient. External component 242 typically comprises two or more sound input elements, such as microphones 224, for detecting sound, a sound processing unit 226, a power source (not shown), and an external transmitter unit 225. External transmitter unit 225 comprises an external coil (not shown). Sound processing unit 226 processes the output of microphones 224 and generates encoded data signals which are provided to external transmitter unit 225. For ease of illustration, sound processing unit 226 is shown detached from the recipient. Internal component 244A comprises an internal receiver unit 232, a stimulator unit 220, and a stimulation arrangement 250A in electrical communication with stimulator unit 220 via cable 218 extending through artificial passageway 219 in mastoid bone 221. Internal receiver unit 232 and stimulator unit 220 are hermetically sealed within a biocompatible housing, and are sometimes collectively referred to as a stimulator/receiver unit. The implanted coil (represented by element 236 depicting silicone over molded over a coil) is in signal communication with the receiver unit 232 via a feedthrough.

Internal receiver unit 232 comprises an internal coil (not shown directly, but again, represented by the silicone overmould 236), and optionally, a magnet (also not shown) fixed relative to the internal coil. The external coil transmits electrical signals (i.e., power and stimulation data) to the internal coil via a radio frequency (RF) link. The internal coil is typically a wire antenna coil comprised of multiple turns of electrically insulated platinum or gold wire. The electrical insulation of the internal coil is provided by a flexible silicone molding (not shown). In use, implantable receiver unit 232 is positioned in a recess of the temporal bone adjacent auricle 110.

In the illustrative embodiment of FIG. 2A, ossicles 106 have been explanted. However, it should be appreciated that stimulation arrangement 250A may be implanted without disturbing ossicles 106.

Stimulation arrangement 250A comprises an actuator 240, a stapes prosthesis 252A and a coupling element 251A which includes an artificial incus 261B.

In this arrangement, stimulation arrangement 250A is implanted and/or configured such that a portion of stapes prosthesis 252A abuts an opening in one of the semicircular canals 125. For example, in the illustrative embodiment, stapes prosthesis 252A abuts an opening in horizontal semicircular canal 126. In alternative embodiments, stimulation arrangement 250A is implanted such that stapes prosthesis 252A abuts an opening in posterior semicircular canal 127 or superior semicircular canal 128.

As noted above, a sound signal is received by microphone(s) 224, processed by sound processing unit 226, and transmitted as encoded data signals to internal receiver 232. Based on these received signals, stimulator unit 220 generates drive signals which cause actuation of actuator 240. The mechanical motion of actuator 240 is transferred to stapes prosthesis 252A such that a wave of fluid motion is generated in horizontal semicircular canal 126. Because vestibule 129 provides fluid communication between the semicircular canals 125 and the median canal, the wave of fluid motion continues into the median canal, thereby activating the hair cells of the organ of Corti. Activation of the hair cells causes appropriate nerve impulses to be generated and transferred through the spiral ganglion cells (not shown) and auditory nerve 114 to cause a hearing percept in the brain.

FIG. 2B depicts an exemplary middle ear implant 200B having a stimulation arrangement 250B comprising actuator 240 and a coupling element 251B. Coupling element 251B includes a stapes prosthesis 252B and an artificial incus 261B which couples the actuator to the stapes prosthesis. In this embodiment, stapes prosthesis 252C abuts stapes 111.

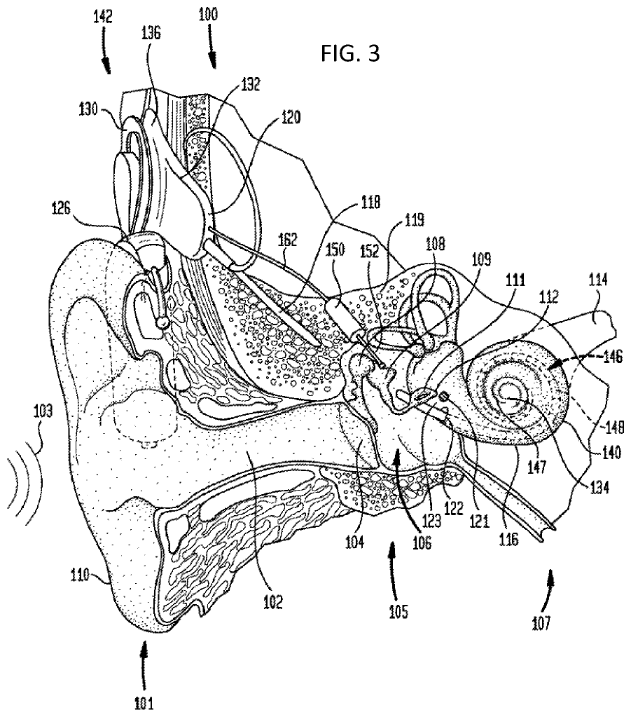

FIG. 3 is perspective view of a totally implantable cochlear implant, referred to as cochlear implant 100, implanted in a recipient. As shown, cochlear implant 100 comprises one or more components which are temporarily or permanently implanted in the recipient. Cochlear implant 100 is shown in FIG. 3 with an external device 142 which, as described below, is configured to provide power to the cochlear implant.

In the illustrative arrangement of FIG. 3, external device 142 may comprise a power source (not shown) disposed in a Behind-The-Ear (BTE) unit 126. External device 142 also includes components of a transcutaneous energy transfer link, referred to as an external energy transfer assembly. The transcutaneous energy transfer link is used to transfer power and/or data to cochlear implant 100. As would be appreciated, various types of energy transfer, such as infrared (IR), electromagnetic, capacitive and inductive transfer, may be used to transfer the power and/or data from external device 142 to cochlear implant 100. In the illustrative embodiments of FIG. 1, the external energy transfer assembly comprises an external coil 130 that forms part of an inductive radio frequency (RF) communication link. External coil 130 is typically a wire antenna coil comprised of multiple turns of electrically insulated single-strand or multi-strand platinum or gold wire. External device 142 also includes a magnet (not shown) positioned within the turns of wire of external coil 130. It should be appreciated that the external device shown in FIG. 3 is merely illustrative, and other external devices may be used with embodiments of the present invention.

Cochlear implant 100 comprises an internal energy transfer assembly 132 which may be positioned in a recess of the temporal bone adjacent auricle 110 of the recipient. As detailed below, internal energy transfer assembly 132 is a component of the transcutaneous energy transfer link and receives power and/or data from external device 142. In the illustrative embodiment, the energy transfer link comprises an inductive RF link, and internal energy transfer assembly 132 comprises a primary internal coil 136. Internal coil 136 is typically a wire antenna coil comprised of multiple turns of electrically insulated single-strand or multi-strand platinum or gold wire.

Cochlear implant 100 further comprises a main implantable component 120 and an elongate electrode assembly 118. In embodiments of the present invention, internal energy transfer assembly 132 and main implantable component 120 are hermetically sealed within a biocompatible housing. In embodiments of the present invention, main implantable component 120 includes a sound processing unit (not shown) to convert the sound signals received by the implantable microphone in internal energy transfer assembly 132 to data signals. Main implantable component 120 further includes a stimulator unit (also not shown) which generates electrical stimulation signals based on the data signals. The electrical stimulation signals are delivered to the recipient via elongate electrode assembly 118.

Elongate electrode assembly 118 has a proximal end connected to main implantable component 120, and a distal end implanted in cochlea 140. Electrode assembly 118 extends from main implantable component 120 to cochlea 140 through mastoid bone 119. In some embodiments, electrode assembly 118 may be implanted at least in basal region 116, and sometimes further. For example, electrode assembly 118 may extend towards apical end of cochlea 140, referred to as cochlea apex 134. In certain circumstances, electrode assembly 118 may be inserted into cochlea 140 via a cochleostomy 122. In other circumstances, a cochleostomy may be formed through round window 121, oval window 112, the promontory 123 or through an apical turn 147 of cochlea 140.

Electrode assembly 118 comprises a longitudinally aligned and distally extending array 146 of electrodes 148, sometimes referred to as electrode array 146 herein, disposed along a length thereof. Although electrode array 146 may be disposed on electrode assembly 118, in most practical applications, electrode array 146 is integrated into electrode assembly 118. As such, electrode array 146 is referred to herein as being disposed in electrode assembly 118. As noted, a stimulator unit generates stimulation signals which are applied by electrodes 148 to cochlea 140, thereby stimulating auditory nerve 114.

As noted, cochlear implant 100 comprises a totally implantable prosthesis that is capable of operating, at least for a period of time, without the need for external device 142. Therefore, cochlear implant 100 further comprises a rechargeable power source (not shown) that stores power received from external device 142. The power source may comprise, for example, a rechargeable battery. During operation of cochlear implant 100, the power stored by the power source is distributed to the various other implanted components as needed. The power source may be located in main implantable component 120, or disposed in a separate implanted location.

Stimulator 132 receives a signal generated by an implanted sound sensor 150, in this embodiment, via a cable 162. Sound sensor 150 is implanted in a cavity formed in mastoid bone 119 so as to extend, in this embodiment, into the middle ear cavity. Sound sensor 150 is configured to detect sound received in a recipient's ear through the use of vibrations or pressure variations that occur in or along the natural path that is followed by acoustic waves in the ear. More specifically, sound sensor 150 senses vibration of a structure of the recipient's ear or vibration of fluid within one of the recipient's body cavities, such as recipient's middle ear cavity, inner ear canals, cochlear ducts, etc. The vibration of the recipient's ear structure, or the vibration of the fluid within a body cavity is a result of the receipt of acoustic waves that travel from the recipient's outer ear to the middle and inner ear. That is, the received acoustic waves result in the vibration of the middle or inner ear structures, or travel through the middle ear cavity, creating vibration of the fluid within the cavities. In the embodiment illustrated in FIG. 3, the sound sensor detects sound based on vibration of the recipient's middle ear bones, and more specifically, based on vibration of incus 109.

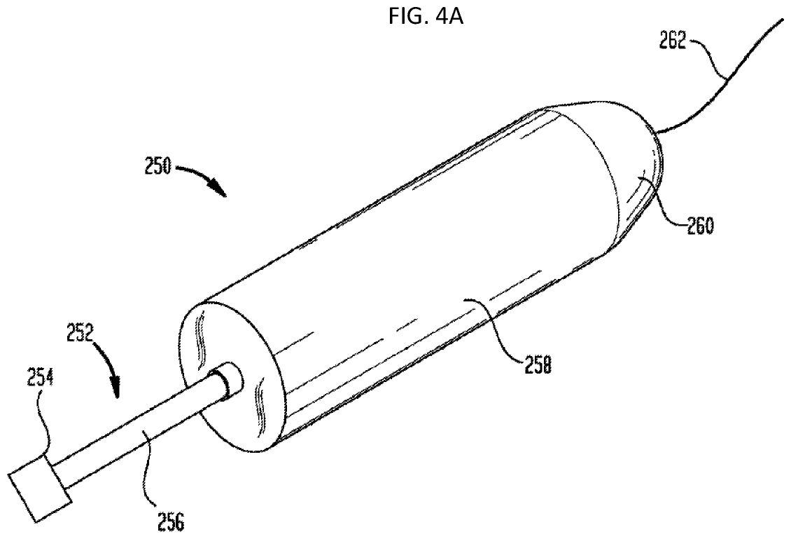

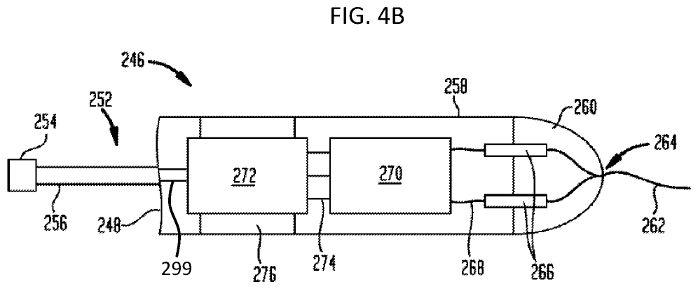

An embodiment of implantable actuator 250 is described next below with reference to FIGS. 4A and 4B, referred to herein as implantable actuator 250. Implantable actuator 250 comprises a housing 258 having, in this embodiment, a substantially tubular shape. The tubular shape may have a cylindrical or elliptical cross-sectional shape. Other shapes, such as prismatic with square, rectangular, or other polygonal cross-sectional shapes may also be used in alternative embodiments. However, a cylindrical shape may be advantageous for purposes of implantation and manufacture.

In the embodiments of FIGS. 4A and 4B, housing 258 is closed at one end 246 by a membrane 248. Membrane 248 is connected to housing 258 as to hermetically seal the one end 246. Membrane 248 may be connected to housing 258 through one of many known techniques, such as laser welding or manufacturing (milling, turning) housing 258 and membrane 248 out of one piece.

Housing 258 is closed at the opposing end 264, that is, the end remote from membrane 248, by a closure 260. Closure 260 also provides a hermetical seal. Hence, housing 258, membrane 248 and closure 260 form a biocompatible hermetically-sealed enclosure that is substantially impenetrable to air and body fluids.

In embodiments of the present invention, membrane 248 is substantially flexible and is configured to vibrate. The thickness of membrane 248 is selected depending on, for example, the material of which it is made and the body location in which actuator 250 will be implanted. Additionally, membrane 248 and housing 258 may be each made from the same or different titanium or a titanium alloy. However, it would be appreciated that other biocompatible materials may also be used. For example, in one alternative embodiment, closure 260 may be manufactured of a biocompatible ceramic material.

A coupling mechanism 252 is secured to the exterior surface of membrane 248. In the embodiment illustrated in FIGS. 4A and 4B, coupling mechanism 252 comprises an elongate rod 256 and a bracket 254 disposed on the distal end of the rod. Bracket 254 may have a variety of configurations depending on which structure of the natural ear the device is to be secured. This is described in further detail below.

An electromagnetic actuator 272 is disposed inside housing 258 and is coupled by output rod 299 to membrane 248. Actuation of the electromagnetic actuator 272 moves the output rod 299 which moves the membrane 248 which moves the elongate rod 256 and thus the bracket 254, and thus moves the ossicle component that is attached to the bracket. (In some embodiments, output rod 299 is integral with the elongate rod 256, and passes through the membrane 248.

The housing 258 is a cylindrical component, as can be seen. The cylindrical component has an outer diameter of more than 3 mm and a length of more than 3 mm. In an exemplary embodiment, the outer diameter is equal to or more than 3.5, 4, 4.5, 5, 5.5, 6, 6.5, 7, 7.5, or 8 mm, or any value or range of values therebetween in 0.05 mm increments. In an exemplary embodiment, the outer length is equal to or more than 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16 mm, or any value or range of values therebetween in 0.05 mm increments.

Actuator 272 is connected to housing 258 by means of support 276.

Actuator 250 further comprises a receiver 270 for receiving a signal from outside the housing based on captured sound to control the actuator 272.

The receiver may comprise an electronic circuit 270 mounted inside housing 258 that is coupled to actuator 272 by wires 262. Electronic circuit 270 may be configured to process the signal received via leads 262 and control the actuator 272 based thereon.

At least one feedthrough 266 is preferably provided for passing electrical wires 262 to through housing 258. Feedthrough 266 is preferably provided through closure 260. In certain embodiments, feedthrough 266 is formed in closure 260; in other words, they are unitary.

Electrical wires 262 may be configured to pass electrical power from outside the housing to inside the housing to power the actuator.

The enclosure, formed by housing 258, membrane 248, and closure 260, is, in certain embodiments, filled with an inert gas, such as nitrogen or argon.

Rod 256 is an elongate member suitable for coupling membrane 248 to a moving structure of the ear. Alternatively, the actuator 250 may comprise one or more brackets 254 for additionally connecting membrane 248 to a structure of the middle or inner ear. Additionally, in other embodiments, rod 256 or bracket 254 may be coupled to the malleus, the incus, or the stapes, and bracket 254 may comprise, for example, a bracket such as those used for stapedioplasty. In such embodiments, bracket 254 comprises a clip for coupling to one of those structures. In still other embodiments, rod 256 or bracket 254 may be coupled to the elliptical window, round window, the horizontal canal, the posterior canal or the superior canal.

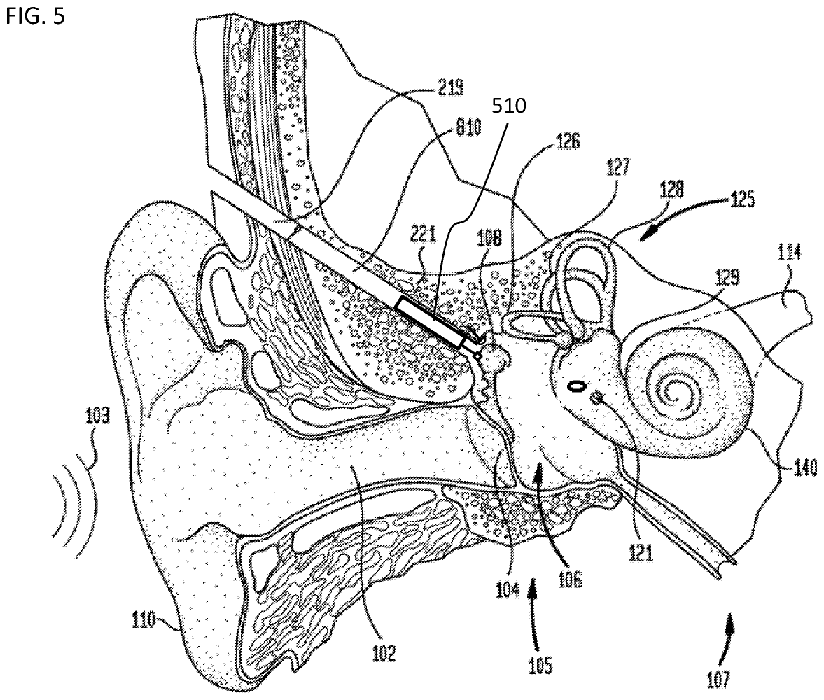

FIG. 5 is a perspective view of an exemplary embodiment where a cavity borer or the like has drilled from the outer surface of the mastoid bone 221 straight to the middle ear cavity 106 to establish artificial passageway 219, in which the middle ear actuator detailed above can be inserted. That said, in alternate embodiments, the passageway 219 may not be straight and the passageway 219 might not be drilled from the outer surface of the mastoid bone 221 but instead from the middle ear cavity 106, and in some embodiments, the passageway 219 might not extend completely from the middle ear cavity to the external surface. Any arrangement of passageway that can have utilitarian value can be utilized in some embodiments.

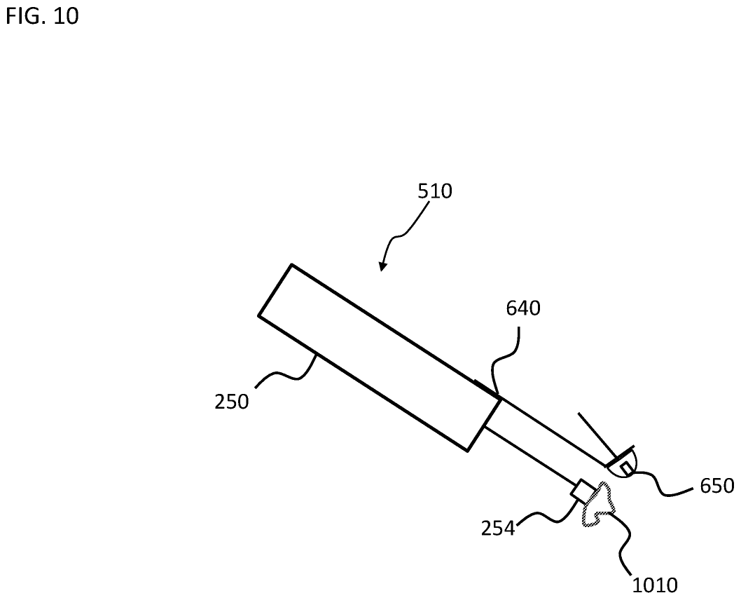

FIG. 5 is also an exemplary embodiment of an exemplary implantable apparatus 510, comprising, now with reference to FIG. 10, the actuator 250 and an implantable transducer fixation mechanism 640, the fixation mechanism 640 being configured to receive the implantable transducer 250. As can be seen, a bone screw 650 is also included with the fixation mechanism 640, which bone screw is used to fix the fixation mechanism to the wall of the middle ear cavity of the recipient, as seen in FIG. 5. Thus, the fixation mechanism 640 is configured to be fixed to a wall of the middle ear cavity of the recipient. In the embodiment of FIGS. 5 and 10, the fixation mechanism 640 is configured to locate the actuator 250 at least partially outside the middle ear cavity. And note that while the implantable apparatus 510 is shown as being connected to the malleus, in other arrangements, the implantable apparatus 510 is connected to one of the windows of the cochlea and/or another portion of the ossicles.

As seen from FIG. 5 in an exemplary embodiment, the fixation mechanism 640 is configured to locate the transducer 250 at least partly outside the middle ear cavity 106, and completely outside the outer ear passageway 102. That is, no part of the transducer is located in the outer ear passageway 102, as might be the case in at least some exemplary embodiments where the transducer extends through the tympanic membrane 104.

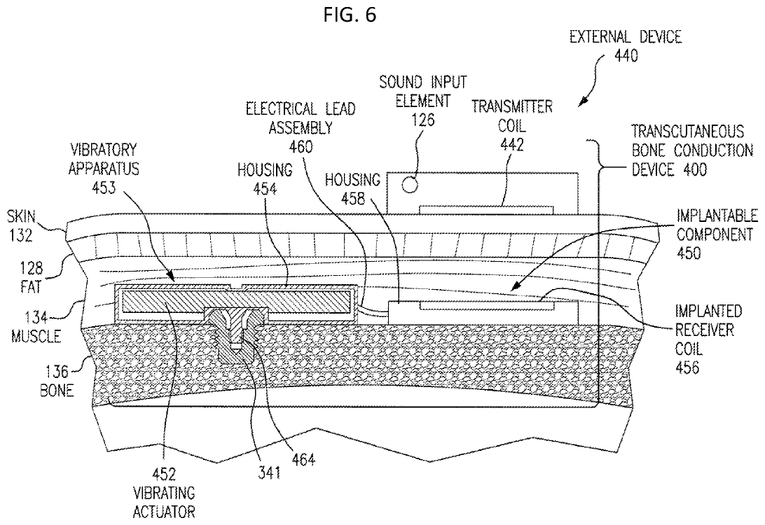

FIG. 6 depicts an exemplary transcutaneous bone conduction device 400 that includes an external device 440 (corresponding to, for example, element 140B of FIG. 1) and an implantable component 450. Various features of the prostheses of FIGS. 1-5 can be used with the prostheses 400, and in the interests of textual economy, any disclosure above can be combined with the prosthesis 400 unless noted or otherwise unless the art does not enable such. The transcutaneous bone conduction device 400 of FIG. 5 is an active transcutaneous bone conduction device in that the vibrating electromagnetic actuator 452 (it can be another type of actuator, such as a piezoelectric actuator—more on this below) is located in the implantable component 450. Specifically, a vibratory element in the form of vibrating electromagnetic actuator 452 is located in housing 454 of the implantable component 450. In an exemplary embodiment, the vibrating electromagnetic actuator 452 is a device that converts electrical signals into vibration.

External component 440 includes a sound input element 126 that converts sound into electrical signals. Specifically, the transcutaneous bone conduction device 400 provides these electrical signals to vibrating electromagnetic actuator 452, or to a sound processor (not shown) that processes the electrical signals, and then provides those processed signals to the implantable component 450 through the skin of the recipient via a magnetic inductance link. In this regard, a transmitter coil 442 of the external component 440 transmits these signals to implanted receiver coil 456 located in housing 458 of the implantable component 450. Components (not shown) in the housing 458, such as, for example, a signal generator or an implanted sound processor, then generate electrical signals to be delivered to vibrating electromagnetic actuator 452 via electrical lead assembly 460. The vibrating electromagnetic actuator 452 converts the electrical signals into vibrations.

The vibrating electromagnetic actuator 452 is mechanically coupled to the housing 454. Housing 454 and vibrating electromagnetic actuator 452 collectively form a vibratory apparatus 453. The housing 454 is substantially rigidly attached to bone fixture 341.

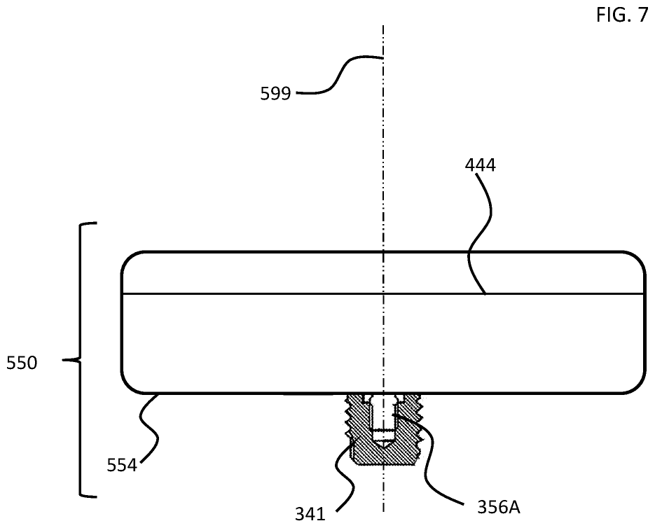

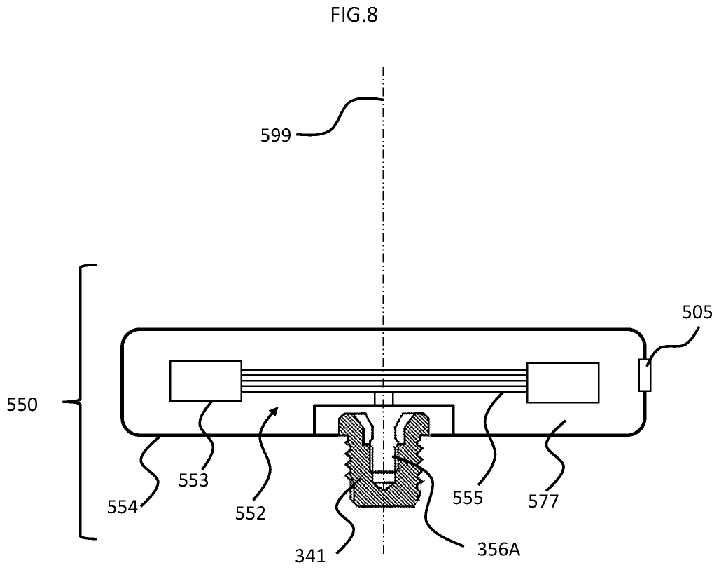

FIGS. 7 and 8 depict another exemplary embodiment of an implantable component usable in an active transcutaneous bone conduction device, here, implantable component 550. FIG. 7 depicts a side view of the implantable component 550 which includes housing 554 which entails two housing bodies made of titanium in an exemplary embodiment, welded together at seam 444 to form a hermetically sealed housing. FIG. 8 depicts a cross-sectional view of the implantable component 550.

In an exemplary embodiment, the implantable component 550 is used in the embodiment of FIG. 6 in place of implantable component 450. As can be seen, implantable component 550 combines an actuator 552 (corresponding with respect to functionality to actuator 452 detailed above). Briefly, it is noted that the vibrating actuator 552 includes a so-called counterweight/mass 553 that is supported by piezoelectric components 555. In the exemplary embodiment of FIG. 8, the piezoelectric components 555 flex upon the exposure of an electrical current thereto, thus moving the counterweight 553. In an exemplary embodiment, this movement creates vibrations that are ultimately transferred to the recipient to evoke a hearing percept.

As can be understood from the schematic of FIG. 8, in an exemplary embodiment, the housing 554 entirely and completely encompasses the vibratory apparatus 552, but includes feedthrough 505, so as to permit the electrical lead assembly 460 to communicate with the vibrating actuator 452 therein. It is briefly noted at this time that some and/or all of the components of the embodiment of FIG. 5 are at least generally rotationally symmetric about the longitudinal axis 559. In this regard, the screw 356A is circular about the longitudinal axis 559. Back lines have been omitted for purposes of clarity in some instances.

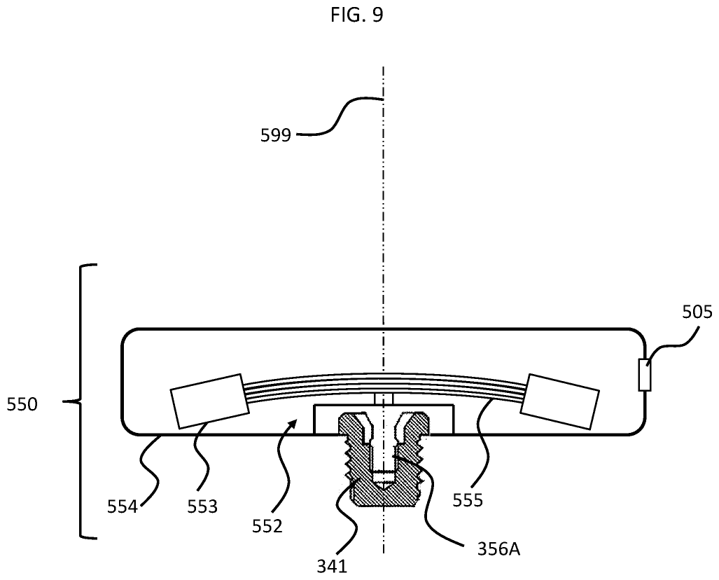

Still with reference to FIG. 8, as can be seen, there is a space 577 located between the housing 554 in general, and the inside wall thereof in particular, and the counterweight 553. This space has utilitarian value with respect to enabling the implantable component 550 to function as a transducer in that, in a scenario where the implantable component is an actuator, the piezoelectric material 555 can flex, which can enable the counterweight 553 to move within the housing 554 so as to generate vibrations to evoke a hearing percept. FIG. 9 depicts an exemplary scenario of movement of the piezoelectric material 555 when subjected to an electrical current along with the movement of the counterweight 553. As can be seen, space 577 provides for the movement of the actuator 552 within housing 554 so that the counterweight 553 does not come into contact with the inside wall of the housing 554. The repeated bending of the piezoelectric component at a desire frequency creates forces owing to F=M*A, which are conveyed to the skull bone and by bone conduction evoke a hearing percept at the frequency of the bending of the piezoelectric component (ideally).

It is noted that any of the disclosure described above does not constitute structure corresponding to the innovative features of the present invention, but instead provides a framework for those teachings as will be described below. Accordingly, “means for” construction does not cover those descriptions per se without one or more features of the below. That is not to say that the above is not used with “means for.” That is to say that, for example, a means for actuating would cover the above, but a means for positioning/holding an actuator would not be covered as the above does not form part of the invention (but again does form a framework which the invention can draw upon, and provides teachings which can be used to implement the teachings below).

With the above in mind, typical bone stimulation actuators (herein, referred to as type 1 actuator assemblies/devices)—the devices of FIGS. 6-9 for example, are at least more force based than stroke based, meaning that they are designed to stimulate targets with a high mechanical impedance. As a result, the amplitude of the displacement (i.e., stroke) of the interface portion contacting the high impedance stimulation target of the body (for example, the outer surface of the skull bone in back of the ear (whether or not there is an excavation) is typically small (e.g., magnitude 0.1 μm/V—voltages typically run from 1 to 10 volts or any value or range of values therebetween in 0.1 volts). The displacement is smaller than for a middle ear actuator and/or a direct acoustic cochlear stimulator (herein, referred to as type 2)—the devices of FIGS. 2A and 2B for example, which typically displace a portion of the middle ear or inner ear (e.g., an ossicle, round or oval window) with a relatively large stroke (e.g., sometimes by 10 μm/V, or up to 100 times the stroke of a type 1 actuator). A type 1 actuator is designed to deliver higher forces than a type 2 actuator as the mechanical impedance of a complete skull (target of type 1 actuator as used in FIGS. 6-9 for example) is much higher than the impedance of the ossicles, a round or oval window (target of a type 2 actuator for example). The force of the type 1 actuator should be high enough to have vibrations traveling through the high-impedance structure of the skull up to the cochlea to induce hearing sensation. (Classic bone conduction.)

Embodiments herein, unlike bone conduction actuators (type 1), do not use a relative heavy floating mass to generate the force for bone conduction. Embodiments do not rely on the inertia effect (owing to the acceleration) per se, or at least not solely, including at least not primarily, and thus can have a higher force output at lower frequencies (e.g., 500 Hz) relative to that which would be the case with a mass. Note also that type 2 devices that also use a floating mass can suffer from relatively reduced output at lower frequencies, thus underperforming at such frequencies. Embodiments of the teachings herein can avoid such in at least some embodiments.

A difference between the prostheses of FIGS. 2A-5 on the one hand and FIGS. 6-9 on the other is that the former relies on a 2-point fixation principle, which allows the generation of a high stroke and relatively more force at low frequencies compared to the latter (at least when compared to the latter concept if mounted on a low impedance structure—there will be less force than if mounted on a high impedance structure). However, these prostheses can often meet a greater level of resistance than type 1 devices. In this regard, in some instances, there are surgical disadvantages relative to the single point fixation prostheses. For example, the surgical implementation typically requires a high skillset of the surgeon, a long(er) surgery time. Moreover, there are sometimes inconsistent outcomes, such as, for example, altered performance over time, due to, for example, the front end coupling to a sensitive and typically movable tissue portion of the body. All this is contrasted to type 1 devices which are typically connected to the stimulation target via a bone anchor such as shown above in FIG. 6 and FIG. 7.

Still, there is utilitarian value with respect to a two-point fixation principle. Embodiments herein at least in some embodiments can overcome or otherwise reduce these drawbacks just detailed.

And by single-point and two point fixation principles, it is not meant that there is only one fixation component and only two fixation components respectively. By “point fixation principle,” it is meant the overall fixation regime with relation to the actuator. Roughly speaking, the fixation “points” are in relation to the overall actuator. If there were, for example, three fixation screws on one side of the actuator, and one fixation component, such as bone cement, on the other side of the actuator, or more accurately, at the location of the output of the actuator, that would be a two-point fixation principle implementation. Conversely, if there was no bone cement for example at the location of the output of the actuator, that would be a one point fixation principle implementation. Conversely, this would be characterized as a four fixation component device (three screws on one end and the bone cement on the other), as distinguished from a point fixation principle. Still, embodiments can utilize a one point fixation principle where, for example, a disk shaped piezoelectric component that extends radially against a cylindrical housing wall is utilized, where, for example, the wall is weakened at certain locations around the circumference of the wall relative to other locations. This would be a hybrid multipoint fixation system. In essence, the force output would be greatest or largest at the weakened portions, and thus would achieve at least in part the results of the two-point fixation. Accordingly, embodiments can include a single point fixation where the output of the device is greater at one or more locations of the device relative to other locations, where this output can be at least 30, 35, 40, 45, 50, 60, 70, 80, 90 or 100% or more greater then the smallest output location.

More specifically, the fixation regime can be considered in terms of where the component is fixated to tissue of the recipient relative to the output of the actuator. In the simplest form, such as with respect to the middle ear implant actuator of FIG. 4A in view of FIG. 5, housing 258 could be attached to the bone of the recipient, such as the temporal bone, which can be high mechanical impedance bone, such as by way of example with an interference fit in a hole through the bone or by the utilization of a holding apparatus attached to the housing, which holding apparatus is then screwed to the temporal bone utilizing one or two or more bone screws. That would be a first fixation portion of a fixation arrangement of the actuator, and thus would constitute a first point irrespective of the number of bone screws because all of the bone screws effectively hold one single portion of the actuator in place (here, the nonmoving part, but that is relative because the housing will move, only ever so slightly, even though the element 254 moves far more—more on this in a moment).

Element 254, which can be a roughened cylinder that is adhesively bonded to the ossicles, in some embodiments, can be attached to a portion of the ossicles for example, utilizing bone cement. That would constitute a second point irrespective of how much bone cement was used or whether two or more screws (or pins) would be utilized to connect to the ossicles (however unlikely). This thus represents a two point fixation principle implementation. And note how the fixation portions are located so that the output, effectively embodied by shaft 256 and bracket 254, is between the two fixation portions. This is clearly seen with respect to a component such as bracket 254 which has a definable movement relative to the rest of the actuator. However, as will be seen, this breaks down a bit when the movement is far lower than that which would be the case with respect to the movement of the bracket 254. The principle is still the same, but from a purely spatial/structural arrangement, it is not always accurate to say that the output is located between the two fixation portions (the fixation points can be at the same side of the actuator). Indeed, arrangements can be seen where for whatever reason, the fixation portions are both located on one side of the actuator. This is seen in FIG. 10 for example where the fixation mechanism 640 is configured to locate the transducer 250 at least partially outside the middle ear cavity, where the fixation portion, embodied by the screw 650, would be about the same location as where the bracket 254 is fixed to tissue by bone cement 1010, as shown. Arguably, the output is not “between” the two fixation portions from a spatial relationship. However, from a holistic interpretation, the output is between the portions, because the “equivalent structure” (akin to an “equivalent circuit”) would have screw 650 on one side of bracket 254, and bone cement 1010 on the other side of the bracket 254.

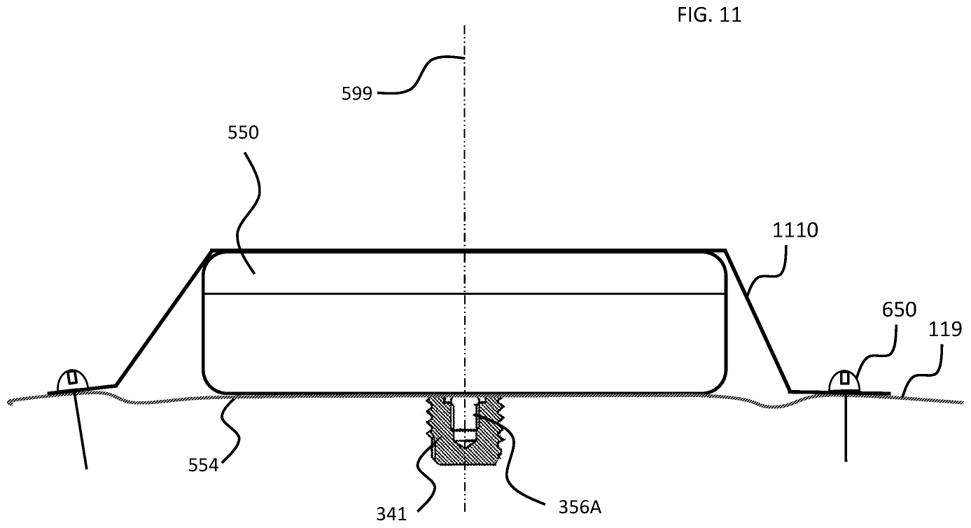

And while FIG. 7 shows a single point fixation principle implementation, FIG. 11 shows a false two point fixation principle (more on this in a moment), where bracket 1110 extends over the top of the housing of the implant 550, which is connected to bone 119 by two screws 650. And note that without bone fixture 341, this would be a single point fixation principle implementation (at least providing that the bottom is not osseointegrated to the bone 119), even if there was a second bracket for example that extended over the top of the first bracket with respective bone screws. But note that the arrangement shown in FIG. 11 is superfluous. There is no need for the strap and the fixture 341 in combination, save for redundancy.

As noted above, we classify the arrangement of FIG. 7 as a false two point fixation principle. It is false in the sense that it can use moving masses inside the housing to generate the force, in combination with that, only 1 fixation point to the body is enough (at the top or the bottom, for example). If the device is not anchored to the fixture or the strap (while not contacting the bottom=floating), it can also work when bottom is pressed down to the bone in combination with the strap—to assure contact with the bone. Moreover, because there is no need for the strap and the fixture 341 in combination, this is a false two-point fixation principle because it really does not achieve anything in a functional manner. That is, the fixation components do not react in combination against a force. They may distribute the reaction against the force, but they do not operate in combination. The strap takes a first percentage of the force and the bone fixture takes the remainder amount of the force. Take one away and the other would take the entire force. Perhaps there would be early failure or perhaps something would break, but one of the points can be sufficiently beefed up so that the functionality of the actuator would remain if only for a short period of time. Only one point is needed for force reaction. This is contrasted to a true two point fixation principle where the two points in combination react against the load, as will be detailed below. Take one away and the actuator becomes useless. Again, because there is a moving mass (e.g., an electromagnetic actuator or a piezoelectric actuator connected to masses, one point fixation works). As will be detailed below, because the actuators used herein are arranged to operate on a different principle (there is no “moving mass” per se), the teachings herein are directed to a true two-point fixation principle. And this is not to say that embodiments do not include the utilization of a mass, such as on top of the back-end fixation for example. But those are not the moving masses of a piezoelectric bender with masses located at the ends of the bender, for example (See FIG. for example, showing the moving mass principle).

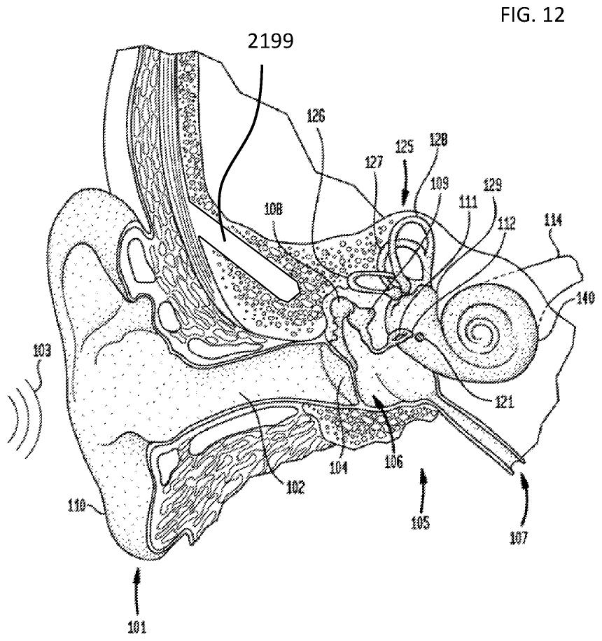

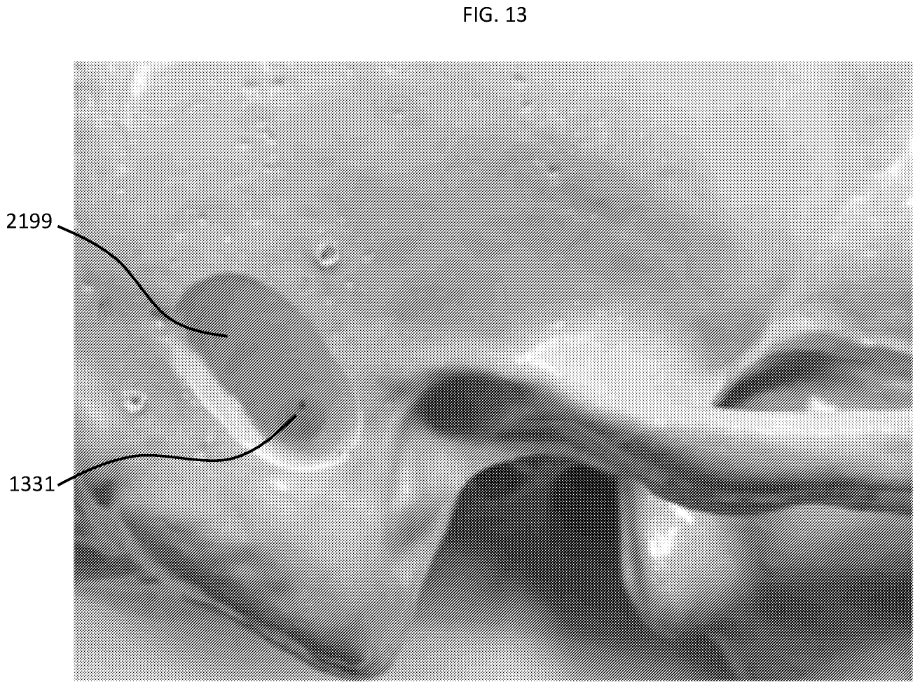

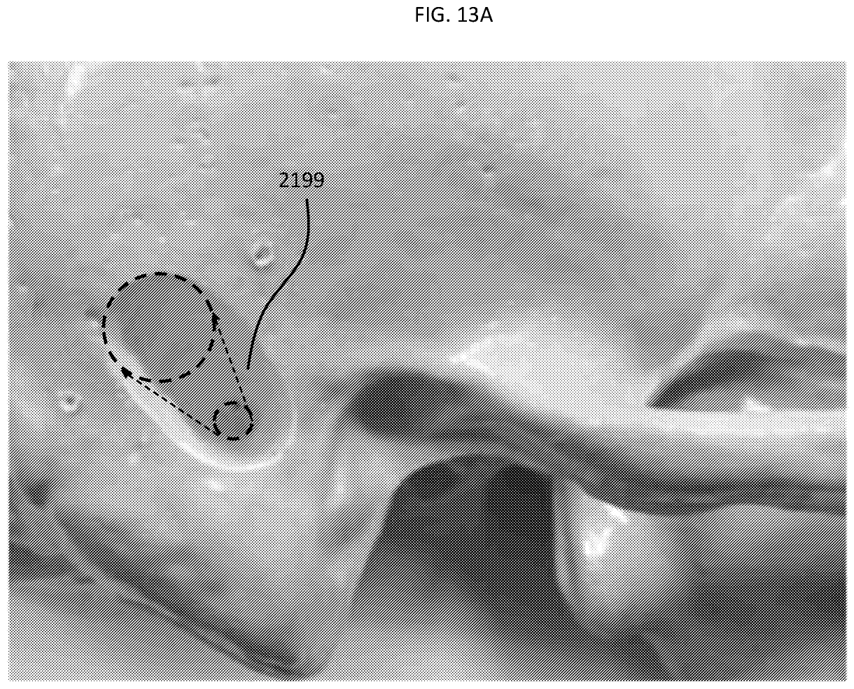

FIG. 12 presents a cavity 2199 in the temporal bone. Unlike the passageway 219, the cavity 2199 does not extend all the way into the middle ear cavity 106. The utility of this will be described in further detail below. (In an embodiment, the cavity made in the temporal bone is at least 1, 2, 3, 4, 5, 6, 7, 8, 9, 10, 11, 12, 13, 14 or 15 mm from the middle ear cavity.) Moreover, while passageway 219 has a circular cross-section at least in the embodiment described above, cavity 2199 is more of an excavation in the mastoid bone and does not have a specific or uniform dimension. In this regard, FIG. 13 depicts the cavity 2199 looking towards the skull from the outside, showing that the boundaries of the cavity can be loosely dimensioned or otherwise established on an as-needed basis. The cavity 2199 can be excavated utilizing a ball tip drill or a grinder or any other machine that can excavate bone in a utilitarian manner. That is, the cavity can be bored out/hogged out with a ball drill bit, and thus need not be as precise as the passageway 219 (although we depict such precision in some figures). One requirement of any cavity 2199 according to the embodiments herein can be that the cavity can accept an actuator and at least a portion of the support assembly. FIG. 13A shows the image of FIG. 13 with graphics superimposed thereon. This can be useful in understanding an excavation process where, for example, a surgeon or healthcare professional starts drilling posterior EC wall and works gradually supero-posteriorly up to the sinodural angle. And note that embodiments can include establishing a cavity that is less inferior than that shown in FIG. 13, and such can have utilitarian value for targeting a lateral canal area, for example.

FIG. 13 and FIG. 13A also shows how an at least partial hemispherical excavation 1331 is drilled into the bone for a spherical or a semi-spherical end portion of the actuator assembly, the end portion of which will be discussed in greater detail below (where there is sphere to bone contact).

In an embodiment, an excavation such as a mastoidectomy, which is sometimes executed for a cochlear implant surgery, is what is used as the excavation, or a similar excavation thereto. (Note that for cochlear implants, typically, a larger excavation is made relative to those used with the embodiments herein. Still, the basic principles can be used to implement the teachings herein.)

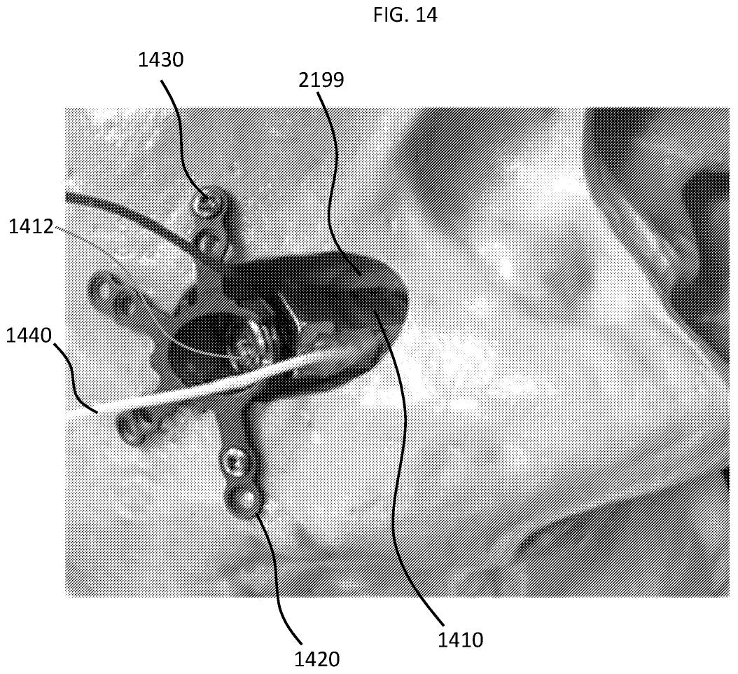

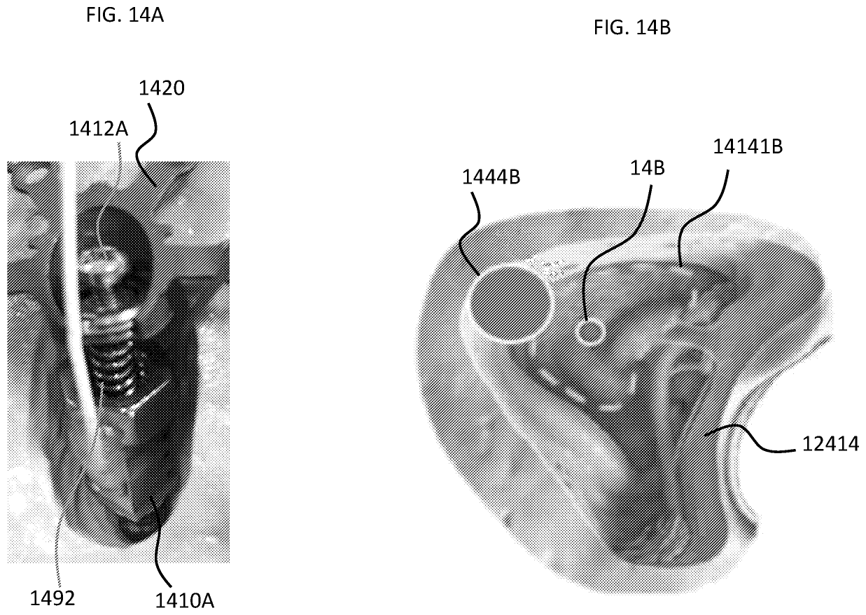

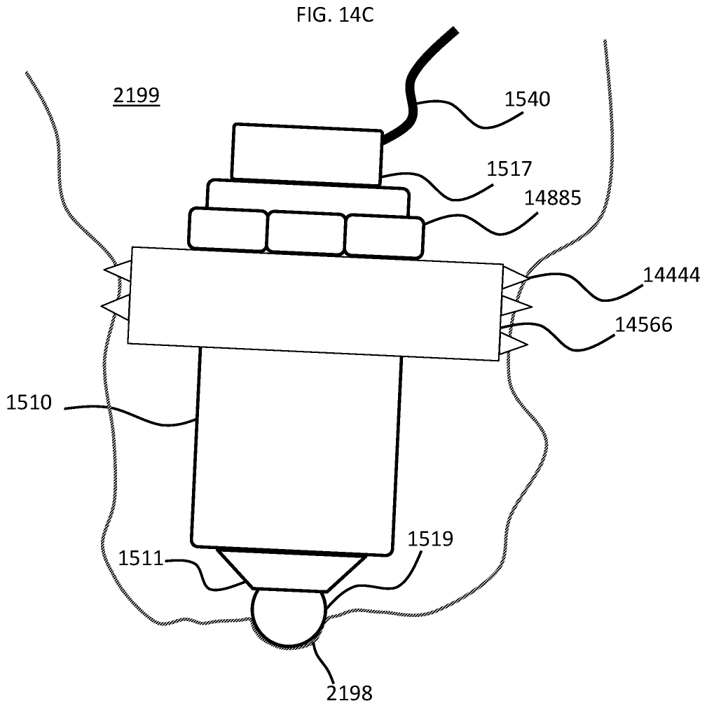

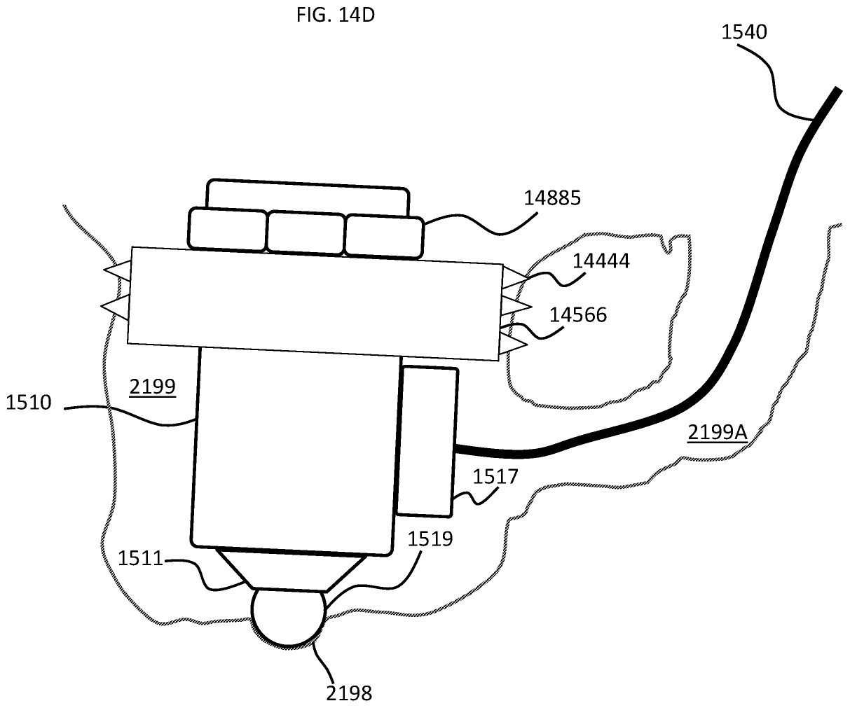

FIG. 14 shows the view looking towards the skull where an actuator 1410 that is part of an actuator assembly is located in the cavity 2199 as can be seen. The actuator 1410 is supported by a support assembly that includes a bracket 1420 which is screwed to the bone utilizing bone screws 1430 as shown. Electrical leads 1440 are shown in an exaggerated manner so that the concept of a self-contained actuator located substantially if not totally in the excavation 2199 can be conveyed. An adjustment threaded body 1412 interfaces with the bracket 1420 and is connected to the actuator 1410. The bracket 1420 is threaded with a female thread that matches the male thread of the adjustment body 1412. As will be described in greater detail below, by turning the adjustment body, the preloading of the actuator 1410 against the bone at the bottom of the excavation 2199 can be established or otherwise adjusted. FIG. 14A shows a sideview of another actuator assembly that includes a variation of a piezoelectric actuator 1410A attached to a bracket 1420. Here, there is a set-screw 1412A that is turned to preload the actuator 1410A. Also shown is a spring 1492 that applies force onto the actuator 1410A. By turning the screw 1412A, the preload on the actuator can be changed. This is slightly different than the embodiment shown in FIG. 14, where the actuator interface with the bracket 1412 is what is turned to adjust the preload on the actuator.

FIG. 14B shows an exemplary excavation, where there is a target for the front end of the actuator assembly 14B. Also, there is a general target area 1444B for the front end of the actuator assembly if the middle ear is not targeted. Also shown in dashed lines is a path 14141B. Again, these areas generally indicate potential general front-end target areas, such as if the middle ear is not targeted. But again, areas of the posterior wall of the ear canal can be targeted. This is seen by the dashed path 12414 (where the front end could be attached/placed (along the line)).

In an embodiment, the target is the otic capsule or the vicinity thereof and/or the lateral semi-circular canal. In an embodiment the front end is within 11, 10, 9, 8, 7, 6, 5, 4, 3.5, 3, 2.5, 2, 1.5 or 1 mm or any value or range of values therebetween in 0.1 mm increments of one or both of these body parts. An embodiment targets relatively hard bone, even if the bone is also relatively thin.

Moreover, in an embodiment, a longitudinal centerline of the actuator, at least with respect to portions thereof that are within the actuator (the centerline is an infinite line—we are limiting that to the component within the actuator) is within 35, 30, 25, 20, 19, 18, 17, 16, 15, 14, 13, 12, 11 or 10 mm or any value or range of values therebetween in 0.1 mm increments of the centerline of the ear canal. In an embodiment, the entire centerline of the actuator within the actuator meets these values, while in other embodiments, at least 90, 80, 70, 60, 50, 40, 30, 20, 10 or 5% or any value or range of values in 1% increments of the centerline within the actuator meets these values. In an embodiment, the centerlines are parallel, while in some embodiments, the centerline of the actuator has an acute angle of no great than 30, 25, 20, 15, 10 or 5 degrees or any value or range of values therebetween in 1 degree increments from a plane parallel to and lying on the axis of the ear canal. In some embodiments, the centerline of the actuator has two acute angles no greater than 30, 25, 20, 15, 10 or 5 degrees or any value or range of values therebetween in 1 degree increments from two planes both lying on and parallel to the centerline of the ear canal, where the two planes are normal to each other (the angles need not be the same). In some embodiments, the centerline of the actuator has two angles greater than 30, 35, 40, 45, 50, 55, 60, 65, 70, 75 or 80 degrees or any value or range of values therebetween in 1 degree increments from two planes both lying on and parallel to the centerline of the ear canal, where the two planes are normal to each other (the angles need not be the same). Indeed, referring to path 12414 of FIG. 14B, if the front end is located on that path, the angle could be between and inclusive 30-80 degrees in any value any value or range of values therebetween in 1 degree increments from two planes both lying on and parallel to the centerline of the ear canal, where the two planes are normal to each other (the angles need not be the same). Embodiments are configured and used to avoid breaking bone or otherwise damaging bone in a manner that renders the bone unusable for the teachings herein, and embodiments are configured to apply force to the same place on the bone during periods of at least 1, 1.5, 2, 2.5, 3, 3.5, 4, 4.5, 5, 6, 7, 8, 9, 10, 15, 20, 25 or 30 years or more and evoke a hearing percept as a result thereof. In some embodiments, it is a lifetime.

In an embodiment, the back end tissue interface is mounted on the cortical layer of the skull.

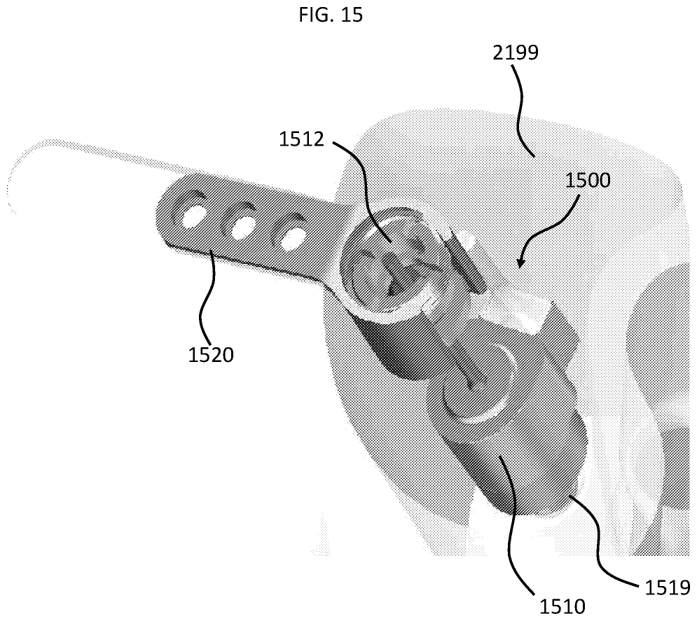

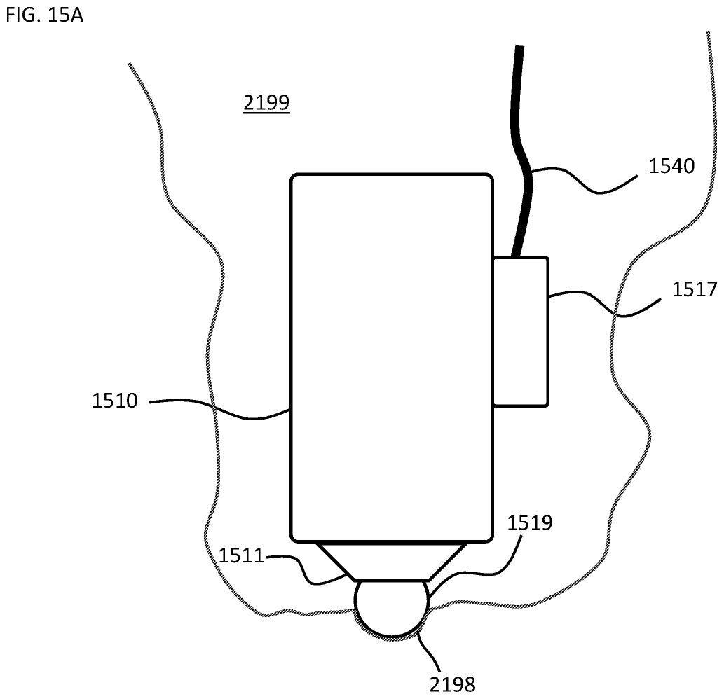

Briefly, FIG. 14C shows another embodiment, again, as with FIG. 14, with respect to a view looking towards the skull where an actuator 1510 (more on this below with respect to FIG. 15A—the actuator 1510 can be representative of actuator 1410 for example, and the elements of FIG. 14C that are labeled as in FIG. 15 correspond to the same elements in this embodiment) that is part of an actuator assembly is located in the cavity 2199 as can be seen. The actuator 1510 is supported by a support assembly that includes a threaded component 14566 that is attached to a hex head component 14885 which is screwed to the bone utilizing bone screws 14444 as shown. In this embodiment, component 14566 is a ring that is rigidly attached to the hex head 14855, such as by welding or by a strong epoxy, etc., and the actuator is configured so that the ring 14566 is configured to freely rotate about the longitudinal axis of actuator 1510, but does not move along the longitudinal axis, so that as the ring turns, the threads 14444 turn, and thus drive the actuator downward to achieve the precompression.

By turning the threaded component 14566, such as with a hex socket, the preloading of the actuator 1510 against the bone at the bottom of the excavation 2199 can be established or otherwise adjusted. In this embodiment, the threads 14444 serve the same function as the threads of FIG. 14, except the threads screw directly into the bone. The bracket is effectively bypassed. Indeed, in an embodiment, the adjustment body 1412 can be oversized from that shown in FIG. 14, and the same effect of FIG. 14C can be achieved, providing an accommodation for the leads can be developed—in an embodiment, a side passage can be put into the bone—the side passage could result in a non-circular passage, but as long as there is enough “circularity” for the threads to grip, the arrangement can be implemented—note that embodiments do not require a circular passageway—as long as there is enough standard dimensionality for the threads to grip (say on opposite sizes), such can work in some embodiments. And FIG. 14D shows an alternate embodiment, where there is a distinct passage 2199A through which lead 1540 extends to the actuator. Indeed, the portion of bone shown to the right of the actuator can be the outer portion of a ledge that extends from the left side of the bone around component 14566. In an exemplary embodiment, the area beneath the ledge is opened up (thus establishing the ledge) by boring through the top to create a hole through which the actuator can pass, and also by boring at an angle underneath and around the ledge to establish what is not necessarily a passageway anymore but in fact an extension of the overall cavity that is created. In essence, the ledge is simply a remainder of the bone that is left after the cavity is created, which is utilized to provide the backend fixation of the actuator.

It is also noted that FIGS. 14C and 14D also show that the actuator can be angled in any utilitarian manner that can enable the teachings detailed herein.

Thus, it can be seen that embodiments include a threaded hole in an osseointegrated bone implant, thus establishing a very rigid back-anchor, that allows a screw to generate a preload to the stack actuator.

FIG. 15 provides a schematic where a bracket 1520 with a single arm is attached to the bone and supports an adjustment screw 1512 via threaded interface between those two components (but again, embodiments can include two or 3 or 4 or more arms as well). This adjustment screw 1512 is in contact otherwise supports actuator 1510 by an elongate rod as shown. (In some embodiments, a long rod can be standard, and cut to length as needed.) Also shown is output device 1519 which is sized and dimensioned and otherwise positioned relative to the actuator 1510 so that when the actuator actuates, the force generated by the actuator is transferred to the output device 1519 and thus into the bone. FIG. 15A presents a side view of a portion of the arrangement of FIG. 15, or more clearly shows the output device 1519, where here, output device 1519 is a partial sphere which is supported by a pedestal 1511 which is connected to the actuator 1510. As will be described in greater detail below, actuator 1510 includes a piezoelectric component stack. In an embodiment, the housing of the actuator 1510 has a relatively thin bottom wall (the wall to which pedestal 1511 is attached) so that when the piezoelectric components expand and contract, the forces generated thereby are transferred to the pedestal 1511 and thus to the sphere 5019, and then to the bone at the bottom of the cavity 2199.

In an embodiment, the housing of the actuator has a solid/rigid bottom wall, and relatively thin or flexible sides (the sides can expand and contract like an accordion). In any event, any embodiment that can enable a longitudinal expansion that is enabled by the art that can enable the teachings herein can be used in some embodiments.

Also shown in this embodiment is that the bottom of the cavity 2199 has a subportion 2198 that is a partial hemisphere sized and dimensioned to generally match the sphere 1519, thus maintaining the position of the sphere 1519 in the lateral directions at least providing there is sufficient pretension on the actuator such as that which can be established by utilizing the adjustment screw (and/or spring-based adjustment system). In an embodiment, the sphere 1519 or other interface can be coated to facilitate osseointegration. In some embodiments, if the excavation is sized/dimensioned sufficiently accurately, the sphere 1519 could be coated with an antiosseointegration material (relying on the preload and the dimensional tightness to hold the sphere 1519 in place).

The point is that with respect to the embodiment of FIGS. 15 and 15A, the expansion of the piezoelectric stack imparts a force onto the pedestal 1511 and the sphere 1519 and thus into the bone, providing that there is sufficient reaction force at the second fixation point (established by bracket 1520).

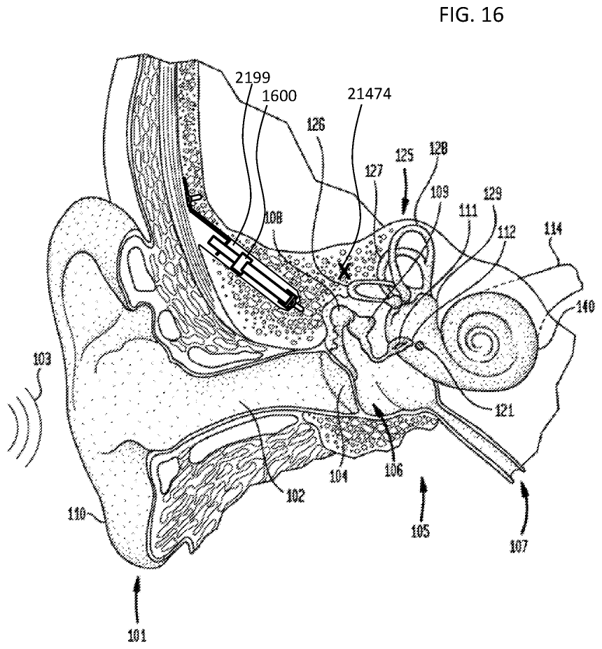

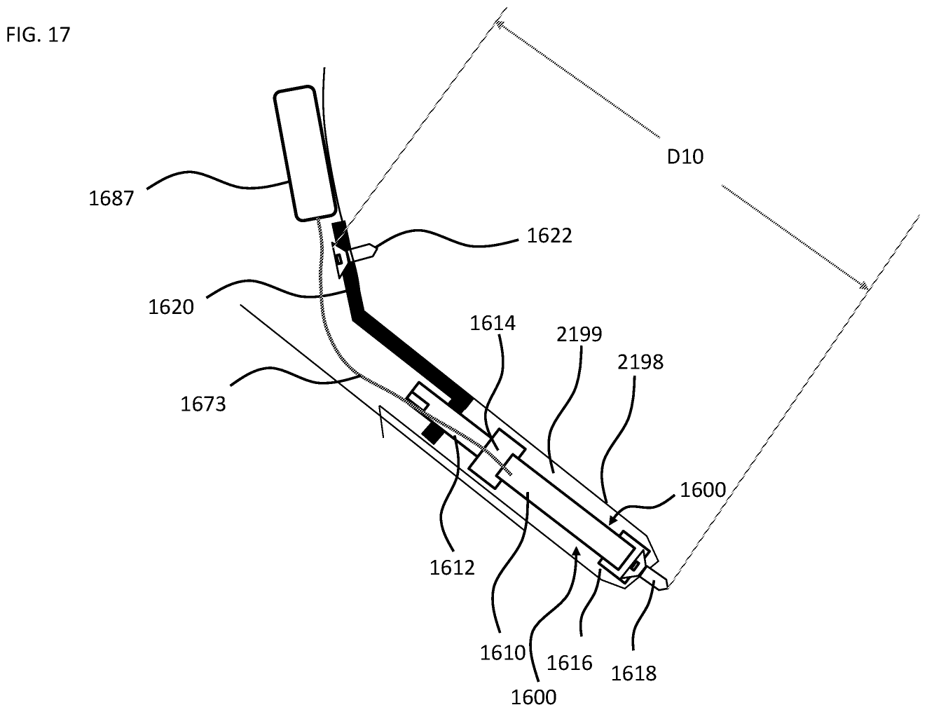

FIG. 15A also shows the lead 1540 connected to the feedthrough 1517, which supplies electrical current/voltage to the piezoelectric stack of actuator 1510. The lead extends to the receiver stimulator assembly on the surface of the skull (more on this below with respect to FIG. 17). It is noted that there can be utilitarian value with respect to “oversizing” the cavity 2199 in the lateral direction to provide room for the feedthrough running on the side of the actuator 1510. That said, it is noted that in alternate embodiments, electricity can be provided to the actuator at the top of the actuator, such as, for example, via the utilization of a hollow set screw or by utilizing components of holding fixtures and bracket assemblies to conduct electricity.

In an exemplary embodiment, the cavity has an average diameter normal to depth of 5, 6, 7, 8, 9, 10, 11, 12, 13, 14, or 15 mm or more, or any value or range of values therebetween in 0.1 mm increments and an average depth of 10, 11, 12, 13, 14, 15, 16, 17, 18, 19, 20, 21, 22, 23, 24, 25, 26, 27, 28, 29, or 30 mm or more, or any value or range of values therebetween in 0.1 mm increments. These values can be maximums in other embodiments.

FIG. 16 presents an actuator assembly 1600 located in the excavation 2199. (Note that the receiver coil and the implanted electronics that receive the signal from the coil and develop a control signal for the actuator are not shown—embodiments can use the receiver/receiver coil of the implants of the embodiments of FIGS. 2-6 noted above—more on this with respect to FIG. 17.) The actuator assembly 1600 has parallels to the device of FIGS. 15 and 15A detailed above. FIG. 17 presents an expanded view of the actuator assembly 1600 and the excavation 2199 as defined by the excavation wall 2198, where there can be seen a bracket 1620 corresponding to any of the brackets detailed above, which can be secured to bone via a screw 1622, but can instead be secured to bone via a bone cement arrangement or any other fixation regime that can have utilitarian value. The actuator 1610 is attached at one end to an adapter interface 1614 (sometimes herein referred to as a bracket, but in practice, element 1614 will often be different, such as a fixture) which is threadably engaged with threaded rod 1612, which threaded rod is also threadably engaged with the bracket 1620. By utilizing two separate thread directions, turning the threaded rod 1612 in a clockwise direction for example will drive the threaded rod 1612 downward into the excavation 2199, and can also drive the fixture 1614 (this can be a cylinder with a cup hollow portion that grips part of element 1610 in an interference fit or by the use of an adhesive) downward further into the excavation 2199. That said, in an exemplary embodiment, fixture 1614 can be fixedly attached to rod 1512 so that when rod 1612 turns, adapter interface 1614 also turns by the same amount, or adapter interface 1614 does not turn, and the rod turns relative to the fixture. Adapter interface 1614 is connected to actuator 1610, where the opposite end of actuator 1610 is connected to fixture 1616 (this can be a hollow cylinder/cup shaped body as with fixture 1614 above). Fixture 1616 is fixedly attached to the bottom of the excavation 2199 via screw 1618 as shown. It is noted that any one or more of these components can rotate relative to the other components so as to enable the threaded rod 1612 to rotate and thus establish the preloading on the actuator 1610. The idea is that by utilizing the threaded rod 1612 to preload the actuator 1610, there will be no airgap between the actuator 1610 and the fixation points (and also not between the fixation points and the bone/between the body parts to which the fixation points are connected). This as compared to the moving mass actuators of FIG. 8 for example.

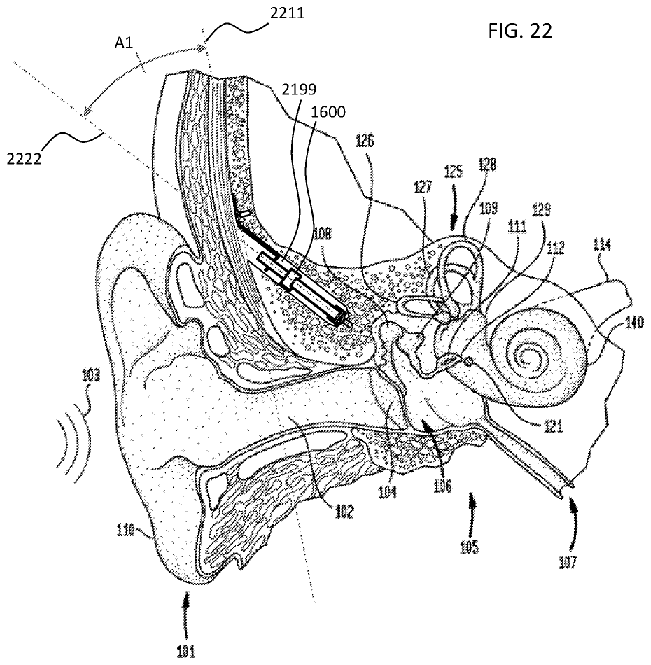

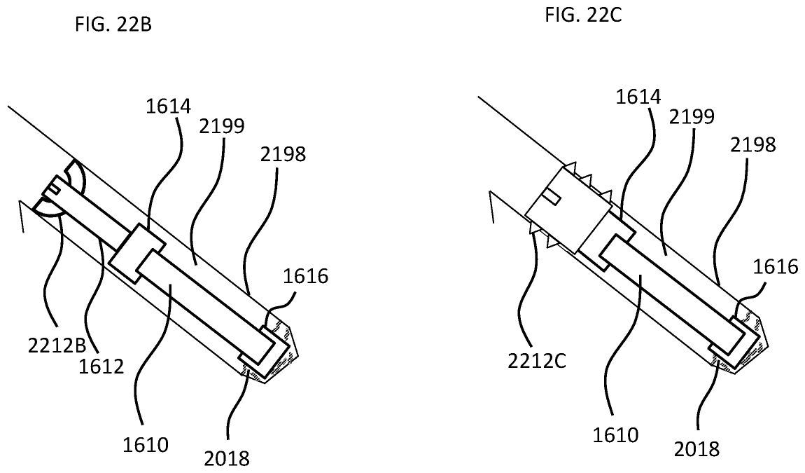

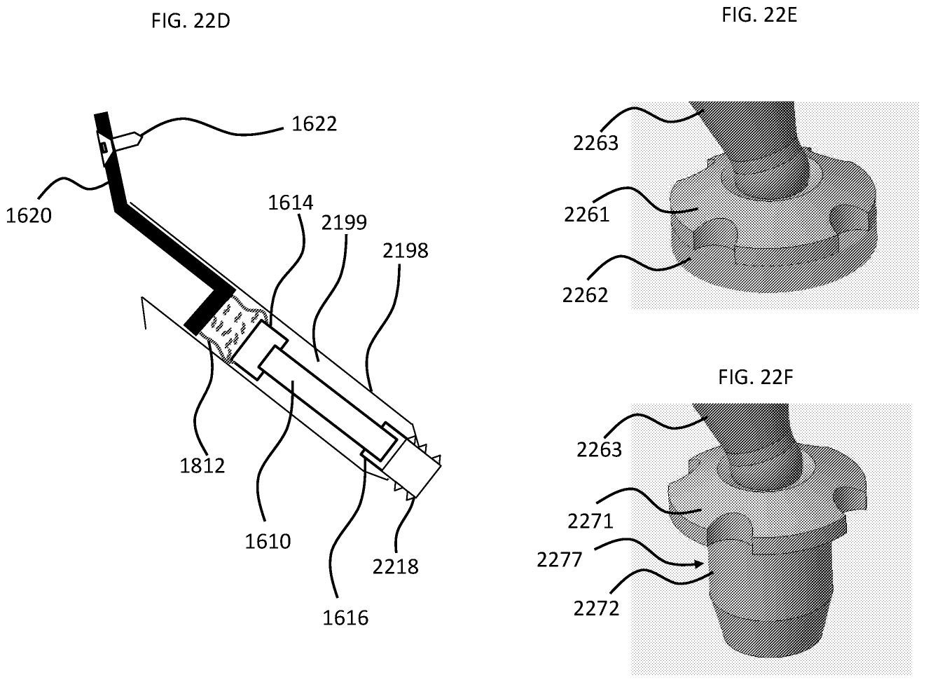

The embodiment of FIG. 16 shows a target area to the left of the top of the malleus 126. Other embodiments can have a target location elsewhere. In an exemplary embodiment, for example, the target area can be located closer to the semicircular canals, such as a target area represented by the X 21474 in FIG. 16. An embodiment can have a target location (bottom most portion of the implant) less than, equal to or greater than 1, 1.5, 2, 2.5, 3, 3.5, 4, 4.5, or 5 mm or any value or range of values therebetween in 0.1 mm increments from the lateral semicircular canal (for example). Indeed, jumping ahead to FIG. 22, the Angle A1 could be 75 or 80 or 85 or 90 degrees for example (the back end/opening of the bore thus might be located “lower” (in the frame of reference of FIG. 22) than that shown to accommodate the different target location).

That is, regardless of how much the piezoelectric stack expands and contracts during normal functioning/operation of the hearing prostheses, there will never be an airgap located between the fixation points.

FIG. 17 depicts a dimensions D10 which is the linear distance between the two furthest portions of the bone attachment components of the actuator assembly that interface with bone (here, the bone screws, as will be detailed below, this could be bone cement or a spring or a bone fixture). Here D10 is equal to or more than 5, 6, 7, 8, 9, 10, 11, 12, 13, 14, 15, 16, 17, 8, 19, 20, 21, 22, 23, 24, 25, 26, 27, 28, 29, 30, 31, 32, 33, 34, 35, 36, 37, 38, 39, 40, 41, 42, 43, 44, or 45 mm, or any value or range of values therebetween in 0.1 mm increments. In an alternate embodiment, D10 can be the linear distance between the two closest portions of the bone attachment components. And note that values can also be for any component that directly contacts tissue. Thus, in some embodiments, there is an apparatus that includes an actuator assembly that includes the actuator, where there is a first tissue interface device and a second tissue interface device, where the first tissue interface device has a portion that is at least D10 away from a portion of the second tissue interface device.

In an exemplary embodiment, the actuator assembly, not including electrical leads (but including a feedthrough—electrical leads are part of a power transmission system) when implanted and fully attached to the bone (the actuator assembly includes all the brackets and fixtures and bone screws, etc.) can fit within a 6 sided box that has a width of 5, 6, 7, 8, 9, 10, 11, 12, 13, 14, or 15 mm or any value or range of values therebetween in 0.1 mm increments, a length of 5, 6, 7, 8, 9, 10, 11, 12, 13, 14, or 15 mm or any value or range of values therebetween in 0.1 mm increments, and a height D10 plus 5 mm (and note that the D10 is used for textual economy—this does not mean that the height must be 5 mm larger than whatever the D10 value is) or any value or range of values therebetween in 0.1 mm increments. In an exemplary embodiment, the actuator assembly when implanted and fully attached to the bone (the actuator assembly includes all the brackets and fixtures and bone screws, etc.) would exceed an interior size of a 6 sided box that has an interior width of 3, 4, 5, 6, 7, 8, 9, 10, 11, 12, or 13 mm or any value or range of values therebetween in 0.1 mm increments, an interior length of 3, 4, 5, 6, 7, 8, 9, 10, 11, 12, or 13 mm, or any value or range of values therebetween in 0.1 mm increments, and an interior height D10 plus 3 mm (again, using D10 for textual economy) or any value or range of values therebetween in 0.1 mm increments.

In the interests of completeness, FIG. 17 also shows housing 1687 connected to the actuator assembly 1600 via leads 1673. Here, housing 1687 can house an implanted receiver unit and stimulator unit hermetically sealed within that biocompatible housing, and are sometimes collectively referred to as a stimulator/receiver unit. Functionally, the receiver unit and stimulator unit can function in an analogous manner to the receiver unit 232 and stimulator unit 220 above. Not shown is the implanted coil that is in signal communication with the electronics inside the housing 1687 via a feedthrough through the housing. Functionally, the implantable portion of the hearing prosthesis of FIG. 17 functions in a manner analogous to the functionality of the arrangement of FIG. 2A above. The functionality and structure will not be repeated here except to note that the functionality and structure of the arrangement of FIG. 2A is appropriately varied as one of skill in the art would understand to operate the actuator assembly 1600 and variations thereof herein any utilitarian manner. That said, housing 1687 can be replaced with implanted receiver coil 456 in some embodiments (or more accurately, the vibratory apparatus 453 of FIG. 6 can be replaced with the actuator assembly to obtain a fully functional transcutaneous bone conduction device—but again, the subject matter of the device of FIG. 2A can be modified with the actuator assembly of the embodiments herein and some other modifications to achieve a fully functional transcutaneous bone conduct device).

And it is briefly noted that in an exemplary embodiment, the piezoelectric element(s) are utilized to gauge or otherwise sense the amount of preloading. The piezoelectric element(s) can be the same as the actuator elements or can be another separate element(s). By way of example, the piezoelectric elements can be utilized as a transducer to measure the amount of compression thereon. In this regard, the piezoelectric elements could provide an output voltage during the compression of the stack during the preloading, which output voltage is measured to determine the amount of preload. Essentially, the leads from the piezoelectric stack can be utilized to monitor the change in voltage with the generation of a voltage in the piezoelectric stack owing to the compression resulting from the torquing of the pre-loading components, including any of the preloading regimes detailed herein, whether that be a spring or the threaded rod 1612, etc. A torque meter can also be utilized to gauge the amount of preloading on the piezoelectric stack 1610 in some other embodiments. Breakaway bolts can also be used that break upon the application of a high enough torque so as to avoid over loading the piezoelectric stack.

In an exemplary embodiment, the receiver component to which the piezoelectric actuator is in electrical communication during normal use can be utilized to monitor the voltage or other electrical properties in the piezoelectric actuator to estimate or otherwise determine the preload. In an exemplary embodiment, a surgical tool, or surgical test set or the like can include an RF inductance coil that can read telemetry from the implantable component's RF inductance coil, where the RF inductance coil of the implantable component is in signal communication with the receiver electronics (or more accurately transceiver electronics) of the implant, which receiver and/or transceiver electronics receive a signal that is at least based on the electrical signal from the piezoelectric stack. Thus, the implantable component can provide telemetry to the surgical test set indicative of the voltage induced in the piezoelectric stack owing to the compression, which telemetry can be utilized to monitor the compression.

In some embodiments, an accelerometer is mounted on or proximate the front end coupling. This is used to monitor the coupling quality, at least for low impedance structures. Output from the accelerometer can be provided to the transceiver of the implantable component, and information based on the output of the accelerometer can be uploaded to the external component as telemetry, or can be evaluated to determine the quality of the preloading or otherwise the coupling quality. This as compared to preload detection, which has utilitarian value for high impedance structures.

In an exemplary embodiment, the implant continuously or relatively continuously or periodically monitors coupling quality utilizing the techniques detailed herein or any other technique that can have utilitarian value, it is configured to provide output to the external component and thus to a recipient and/or a healthcare professional indicative of the coupling quality.

In an exemplary embodiment, the techniques detailed herein can be utilized to fine-tune the preload.

In an exemplary embodiment, the telemetry can be utilized after implantation to determine the existing preload on the piezoelectric stack which may have changed over time. In this regard, as will be detail below, embodiments can be implemented in pediatric situations where after implantation, the recipient's bone will grow, and thus there could be a change in the preloading of the actuator over time. (Of course, this can also occur owing to fatigue on the components or otherwise where on the components and/or due to adaptation of bone over time.) Regardless of the reason for the decrease in preloading, periodically, voltage measurements or any other utilitarian electrical phenomenon measurements can be made of the piezoelectric stack to estimate or otherwise determine the preloading thereon. This can be done utilizing the implant itself, either automatically or under the control of an external device is signal communication with the implant via the transcutaneous RF inductance link. An indication can be given buy back telemetry to an external component or some other test set indicating the preload and/or indicating whether or not the preload is within specifications. In an exemplary embodiment, a healthcare professional may then execute one or more of the remedial preloading techniques detailed herein to increase the preload from that which is the case after the reduction in preload. Alternatively, as noted herein, in some exemplary embodiments, the device can have a self-adjusting preload feature which can increase the preload after implantation, thus enabling an increase in preload after implantation without requiring surgery or otherwise accessing the actuator directly or a component of the actuator directly.

In an embodiment, after sensing the preload adjustment could be done by the stack(s) (with offset voltage). Another alternative is to manually adjust (re-surgery). As we detail below, another alternative is to use the spring itself which covers the growth compensation.

That said, embodiments can provide for skull growth compensation by utilizing the threaded rod 1612. In an exemplary embodiment, as the recipient grows, a minimally invasive procedure can be executed to access the threaded rod and provide/restore preload by “tightening” (retightening) the threaded rod 1612. That said, in an exemplary embodiment, a separate powered actuator can be used (an actuator added in addition to the piezoelectric stack of the implant detailed above). For example, a rotary electrically and/or vibrationally controlled/powered actuator can be used to apply a torque to the rod to apply a load after implantation/after the recipient grows without a surgery, minimally invasive or otherwise. This could be mounted at the back end for example. Indeed, a spring loaded actuator can be present that would apply a torque to the rod to tighten the assembly upon receiving a simple signal to release some of the spring energy (this way, the only power needed is to provide a signal to the actuator to activate—the mechanical energy is stored in the actuator with a spring device). Thus, there is an apparatus that is configured to compensate for and/or enable at least minimally invasively compensate for pediatric growth of the skull.

In an exemplary embodiment, the actuator can be adjusted or otherwise the preload of the actuator can be adjusted by extending a device through an incision in the skin no greater than 20, 15, 10, 9, 8, 7, 6, 5, 4, or 3 mm, or any value or range of those therebetween in 1 mm increments in length. That said, in an embodiment, the actuator can be adjusted or otherwise the preload the actuator can be adjusted without incising into the skin at all otherwise passing a solid body through the skin (radiation can be used to free a pretensions actuator in part for example, or an ultrasound can be used to power an implanted actuator).

Corollary to this is that a spring based anchoring system can also allow for pediatric application (just as can be the case with the threaded rod), as such systems maintain the zero-clearance interface as the skull grows). Additional details of this will be described below.

And note that when “preload” is used herein, it is in some embodiments presented as a proxy for the zeroing out of any airgap that may exist for whatever reason.

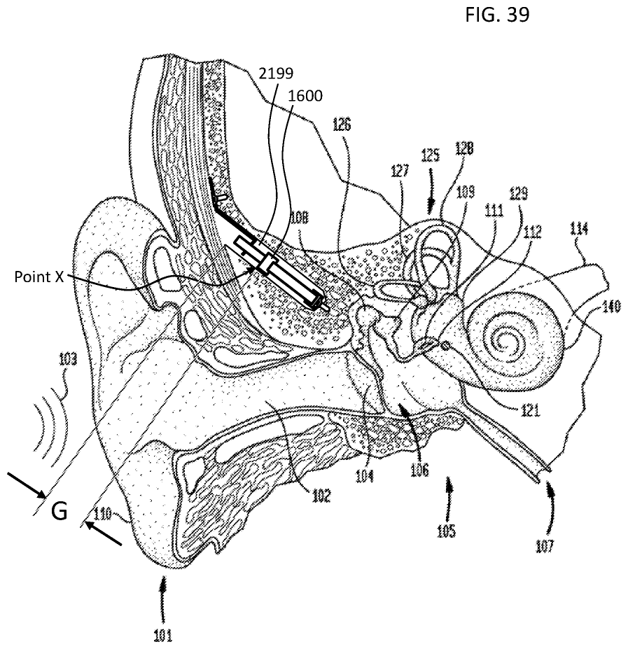

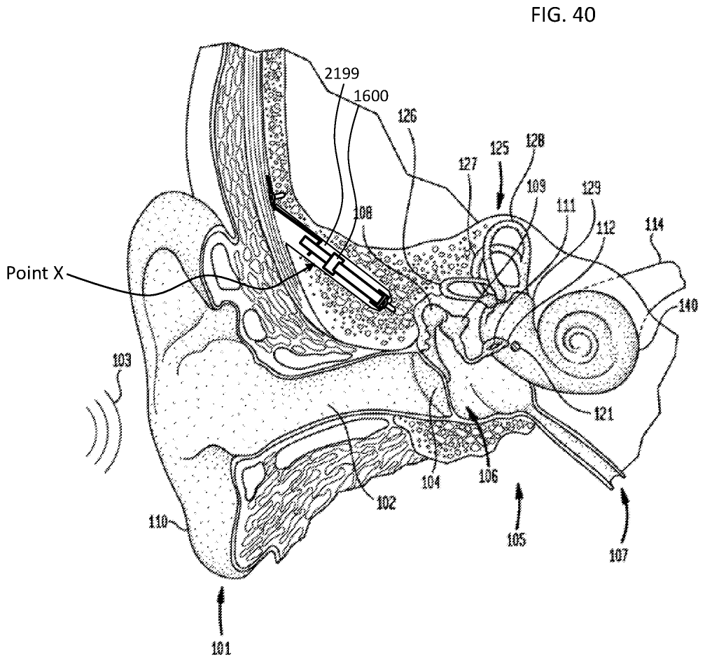

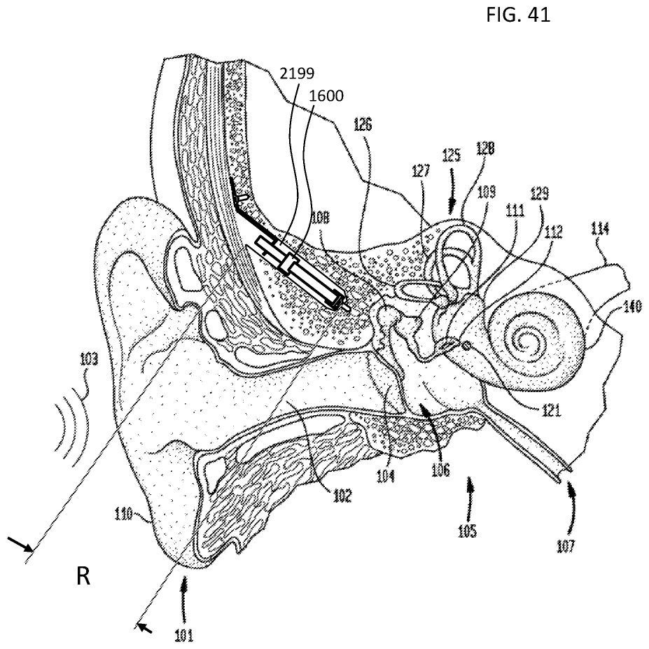

Thus, in an embodiment, the actuator can be controllably moved in the artificial cavity (or at least preloaded). This can be under the control of a powered actuator for powered movement or by manual movement (with or without a tool). Moreover, in some exemplary embodiments, upon completion of the action of fixation of the actuator, portions of the artificial cavity surrounding the actuator can move in a longitudinal direction relative to the actuator due to growth without causing the transducer to move. In this regard, FIGS. 39 and 40 depict by way of conceptual representation only the growth of the skull of a recipient from temporal location A (e.g., childhood, or infancy) to temporal location B (e.g., post adolescence or pre-adolescence but post infancy) in a one G environment, where FIG. 39 conceptually represents the size of the skull and the location of the implantable apparatus at temporal location A, and FIG. 40 conceptually represents the size of the skull and the location of the implantable apparatus at temporal location B (point X can be seen to move, at least relative to the actuator). As can be seen, the size of the skull has enlarged between the two temporal locations. The length of the cavity has lengthened and/or has expanded in the radial direction (the diameter has increased). Accordingly, as can be seen, midpoint of the cavity has moved away from the implantable apparatus in general, and from the rearmost location of the implantable apparatus in particular. (It is briefly noted that FIGS. 39 and 40 are but conceptual.) In an exemplary embodiment, from temporal location A to temporal location B (and, with respect to the arrangement of FIG. 41, dimension R, which is measured from the surface of the mastoid bone/opening of the cavity to the deepest portion of the cavity where the implantable component working end is attached to the bone when the system is at rest) the length the passageway cavity increases and/or the dimension G increases by at least or by no more than 1, 2, 3, 4, 5, 6, 7, 8, 9, 10, 11, 12, 13, 14, 15, 16, 17, 18, 19 or 20 percent or more or increases by any value or range of values therebetween in 0.1% increments. In an exemplary embodiment, temporal location A and B is separated by or at least by 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 80, 90, 100, 125, 150, 175 or 200 months, or any value or range of values therebetween in 1 day increments.

The adjustment screw and/or other adjustment mechanisms can be used to compensate for any changes in R that can impact actuator performance/implant performance, and thus can accommodate any of the just noted growth phenomena in at least some embodiments. Accordingly, in an exemplary embodiment, the methods herein can be practiced where the recipient is in adolescence or pre-adolescence and the actuator is at least partially located in a portion of the recipient subject to growth movement relative to the actuator. By way of example only and not by way of limitation, the portion of the recipient where the transducer is at least partially located can be the excavation in general, and the wall of the excavation in particular.

Still further, in an exemplary embodiment any one or more of the method actions herein can be practiced where the recipient is less than C years old and a portion of the recipient where the transducer is at least partially located is subject to growth movement relative to the transducer. In an exemplary embodiment, C is 1, 2, 3, 4, 5, 6, 7, 8, 9, 10, 11, 12, 13, 14, 15, 16, 17, 18, 19, or 20, or any value or range of values therebetween in 0.01 increments.

In another exemplary embodiment, the actuator 1610 can be controlled to contract or otherwise be in the contracted state when the bracket 1620 or whatever bracket is being utilized is attached to the rest of the assembly and the assembly is mounted in the cavity 2199. This would by definition provide a preload when the actuator is permitted to extend to its non-contacted state.

By way of example only and not by way of limitation, the actuator could be placed into a contraction mode during implantation to contract the actuator, and then, after all the components are mounted together, the contraction mode is removed, and thus the actuator expands to its relaxed state.

This arrangement differs from the type 1 arrangement detailed above in that there is no mass that moves back and forth, or, more accurately, the only mass that news is the mass of the actuator, and there is no seismic mass phenomenon that results from the actuation of the actuator, as contrasted to the actuator of the embodiment of FIG. 9 above.

This arrangement also differs from the type 2 arrangement in that the fixation points effectively do not move. That is, any movement of the fixation points relative to one another is de minimus. As will be detail below, the total expansion and contraction of the stack will typically be less than two or 3 μm (and sometimes far less).

Accordingly, the embodiment of FIG. 17 by way of example and thus the embodiments of FIGS. 14 and 15 by way of example, include a two point fixation principle where the back and front-end of the actuator are fixed between 2 separated points (as is the case with the type 2 arrangement noted above). Here, the first fixation point can be at the screw 1618, and the second can be at the screw 1622. Relative movement between the two will be negligible (as compared to the stroke of the middle ear implant of FIG. 5 for example).

In an exemplary embodiment, a distance between the two fixation points that changes during action will be less than and/or equal to 5, 4, 3, 2, 1.5, 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01 percent, or less or any value or range of values therebetween in 0.001 percent increments (e.g., 1.553 percent, 0.777 percent, 1.11 to 0.564 percent, etc.) of the at-rest/non-energized actuator distance. That is, if the at rest distance has a unit value of 1, the increase in distance will not be more than 0.03 units if the change is limited to 0.03 percent or less (so the distance could increase by up to 1.03).

It is noted that the aforementioned values are values related to the normal operation of the prosthesis and/or can be related to the maximum performance capabilities of the prosthesis. By way of example, if the maximum voltage that can be applied to the piezoelectric stack by the implanted device is X volts, then upon the application of X volts, any expansion will be limited by the aforementioned parameters. Further by way of example, if the prostheses is configured so that the maximum voltage that can be applied to the piezoelectric stack is limited to a lower value than the total capability of the prostheses (which may be done to ensure that there is a comfort level that is established), and expansion would be limited by the aforementioned parameters. Note also that in some embodiments, the aforementioned parameters are in situ parameters, while in other embodiments, the aforementioned parameters are parameters that exist when the actuator assembly is not attached to anything or otherwise where there is no restraining force or little restraining force on the actuator. That is, even without any restraining force, the total amount of change in distance will be the aforementioned parameters.

In an exemplary embodiment, change in distance of the fixation points from the at rest/non-energized state will be less than and/or equal to 5, 4, 3, 2.75, 2.5, 2.25, 2, 1.75, 1.5, 1.25, 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01 micrometers, or any value or range of values therebetween in 0.001 micrometer increments. Again, the aforementioned actuator environments apply.

In an embodiment, there is a front-end coupling to a solid substrate (or there can be simply the pressure applied by the preloading) which is located closer to the cochlea, such as in the recess/excavation 2199 in the skull, and thus is closer than a typical skull surface based type 1, such as that which is the case with the device FIG. 6. By way of example only and not by way of limitation, the device of FIG. 6 typically has the actuator mounted to the skull at a location in back of the ear (posteriorly versus the ear) and slightly above the ear canal, which can be a distance of more than 2, 2.5, 3, 3.5, or 4 inches from the closest portion of the cochlea. Conversely, the arrangement of FIG. 16 can have that front-end coupling within 1.5, 1.25, 1, 0.75, 0.5, 0.25, 0.1, 0.5, or 0.25 inches, or any value or range of values therebetween in 0.01 inches of the cochlea. Thus, there will be less attenuation of the energy than that which is the case with respect to the device of FIG. 6 because there will be less bone for the energy to travel through to reach the cochlea. In some embodiments, the front end is within 3, 2, or 1 mm of the cochlea.

And note that for convenience, the coupling or otherwise the portion of the actuator assembly that interfaces with the bone that is closest to the cochlea will sometimes be referred to herein as the output end of the actuator assembly, even though there will be two output ends. Embodiments include an actuator that includes two output ends (two distinct output ends). This as opposed to a radially expanding actuator that has one output “end” (all around).

In this embodiment, where the end closest to the cochlea is in direct contact with hard bone or otherwise tissue that does not move or otherwise moves very little relative to, for example, the ossicles, there will be a mechanical impedance that is significantly higher than that which exists with the type 2 arrangement. The impedance would be along the lines of the type 1 arrangement.

In essence, the actuator assembly 1600 of FIG. 16 is a combination of type 1 and type 2 arrangements, and can be considered a type 3 arrangement. This is different than the type 2 and type 2 arrangements.

There can be utilitarian value with respect to the actuator assembly 1600 in that the floating mass principle is abandoned and instead a piezoelectric stack without mass (effectively without mass/any mass is de minimus compared to the seismic mass of the actuator of FIG. 9 for example—but it is noted that mass can still be added externally, such as at the back end) is implemented. This allows for the generation of relatively high forces at high and at low frequencies. The actuator assembly 1600 can deliver constant force output across the full audio range in some embodiments, whereas this is not the case for floating mass actuators and/or actuators that utilize a seismic mass, such as the actuator of FIG. 9 (where F=M*A, and a is typically lower at low frequencies as compared to high frequencies).

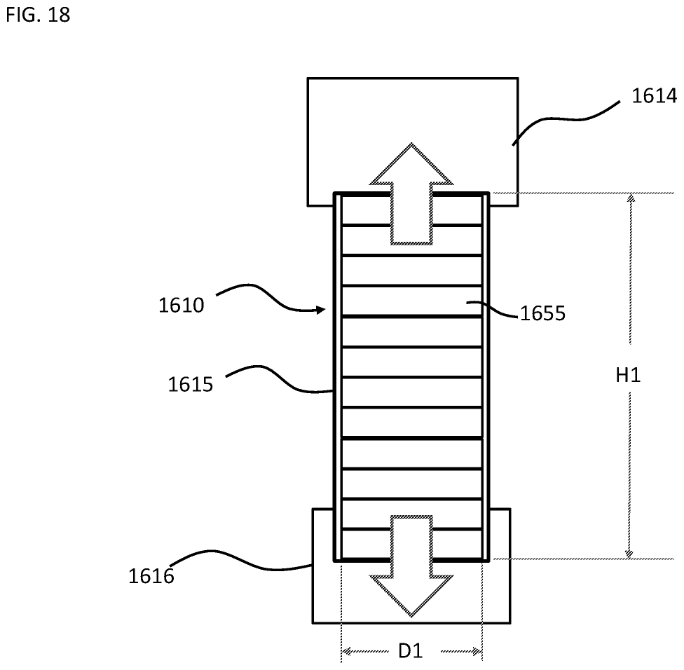

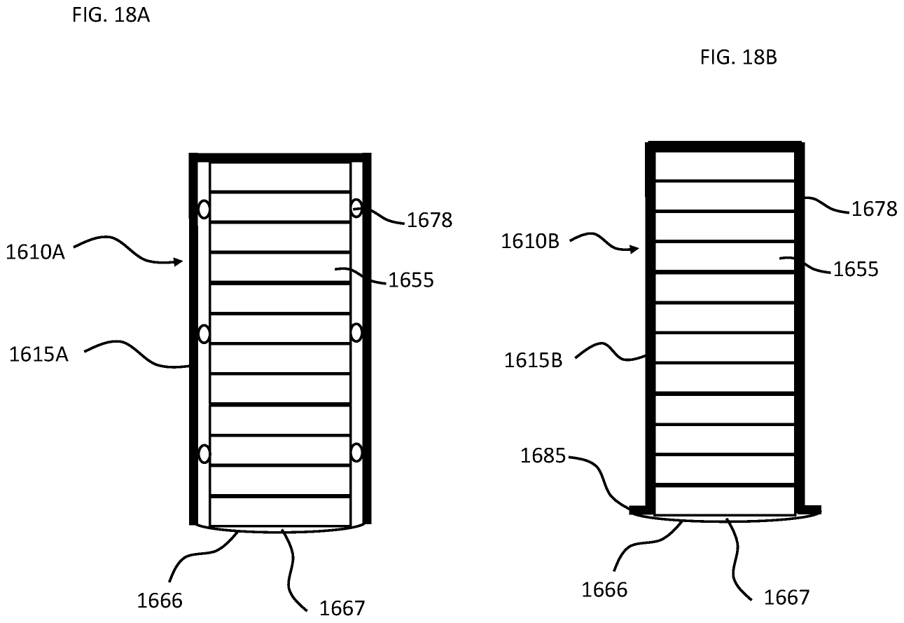

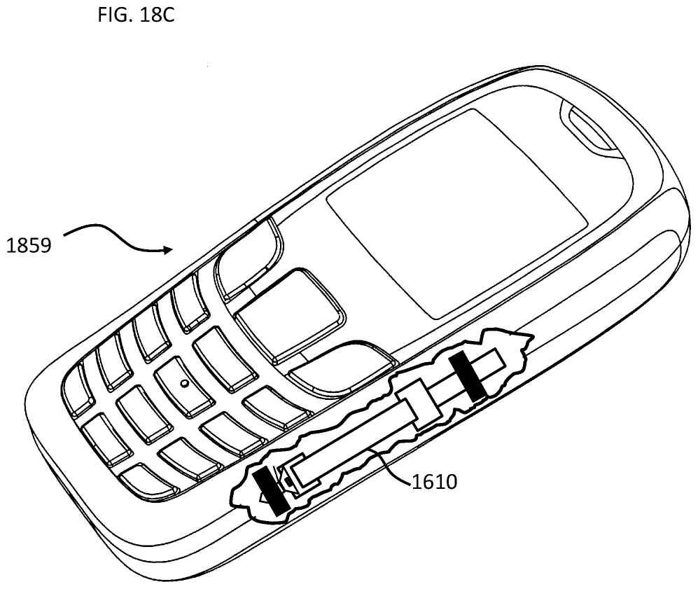

FIG. 18 shows a cross-section of the actuator 1610 and the interfaces 1614 and 1616. As seen, there are a plurality of piezoelectric elements 1655 that collectively form a piezoelectric stack. This is located inside a housing 1615 (the components of FIG. 18 have circular cross-sections and/or square or rectangular or oval shape cross-sections (any cross-section that has utilitarian value can be used), and are symmetric about the longitudinal axis of the actuator 1610). In some embodiments, the housing 1615 is a closed cylinder with a flexible bottom and/or top that enables the expansion of the piezoelectric stack 1655 to expand this flexible bottom, and thus moves the fixture 1616 accordingly (the bracket 1616 and/or the fixture 1614 can slide relative to the housing 1615, thus enabling the fixture(s) and bracket(s) to move relative to the housing). In an exemplary embodiment, the housing 1615 is an open cylinder (top and/or bottom) and the piezoelectric stack comes into direct contact with the fixture 1616 and/or 1614 (and again, the fixtures can slide relative to the housing 1615). In an exemplary embodiment, the housing 1615 is a closed housing, but is made so that the piezoelectric stack can expand the housing in the longitudinal direction. That is, the housing is sufficiently structurally weak (where the phrase weak is not utilized as a pejorative, but simply to differentiate from something that is structurally very strong) or otherwise sufficiently compliant so that the housing will expand with the expansion of the piezoelectric stack.

In an exemplary embodiment, the housing alone and/or in combination with the fixture or other components provides a hermetically sealed environment for the piezoelectric elements, and the housing and/or the other components provide for expandability and contractability. That said, in some other embodiments, the piezoelectric component(s) is/are made up of biocompatible piezoelectric elements such as that disclosed in U.S. Patent Application Publication No. 2016/0037274 to Dr. Marcus Andersson, published on Feb. 4, 2016, and thus can be directly exposed/open to the ambient environment.

FIG. 18 shows arrows indicating the direction of the force when the piezoelectric stack expands. This is consistent with all of the piezoelectric stacks herein unless otherwise noted.

Still, at least some embodiments are contemplated where the piezoelectric stack 1615 will be located in a housing such as a titanium housing that provides a totally hermetically sealed environment for the piezoelectric elements (aside from any feedthrough needed to provide for the conduction of electricity from outside the housing to inside the housing). FIG. 18A shows an exemplary actuator 1610A that includes a housing 1615A that has relatively thick walls along the sides and the top thereof, but a thin wall 1666 at the bottom. This provides for flexibility at the bottom and thus enables the expansion of the piezoelectric stack 1655 to be conveyed outside the housing. In an exemplary embodiment, the bottom portion of the housing moves in about a one-to-one relationship with the piezoelectric stack with respect to expansion thereof. In an exemplary embodiment, a spacer material 1667 is provided at the bottom of the piezoelectric stack so as to avoid line or point pressure of the piezoelectric stack on to the titanium housing and vice versa. In an exemplary embodiment, instead of a spacer material, the piezoelectric stack is dimensioned to provide for a rounded or a partial hemispherical surface so as to more evenly distribute the force onto the thin-walled housing material 1666 of the bottom of the housing.

In an exemplary embodiment, the thickness of the thin-walled portion corresponds to a value that is less than and/or equal to 30, 25, 20, 15, 14, 13, 12, 11, 10, 9, 8, 7, 6, 5, 4, 3, 2, or 1%, or any value or range of values therebetween in 0.1% increments of the thickness of the average thickness of the sidewall of the housing and/or the thickness at the top of the housing. In an exemplary embodiment, the affirmation thicknesses are average thicknesses (mean, median, and/or mode).

Also as can be seen in FIG. 18A is the utilization of compliant O-rings 1678. These can be utilized to space the piezoelectric stack 1655 away from the sidewall of the housing, and thus provide more clearance at the bottom with respect to the flexible bottom surface. In this regard, when a force is applied away from the interface between the thin-walled portion of the housing and the thick-walled portion of the housing, there is less concentrated stress in the thin-walled portion of the housing than that which would otherwise be the case if the piezoelectric stack extended all the way to the sidewalls of the housing. The O-rings 1678 can provide for maintenance of the lateral positioning of the stack and thus supplement or otherwise replicate the positioning features that would exist if the side wall of the housing was up against the piezoelectric stack. In an alternate embodiment, a flange can be located at the bottom of the housing, which flange provides greater distance from the piezoelectric material in the interface of the thin-walled portion of the housing with the remainder portion of the housing. This is shown in FIG. 18B where actuator 1610B comprises a housing with sidewall 1615B which snugly enveloped the piezoelectric stack 1655. At the bottom of the sidewalls is located a flange 1685 to which is attached the bottom thin-walled portion of the housing 1666 at locations outboard of the flange, two thus provide additional clearance between the attachment portions of the thin-walled portion and the rest of the housing and the piezoelectric stack to avoid stress concentrations.

As noted above, embodiments of the actuator assembly as detailed herein can utilize other devices beyond hearing prosthesis. In this regard, FIG. 18C shows an exemplary cell phone 1859 where the cutaway view as shown depicts utilization of the actuator 1610 and the fixtures and adjustment mechanisms detailed herein inside the cell phone. In an exemplary embodiment, the actuator 1610 can be actuated so as to provide a tactile feeling of vibration so as to alert the user of the cell phone that there is an incoming call or message without an audible sound that might otherwise disturb other people around the user. And it is noted that the cell phone can be a smart phone or a smart device (including a smart watch). Moreover, the actuator assembly can be used in a wearable alarm device that is not a cell phone. The device can be used in an alarm watch to provide for a tactile alarm. The actuator can be used in a computer mouse to provide feedback or a feeling of resistance to movement.

In some exemplary embodiments, the housing 1615 is sufficiently long that the housing will stretch when the piezoelectric stack expands. Such an embodiment can have utilitarian value with respect to interface apparatuses 1614 and 1616 that are fixed to the housing 1615 (in some embodiments, elements 1614 and 1616 are part of the housing).

The piezoelectric stack has a height H1 and a diameter D1. A piezoelectric stack with, for example, a height of 7.5 mm and a diameter of 6.5 mm can deliver in d33 mode +−8 N/V at full audio range. (The d33 effect is one of the different piezoelectric effects (others are d31 and d15) of piezoelectric transducers. When a pre-polarized layer of a piezoelectric component receives an electric charge with the same polarity it will expand in the axial direction (and contract in the radial direction). The axial expansion is used to generate the displacement (and thus stimulate the bone).) That said, a stack output (N/V) is also largely dependent on piezo layer thickness, and thus depending on the thickness, the aforementioned output values may vary.

In an exemplary embodiment, H1 can be less than greater than and/or equal to 2, 3, 4, 5, 6, 7, 8, 9, 10, 11, 12, 13, 14, 15, 16, 17, 18, 19, or 20 mm, or any values or range of values therebetween in 0.1 mm increments. In an exemplary embodiment, D1 can be less than greater than and/or equal to 1, 2, 3, 4, 5, 6, 7, 8, 9, 10, 11, 12, 13, 14, or 15 mm, or any values or range of values therebetween in 0.1 mm increments. Thus, it can be seen that in some embodiments, there is an apparatus that includes an actuator that includes a piezoelectric stack that is at least 5 mm in length (the length being the largest dimension and/or the dimension in which the stack expands/contracts).

In an exemplary embodiment, the stack can deliver, in a d33 mode, greater than and/or equal to +−2, 3, 4, 5, 6, 7, 8, 9, 10, 11, 12, 13, 14, or 15 N/V, or any value or range of values therebetween in 0.1 N/V increments over a range of frequencies of 2, 3, 4, 5, 6, 7, 8, 9, 10, 11, 12, 13, 14, 15, 16, 17, 18, 19 or 20 kHz where the range includes 0.1, 0.2, 0.3, 0.4, 0.5, 0.6, 0.7, 0.8, 0.9, 1, 1.5, 2, 2.5, 3, 3.5, 4, 4.5, and/or 5 kHz. In an exemplary embodiment, the variation in maximum output, where the maximum output is the denominator, is no more than 20, 19, 18, 17, 16, 15, 14, 13, 12, 11, 10, 9, 8, 7, 6, 5, 4, 3, 2 or 1% or any value or range of values therebetween in 0.1% increments over the aforementioned range of frequencies for a given voltage application, such as 1, 1.5, 2, 2.5, 3, 3.5, 4, 4.5, 5, 6, 78, 8, 9, 10, 11, 12 or 13 Volts or more, or any value or range of is therebetween in 0.1 V increments.

Thus, embodiments can avoid the underperformance at low frequencies that can exist in type 1 (and type 2) arrangements.

Accordingly, there is an apparatus that provides a force at actuator actuation over a frequency range that extends between 100 Hz to 15 kHz or any range of values therebetween in 1 Hz increments (such as 300 Hz to 10,000 Hz and inclusive of 300 Hz and 10,000 Hz) of a N/V value that varies no more than 35, 30, 25, 20, 15, 14, 13, 12, 11, 10, 9, 8, 7, 6, 5, 4, 3, 2, or 1% from the maximum N/V value and/or the average value (mean or median) over the entire frequency range.

Thus, there can be an apparatus, such as an implantable tissue stimulation portion of a hearing prosthesis, comprising an actuator, such as a piezoelectric actuator, a first tissue interface device (this can be a bone screw or can be a sphere that directly interfaces with bone, for example—the interface need not “attach” but can), and a second tissue interface device spaced away from the first tissue fixation device (again, this can be an attachment device but can also be a support device). Here, the apparatus is at least a partially extra-middle ear cavity dual bone interface force based implantable tissue stimulation portion of a hearing prosthesis. By partially extra-middle ear cavity, it is meant that at least a portion of the tissue stimulating portion is located outside the middle-ear cavity. By dual bone interface force, it is meant two distinct things separated by space vs. a single area, even if a broad-based area. As described herein, this can be achieved by mounting the actuator at two separate spaced away locations. The actuator has portion(s) that are not in contact with bone (e.g., the sides of the actuator and/or the bottom and/or top (laterally—the bottom would be the bone facing side, and the top would be the skin facing side, with the “sides” being in between—concomitant with embodiments that utilize a piezoelectric stack that expands/contracts in one direction as opposed to multiple directions and/or a bender or the like that imparts vibrations at one location) or mechanically decoupled from bone, or at least portion(s), if connected to the bone, are connected by lower impedance (mechanical impedance—as used herein, “impedance” refers to mechanical impedance”) components than that which is established at the locations that establish the dual bone interface. As can be seen above, in some embodiments, the stimulating portion is completely outside the middle ear cavity (that is, no part of the stimulation portion is inside the middle ear cavity). In some embodiments, no part of the prosthesis is in the middle ear cavity (parts beyond the stimulator portions). But note that in the case of a hybrid portion, an electrical stimulator portion can be located in the middle ear cavity. Thus, some embodiments are such that all mechanical stimulator portions of the prostheses are totally extra middle ear cavity. And note that in some embodiments, the teachings herein can be keyed off of a device interface. Any disclosure herein that keys off of an interface device corresponds to an alternate disclosure of keying off of a device/apparatus interface unless otherwise noted providing that the art enables such. It is also noted that any disclosure herein of a tissue interface device includes a disclosure of TiO blast coating applied there to or any other regime that facilitates osteointegration. In some embodiments, any tissue interfacing component can be an osseointegrating component and/or can be treated to be an osseointegrating component.

The embodiment of FIG. 16 provides zero clearance of the mechanical interfaces/the complete absence of an air gap between the actuator material and the remainder of the system, by, for example, having both the interfaces connecting the actuator front-end to the bone, and the actuator back-end to the bone, when the piezoelectric stack applies its (minimal) stroke. That is, in all states of the piezoelectric stack and/or in the deenergized state (where the stack is not expanded/is shrunk to its minimum in some embodiments), there is zero clearance between the stack and the rest of the components of the actuator assembly. Thus, when the piezoelectric stack expands, the full force thereof is transmitted to the bone all the time at all frequencies. And note that in at least some embodiments, force and displacement have an inverse relationship. Maximum force is obtained when the displacement is smallest, and visa-versa. In some embodiments, the relationship is linear, while in other embodiments, it is non-linear.

In an exemplary embodiment, a stroke length of a stack with a height H1 of 7.5 mm can be 0.05 μm/V (0.1 μm/V when height is doubled). This means that there is utilitarian value with zero (mechanical) clearance at both fixation points in order to allow for maximum force transfer.

In an exemplary embodiment, the expansion from the fully contracted state of the piezoelectric stack is 0.005, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.25, 0.3, 0.35, or 0.4 μm/V, or any value or range of values therebetween in 0.001 μm/V increments (based on the above-noted exemplary heights).

Embodiments can have utilitarian value in that the teachings herein can utilize high stiffness of device interfaces. Here, the stiffness (as per design and material e-modulus) of mechanical interface structures at the actuator front and back end can be high (including maximal feasible). This can prevent or limit or otherwise reduce to negligible any axial deformation when the stack applies its stroke. In some embodiments, thus, the interface has equal or higher stiffness than the bone structures directly contacting at the front and/or back end.

Corollary to this is that the mechanical impedance of human (interface) structures is also high in at least some embodiments. Here, the mechanical impedance of the bony structures at the back-end can be at least equal or higher than the impedance at the front-end (end closest to the cochlea) which is the stimulation target's displacement direction. (Note that displacement is a relative term. In high-impedance (bone impedance) scenarios, the displacement can be very small (approaching zero—infinitesimal). The idea is that stress always induces a strain however small. Theoretically, then there will always be a finite small displacement involved. The greater the bone impedance, the less the displacement. In some scenarios, the displacement will not be able to be measured or otherwise detected utilizing any feasible measurement regime. The displacement would likely not show up, for example, utilizing standard imaging techniques (e.g., CT scan), at least in some scenarios. If the surrounding bone is relatively stiff, an effectively immobilized actuator may result. This may effectively result in exerting force at two ends with effectively no displacement. This can be the case when low voltages are used to energize the piezoelectric component(s).)

The embodiments above have focused on the utilization of bone screws for the fixation portions. Embodiments can utilize other types of fixation regimes, such as, for example, bone cement. This can also be another material/substance, with a high stiffness—any material that is biocompatible and can enable the teachings herein can be used.

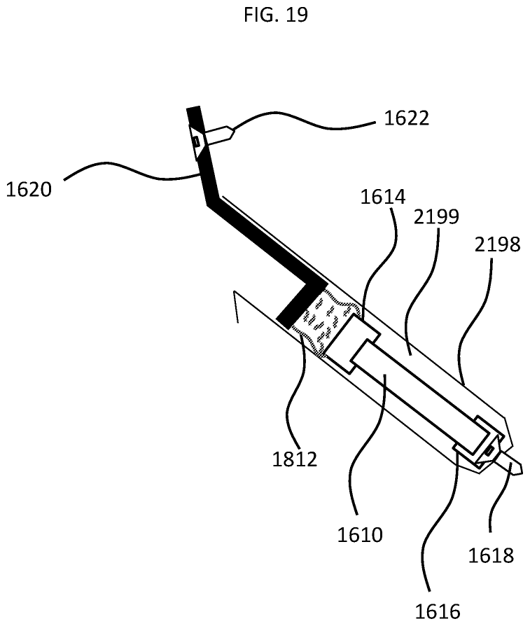

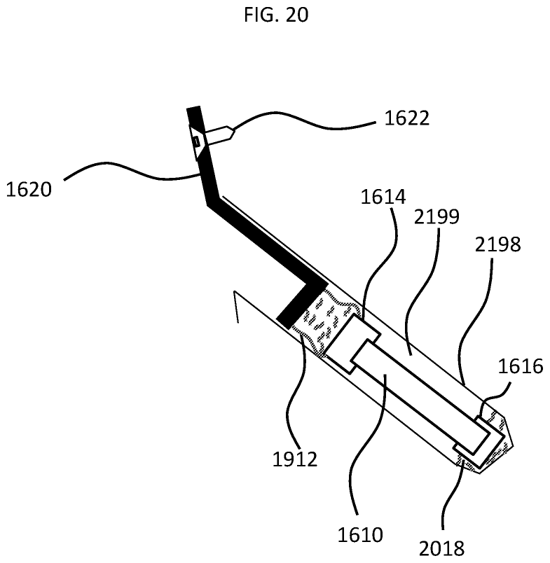

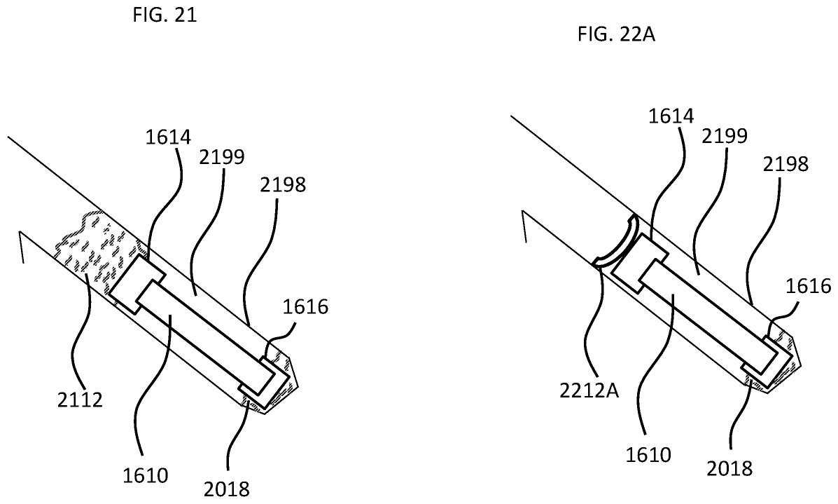

FIG. 19 shows an exemplary embodiment where bone cement 1912 is utilized to secure fixture 1614 to fixture 1620 as shown. FIG. 20 shows the utilization of bone cement 2018 to secure fixture 1616 to the bottom of the excavation 2199 as shown. FIG. 21 shows the utilization of bone cement 2112 to eliminate the bracket at the top and thus secure fixture 1614 to the walls of the excavation 2199. And it is noted that as with all embodiments herein, unless otherwise noted, and he component or feature detailed herein can be combined or replaced with any other component and/or feature detailed herein unless otherwise noted providing that the art enables such. In this regard, while the embodiment of FIG. 21 shows the utilization of bone cement at both ends of the actuator assembly, in another embodiment, a bone screw can be utilized at one end and bone cement can be utilized at the other by way of example (e.g., bone screw 1618 can be utilized in lieu of bone cement 2018, etc.).

It is briefly noted that any type of interface with the bone that can have utilitarian value and otherwise can enable the implementation of the teachings detailed herein can be utilized in at least some exemplary embodiments. In an exemplary embodiment, with respect to the back end bone interface (the interface point furthest from the cochlea), a solid fixed fixture with an adjustable screw to apply a preload can be utilized, and as will be described in further detail below, a solid fixed fixture with an adjustable spring to apply a preload can also be utilized. That said, the spring can be nonadjustable. In at least some exemplary embodiments, the fixture can be fixed to the bone utilizing a bone screw, while in other embodiments, the solid fixed fixture can be fixed to bone utilizing cement and/or glue, alone and/or in addition to the utilization of a bone screw. Indeed, any of the fixation system detailed herein can be combined with any of the other fixation systems detailed herein providing that the art enables such unless otherwise noted.

In some embodiments, a spring can be utilized to provide for the bone interface of the backend without a bracket. In an exemplary embodiment, the spring load is adjusted in other embodiments it is not adjustable. FIG. 22A shows an exemplary leaf spring 2212A that can be interference fitted into the excavation 2199 and can apply a downward force or otherwise a preload on to the actuator 1610 is shown. The spring is not a fixture per se. That said, embodiments include utilizing a fixture that has spring features to support a set screw which permits the set screw to be turned and otherwise provide for adjustability of the preload on the actuator. This is shown in FIG. 22B where spring 2212B as a threaded hole therethrough through which the set screw 1612 extends. The set screw 1612 can be adjusted utilizing a flat head screwdriver for example that fits into the slot. And it is briefly noted that in some embodiments, instead of a flathead, a Phillips head receptacle can be utilized in the threaded rod 1612, while in other embodiments, the end of threaded rod can have a hexhead to receive a female hex wrench by way of example. Any interface with a torquing tool to which the threaded rod can interface can be utilized to implement the teachings detailed herein providing that the art enables such unless otherwise noted.

As seen in FIG. 21, the backend bone interface can utilize bone cement. FIG. 21 shows that in an embodiment, the actuator assembly is implanted in a recipient in an artificial cavity in a skull, wherein at least two opposite sides of the apparatus are mechanically decoupled from the skull (the lateral sides, where there is no cement). In the embodiment of FIG. 21, the actuator assembly is implanted in a recipient so that actuation of the actuator imparts forces only on two sides of the actuator, with bone in between to which force is not applied, or more accurately, not directly applied. In some embodiments, to some extent the bone in between may experience forces, but these are not direct forces. This as opposed to the direct forces applied to the bone at the ends of the device.

FIG. 22C shows an exemplary backend bone interface that is pre-integrated in the actuator assembly. Here, fixture 2212C is rotatably connected to fixture 1614 and can be independent from element 2212C in some embodiments. Fixture 2212C has self-tapping threads that will cut threads into the sidewall 2198 of the cavity 2199 when a torque is applied thereto utilizing a flat head screwdriver positioned in the slot of the fixture. The fixture 2212C can be turned and thus driven into the cavity 2199 a given distance to apply a preload or otherwise a desired preload on to the actuator 1610.

Front end bone interface (the interface point closest to the cochlea) examples can include a screw such as shown in some of the figures above and/or an osseointegrated component, such as a titanium fixture or a titanium wedge or a titanium spike. This can be pressed into bone or screwed in the bone as applicable. In this regard, in an exemplary embodiment, the front end interface can be interface established by osseointegration. It is also briefly noted at this time that in some embodiments, the back end interface can also be established by an osseointegrated component, whether that be a fixture or a spike or another type of component, such as a titanium component. Any of the components detailed herein that can be osseointegrated can be utilized in combination with osseointegrated to establish an interface such as a long-term interface. (Front and/or back end interface can rely upon an osseointegrated component—that is, both actuator ends can be osseointegrated in some embodiments).

The front end bone interface can also be established by bone cement and/or glue, and this can be achieved by direct contact with the bone or between the piezoelectric actuator the fixture and a bone fixture.

It is briefly noted that the phrase “bone fixture” as used herein differentiates from a bone screw. A bone fixture corresponds to a more bolts like component than a screw. The two can have similar features but there is a difference. By way of example, the threaded element that is utilized to secure the actuator to bone in FIG. 6 is a bone fixture. Any disclosure of a bone screw corresponds to an alternate disclosure of the utilization of the bone fixture and vice versa unless otherwise noted. The front end and/or the back end interface can be established utilizing a bone fixture or a screw.

In this regard, FIG. 22D shows a bone fixture 2218 to which is affixed fixture 1616. In an exemplary embodiment, a torque wrench is applied to the outside of the fixture 1616 to interface with flats thereon to self threadingly screw the bone fixture 2218 into the bone.

It can be seen that by using a relatively deep excavation, stimulation at a location closer to cochlea can be achieved relative to a shallow or no excavation (where the piezoelectric stack would be mounted on the surface of the skull). This can provide utilitarian value in that a more effective transfer of vibrations can be achieved relative to the surface mounted arrangement, and this allows the elimination of/avoidance of the relatively high/long actuator stack inside the skull cavity, so there would be no protruding height on skull surface (avoids sticking out of the cavity).

FIG. 22E shows an exemplary frontend bone interface portion of the actuator assembly. Here, there is a ball joint established by the male partial spherical portion of fixture 2263 (or a component that is connected to the bottom fixture which in turn is connected to the actuator) which rotationally interfaces with a female portion in footplate 2261. The footplate can be a titanium disk with or without the wrench cavities shown (for a toothed wrench). This is nowhere embodiment, material 2262 comprises a bone cement or a bone adhesive, such as by way of example only and not by way of limitation, Transbond™ by the 3M™ corporation (but in some embodiments, a more stiffer material is used). In this exemplary embodiment, the distribution of local pressure is distributed over the disk. This can have utilitarian value with respect to the avoidance of bone erosion effect to the LSCC (lateral semicircular canal) area. In an exemplary embodiment, a cylindrical whole can be bored into the bottom of the excavation, which hole is sized and dimensioned to receive the titanium disk 2261. In an exemplary embodiment, this arrangement can be utilized and is utilized where the bone thickness beneath the disk is less than and/or equal to 0.5, 0.6. 0.7, 0.8. 0.9, 1, 1.1, 1.2, 1.3, 1.4, 1.5, 1.6, 1.7, 1.8, 1.9, or 2 mm, or any value or range of values therebetween in 0.01 mm increments.

FIG. 22F shows another exemplary embodiment of a front end bone interface. Here, element 2263 is the same as that of FIG. 22E. However, there is an integrated bone fixture 2277 that is made up of a flange 2271 and a cylindrical body 2272 that extends downward from the flange. Here, this can be a titanium bone fixture that can be screwed into bone. In an exemplary embodiment, element 2277 can be press fitted into bone. In an exemplary embodiment, a hole for the cylindrical body 2272 can be predrilled at the bottom of the excavation. Note also that a countersink or an offset whole can also be drilled to accommodate the flange 2271. In an exemplary embodiment, as with all of the fixtures and/or screws detailed herein, element 2277 can be self drilling and/or self-tapping. In an alternate embodiment, a bonding agent can be utilized to adhere the element 2277 to bone.

In an exemplary embodiment, the arrangement of FIG. 22F is utilized at the target area. In an exemplary embodiment, this arrangement can be utilized and is utilized where the bone thickness beneath the bottom surface of the flange greater than and/or equal to 3, 3.25, 3.5, 3.75, 4, 4.25, 4.5, 4.75, 5, 5.5, 6 mm or more, or any value or range of values therebetween in 0.05 mm increments.

Thus, it can be seen that in some embodiments, there is an apparatus, such as a hearing prosthesis bone conduction device (as distinct from the device of FIG. 2A, for example, or from a cochlear implant, or from a conventional hearing aid), comprising a piezoelectric actuator (although in some embodiments an electromagnetic actuator can be utilized), a first tissue fixation device (as distinct from a tissue interface device—a tissue interface device is a genus that includes the species of a tissue fixation device) and a second tissue interface device spaced away from the first tissue fixation device. (Note that the enumeration of the devices means that there are two different devices, as opposed to a single device that is divided up arbitrarily to achieve multiple distinct tissue interfaces. By way of example, a threaded body has one tissue interface device.) Wherein actuation of the actuator moves the first tissue fixation device relative to the second tissue interface device (in an embodiment, the movement is greater than, less than and/or equal to 5, 4, 3, 2.75, 2.5, 2.25, 2, 1.75, 1.5, 1.25, 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01 micrometers, or any value or range of values therebetween in 0.001 micrometer increments and/or 1.5, 1.25, 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01 micrometers/Volt, or any value or range of values therebetween in 0.001 micrometer). In this embodiment, the first tissue fixation device is attached to a first portion of skull bone of a recipient of the actuator and a second tissue fixation device abuts a second portion of skull bone that is fixed relative to the first portion of skull bone (note that the tissue interface can be a tissue fixation device—a tissue fixation device can be bone cement for example). In some embodiments, the first portion of the skull bone and the second portion of the skull bone is a same part of the skull, such as, for example, the temporal portion of the skull. In some embodiments, the first tissue fixation device is at or above a natural outer surface of the skull (as seen with screw 1622 in FIG. 17) or within 1, 2, 3, 4, 5, 6, 7, 8, 9, 10, 11, 12, 13, 14, or 15 mm, or any value or range of values therebetween in 0.1 mm increments of the natural outer surface of the skull (as is the case with the bone cement 2112 of FIG. 21). In some embodiments, all of the apparatus is located at least 1, 2, 3, 4, 5, 6, 7, 8, 9, 10, 11, 12, 13, 14, 15, 16, 17, 18, 19, or 20 mm or any value or range of values therebetween in 0.1 mm increments away from a cochlea of the recipient. In some embodiments, the bone to which the first tissue fixation device is attached and the bone to which the second tissue fixation device abuts has a thickness of at least 0.5, 1, 1.5, 2, 2.5, 3, 3.5, 4, 4.5, 5, 5.5, 6, 65, 7, 8, 9, or 10 mm, or any value or range of values therebetween in 0.1 mm increments directly beneath the respective devices. Again, as with the embodiments describe above, the first portion is located outside a middle ear cavity of the recipient (meaning completely outside) and/or the second portion is located outside the middle ear cavity of the recipient. In some embodiments, the entire apparatus is completely located outside a middle ear cavity of the recipient.

In an exemplary embodiment, there is a method of implanting the implantable component of the hearing prostheses detailed herein in general, and the actuator assembly in particular. First, the implantation site(s) are prepared by excavating bone such as to create a cavity 2199 as disclosed above (such as in FIG. 14C) and, optionally, excavating a recess for the top fixture on the upper surface of the bone. Further, in an exemplary embodiment, a recess is excavated for the housing of the receiver electronics and/or the RF inductance coil assembly that is in signal communication with the housing the receiver electronics. Then, the front end bone interface components are implanted or otherwise attached to the bone in the excavations, such as, for example, the front end bone fixture and/or the front end bone screw with the front end fixture. In an exemplary embodiment, the above-noted titanium footplate is attached to the bone utilizing adhesive and/or the above-noted titanium fixture is screwed into the bone. Then, the back end fixture is mounted to the bone. Then, the actuator is mounted in an adjustable manner between the front end interface and the back end interface, where the actuator can include the top fixture and/or the adjustment screw. Then, the pre-load is applied to the actuator. Optionally, the receiver electronics are attached to the actuator (if not already attached during the actuator insertion process). This can be done with a wire connection that forms a hermetically sealed connection. It is noted that the mounting sequence can be different from the order just detailed. The electronics and the actuator can be pre-attached in production. Also, in the event that a hybrid device is used, an electrode can be inserted in the method.

Moreover, in some embodiments, the apparatus is an implantable portion of a hearing prosthesis stimulator configured to operate over an output range up to at least 2, 3, 4, 5, 6, 7, 8, 9, 10, 11, 12, 13, 14, 15, 16, 17, 18, 19, or 20 kHz, or any value or range of values therebetween. The apparatus is configured so that when the apparatus is in free space (as opposed to restrained by connection to bone), the first tissue interface device moves relative to the second tissue interface device when the actuator is actuated. The second tissue interface device is a bone penetrating component (a bone screw or spike or a fixture, as opposed to the footplate for example, even if the footplate is located in an excavation—penetration means some form of interference with bone). Here, the second tissue interface device is a front end interface device relative to the actuator. Further, output of the actuator is between the first tissue interface device and the second tissue interface device.

In an embodiment, the apparatus can deliver at least 1, 1.5, 2, 2.5, 3, 3.5, 4, 4.5, 5, 5.5, 6, 6.5, 7, 7.5, 8, 8.5, 9, 9.5, or 10 N per Volt+−0.05, 0.1, 0.15, 0.2, 0.25, 0.3, 0.35 or 0.4 N applied to the actuator over a range of frequencies from 300 to 15,000 Hz or any value or range of values therebetween in 1 Hz increments (e.g., 100 Hz to 1,500 Hz; 500 to 5,000 Hz, 400 to 8,000 Hz).

Concomitant with the teachings detailed above, the apparatus is a stroke output and force output apparatus (and note that force and stroke are inversely related, as noted herein—force is maximum when stroke is minimum, and visa-versa). Indeed, without the stroke output, there is no force output. And the apparatus is an implantable portion of an active transcutaneous bone conduction device.

FIG. 22 shows an angular orientation regime of the actuator relative to the tangent plane of the surface of the bone at the location of the excavation 2199. More particularly, the tangent plane is represented by line 2211 and the longitudinal axis of the actuator/piezoelectric stack is represented by line 2222. As seen, the small angle between the two is labeled A1 (the figure shows an acute angle, but in some embodiments, this could be a 90° angle). In an exemplary embodiment, A1 is 90, 85, 80, 75, 70, 65, 60, 55, 50, 45, or 40 or any value or range of values therebetween in 1° increments. Thus, it can be seen that in some embodiments, where angle A1 is relatively high, by utilizing excavations according to the teachings detailed herein, a relatively tall piezoelectric stack can still be utilized without problems with too much protrusion of the actuator assembly above the outer surface of the skull.

As will be described in greater detail below, in some embodiments, the front end interface can be established by direct contact with bone, such as by pressing the actuator against the bone at the bottom of the excavation. Further, it can be seen that in some exemplary embodiments, the front end interface is established by a pre-integrated device in the overall actuator. By pre-integrated, it is meant that it is carried with the actuator when the actuator is placed into the cavity as opposed to being a component that is placed in before and/or after the actuator is placed in the cavity (or placed in the human in the case of a surface mounted actuator by way of example).

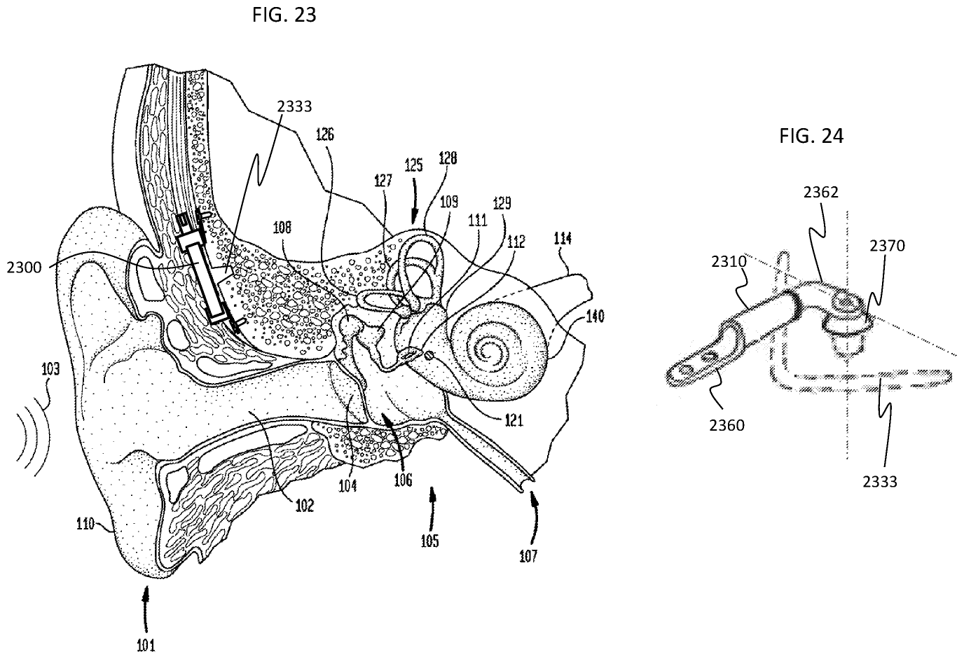

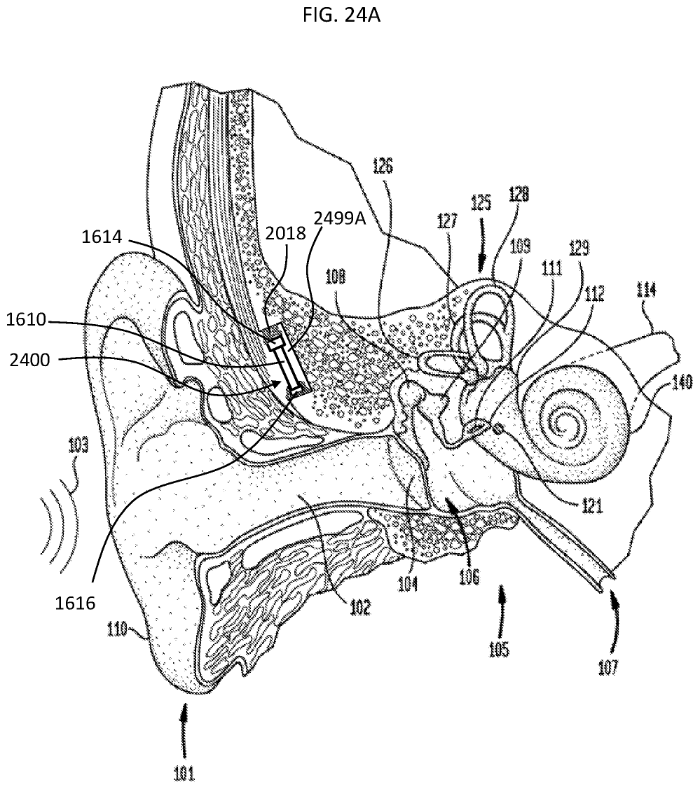

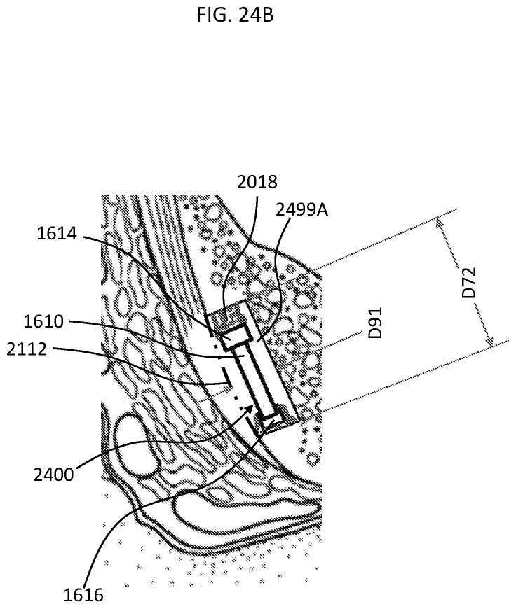

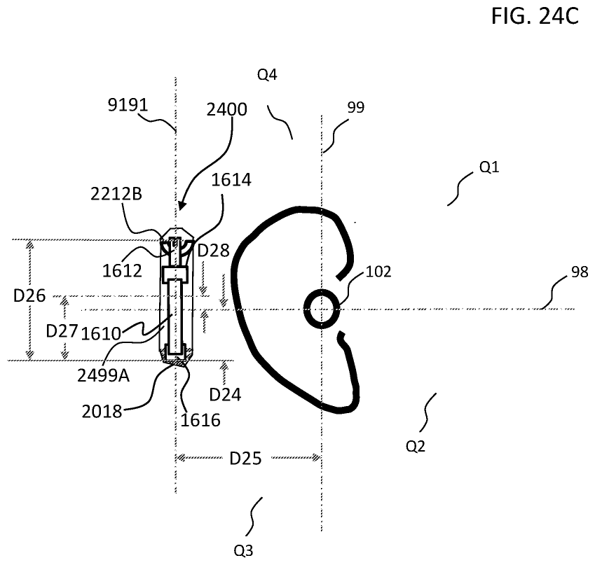

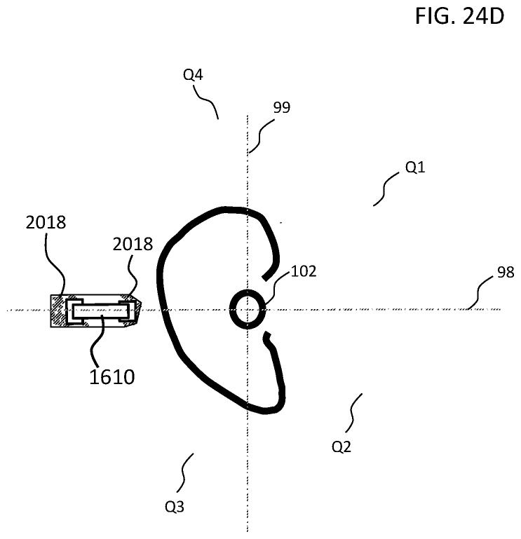

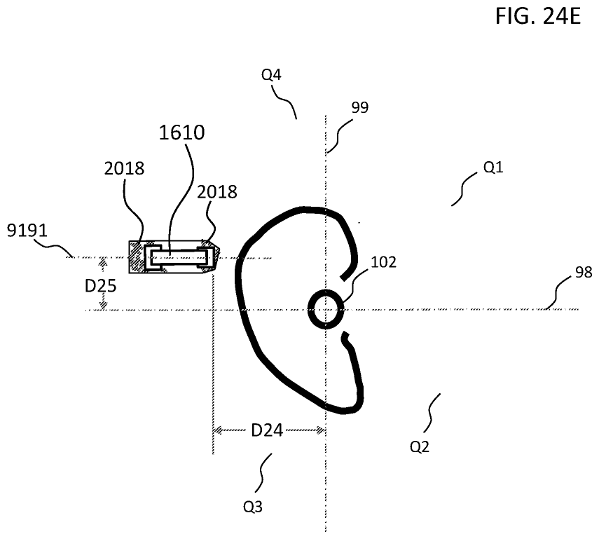

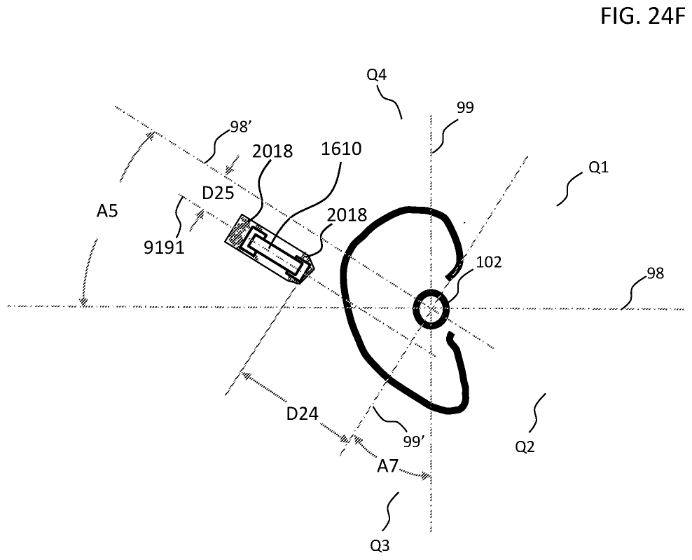

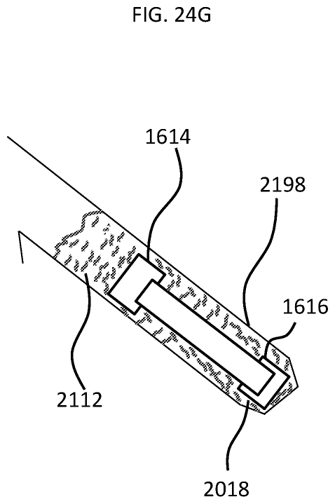

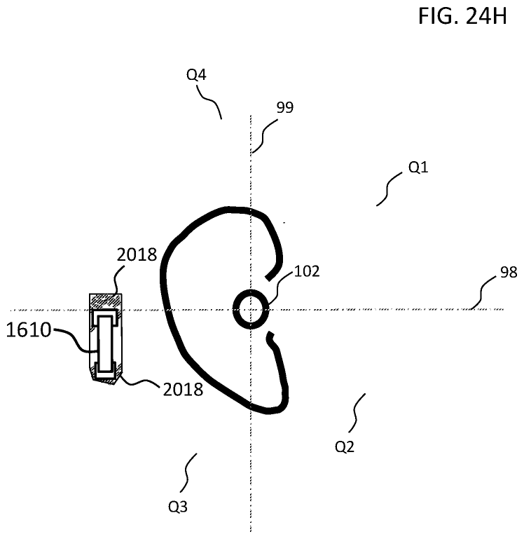

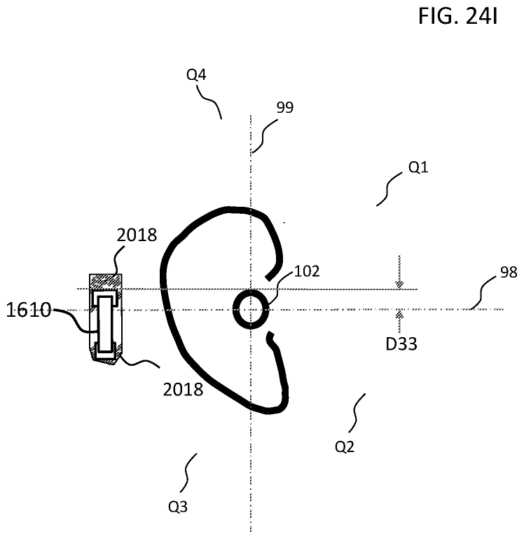

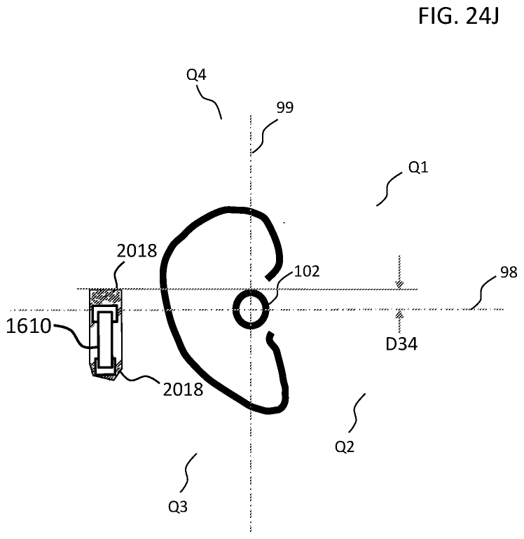

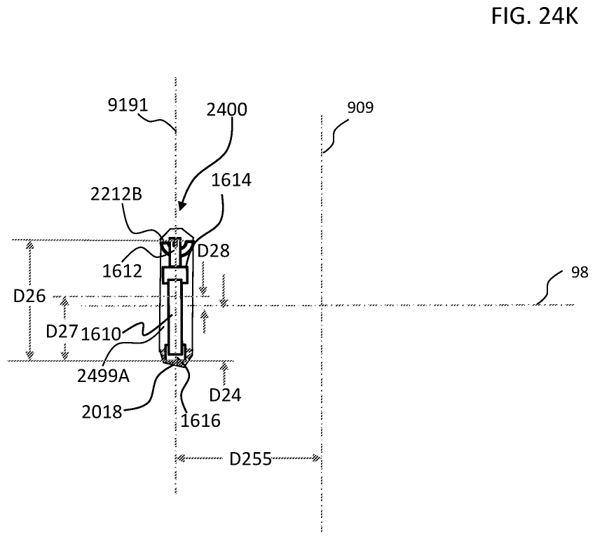

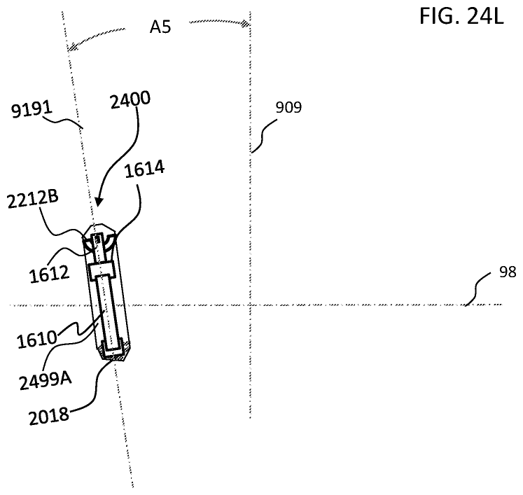

The above stack principle can still be used on the skull surface, such as where the piezoelectric stack is oriented parallel to the skull surface instead of having one of the higher angles of A1 noted above. The bone contact point(s) can be placed very close to the ear canal (closer to cochlea) than that which exists with the surface mounted bone conduction actuator of FIG. 6 for example. FIG. 23 presents an exemplary embodiment of an actuator assembly 2300 that has a piezoelectric stack that is mounted horizontally, the front end being located closer to the cochlea than the far end as shown. FIG. 24 presents an isometric view of the assembly 2310, where fixture 2360 and fixture 2362 are shown connecting the actuator 2310 to the bone. A bone fixture 2370 is connected to fixture 2362. Also shown, fixture 2362 is curved or otherwise has a dog leg, and thus the fixation points are not perfectly aligned along the longitudinal axis of the actuator 2310 (but they can be perfectly aligned). Also shown in FIGS. 23 and 24 is a trench 2333 that is excavated in the bone. The trench is located between the two fixation points as shown. This trench can have utilitarian value with respect to providing an expansion and contraction area on the surface of the bone that will result in less resistance to the force imparted to the bone by the actuator. In an exemplary embodiment, the trench has a width of less than, equal to and/or greater than 0.5, 1, 1.5, 2, 2.5, 3, 3.5, 4, 4,5, 5, 5.5, 6, 6.5, or 7 mm, or any value or range values therebetween in 0.1 mm increments, a depth less than, equal to and/or greater than 0.5, 1, 1.5, 2, 2.5, 3, 3.5, 4, 4,5, 5, 5.5, 6, 6.5, or 7 mm, or any value or range values therebetween in 0.1 mm increments, and a length (pacing length, not linear length) of less than, equal to and/or greater than 2, 3, 4, 5, 6, 7, 8, 9, 10 mm, or any value or range values therebetween in 0.1 mm increments.

The above stack principle can also be used in a manner where the actuator is at least partially recessed in the skull where piezoelectric stack is oriented parallel to the skull surface (or at least a direction of actuation is so oriented) instead of having one of the higher angles of A1 noted above. FIG. 24A presents an exemplary embodiment of an actuator assembly 2400 that has a piezoelectric stack that is mounted parallel to the skull surface, but recessed in a recess 2499A, one end being located closer to the cochlea than the other end. In this exemplary embodiment the actuator assembly 2400 is located above the ear canal 102, and actuator assembly 2400 is aligned with the center of the ear canal. However, in other embodiments, the actuator assembly 2400 can be located behind the ear canal and at a level of the ear canal 102. This can be seen in FIG. 24C. More on this in a moment. (It is briefly noted that the graphical positions may not be exact in some embodiments. For example, a position of the top of the actuator might be aligned with a top of the ear canal. Note that embodiments include actuator positioning that is not as “high” in the X direction, as will be describe further below.)

With regard to FIG. 24A, there is a relatively shallow (with respect to its length) excavation 2499A located in the surface of the skull as shown. The depth of the excavation of this can be limited to that which is sufficient to locate the entire actuator assembly 2499 below the extrapolated surface of the skull (the extrapolated surface being where the skull surface was or otherwise would be if the excavation did not occur). In some embodiments, the depth could be less than this, owing to the fact that a certain amount of the actuator assembly 2400 can be located above/proud of the extrapolated surface and/or the surface at the sides of the excavation. FIG. 24B shows some exemplary dimensional data for the excavation 2499A. As seen, there is the extrapolated outer profile 2112 shown in phantom line because that profile is not there having been removed via bone excavation. Distance D91 is the distance between the highest most portion of the extrapolated outer profile 2112 and the lowest portion of the excavation 2499A with respect to the closest distance between those two points. In an embodiment, the distance is taken normal to the tangent of the extrapolated outer profile at its highest point and/or normal to the tangent of the lowermost surface of the excavation. In an embodiment, distance D91 is a mean, median and/or mode of the overall depth from the extrapolated outer profile to the bottom surface. In an embodiment, D91 is less than, greater than and/or equal to 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, or 15 mm or any value or range of values therebetween in 0.01 mm increments. The width of excavation 2499A can be any of those values as well, and need not be the same. The length of the excavation, D72, can be less than, equal to or greater than 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, 15, 15.5, 16, 17, 18, 19, 20, 21, 22, 23, 24, 25, 26, 27, 28, 29, 30, 32, 32, 33, 34 or 35 mm or any value or range of values therebetween in 0.05 millimeter increments.

In some embodiments, utilitarian value can be achieved with respect to utilitarian outcomes when one or both actuator ends are (at least partially) in contact with the top cortical layer of the skull. In some embodiments, this can be utilitarian for generating effective vibrations to the cochlea. It could be that that placing a parallel actuator “too deep” may be less effective (unless if its section would be large enough to still—at least partially—be in contact with the top layer). Accordingly, embodiments include output ends that respectively have at least 25, 30, 35, 40, 45, 50, 55, 60, 65, 70, 75, 80, 85, 90, 95 or 100% or any value or range of values therebetween in 1% increments of the area of the ends that outputs force outputting force to the top cortical layer and/or the top 1, 1.5, 2, 2.5, 3, or 3.5 mm or any value or range of values therebetween in 0.01 mm increments. In some embodiments, this is the ends of the actuator. In some embodiments, this can be calculated with respect to the force spread. That is, of the total output force and/or pressure, the above percentages go directly into the above portions of the bone (force and/or pressure instead of area).

In an embodiment, the excavation is adapted to allow integration of an interface to the bone with maximum stiffness and reliability: e.g., if cement is used, the clearance to the actuator may have to be minimal to limit compression effect of the cement, whereas on the other hand it can be utilitarian to utilize a minimum amount of cement to get sufficient matrix rigidity. When choosing the clearance to be used (and amount of cement), it can be utilitarian to attempt to maximize facilitation of the process where the cement undergoes physiological absorption and bony deposition.

Note that there can be an additional excavation for wiring or leads or the like to the receiver stimulator or to another component. These are not counted in the aforementioned values of the excavation for the actuator and the associated components to hold the actuator in place. All of the above noted values can be the mean, median and/or mode of the dimensions, or can be the maximum or minim values of the excavation.

In view of the above, it can be seen that in an embodiment, the actuator assembly is mounted in a skull excavation that has a length that is longer than a width. In an embodiment, the excavation is not symmetrical about a first axis and not symmetrical about a second axis normal to the first axis. In an embodiment, the excavation is not symmetrical about a third axis normal to the first and second axis. In an embodiment, the excavation is non-symmetrical. In an embodiment, a cross-section of the excavation normal to a surface of the bone (or extrapolated surface of the bone) is non-circular. In an embodiment, the excavation is established by moving a rotating cutting device laterally and longitudinally. In an embodiment of the embodiment of FIG. 24B, the space in between the bone cements 2018 can be filled with silicone, or can be left vacant. Thus, there can be two separate high impedance portions that are separated by bone that is either not in contact with the actuator assembly or in contact with low impedance material of the actuator assembly. In an embodiment, the end surfaces of the excavation (the surfaces bisected by the direction of actuation) are curved differently or have radiuses of curvatures that are different from such of the sides, such as having radiuses of curvature that are at least 30, 35, 40, 45, 50, 55, 60, 65, 70, 75, 80, 90, 100, 125, 150, 175, 200, 250, 300, 350 or 400% or greater than the sides (and could be a huge percentage greater if the sides are generally flat). In an embodiment, the lateral sides of the excavation are generally flat. In an embodiment, the respective sides of the excavation (lateral sides) fall within two planes that are no more than 2, 0.75, 1.5, 1.25, 1, 0.75 or 0.5 mm or any value or range of values therebetween in 0.1 mm increments. In an embodiment, all of the planes just noted associated with the surfaces are less than, equal to or greater than 2, 2.5, 3, 3.5, 4, 4.5, 5, 6, 7, 8, 9, 10, 11, 12, 13, 14 or 15 from each other, when the planes meet any one of those values. In an embodiment, the transition from the lateral sides to the longitudinal sides (ends) will be curved, as a ball drill will likely be used.

While the embodiment of FIG. 24A and FIG. 24B show the utilization of bone cement 2018 to hold the actuator assembly in place and otherwise secure the ends of the actuator to the bone, other embodiments can utilize the other connection and/or fixation arrangements detailed herein, such as a flange that is attached to the bone with a screw, where the screws would extend parallel to the surface of the bone. A 90° wrench or the like can be utilized to turn the screws, and corollary to this is that a 90° bone drill can also be used, this to achieve the directionality parallel to the surface of the skull while working from the interior of the excavation. The screws could be obliquely angled relative to the longitudinal axis of the excavation and/or ultimate placement of the actuator so that a traditional screwdriver or the like can turn the screw, and corollary to this so that a traditional bone drill can be used to drill the hole, by working at highly acute angles relative to the normal direction of the skull surface, which can be enabled owing to the length of the excavation. Flanges at the ends of the actuator can be designed to work with this angled screw, or more accurately, can be designed so that the screw is angled when being screwed into the bone, such as by having an angled through bore for the screw. Other bone penetrating componentry can be utilized. In any event, as noted above, there is utilitarian value with respect to utilizing high impedance bone structure, and in at least some of the embodiments herein, the excavation is made in bone having high impedance, at least at the longitudinal ends of the actuator assembly.

Any configuration of the excavation 2499A that can have utilitarian value and otherwise enable the teachings detailed herein can be utilized in some embodiments, providing that the art enables such. And again, here, the bone contact point(s) can be placed very close to the ear canal (closer to cochlea) than that which exists with the surface mounted bone conduction actuator of FIG. 6 for example.

With respect to FIG. 24C, which shows an actuator assembly located in an excavation 2499 that is located behind the ear canal 102 and on a level of the ear canal 102 (in that the actuator assembly has a component that passes through a horizontal plane that passes through the ear canal), there is a quadrant system presented that is centered about the ear canal 102 of the recipient (where the view of FIG. 24B is looking directly at the side of the human or a coronal view (looking parallel in the coronal plane/the Y axis (where the Y axis extends from the right arm to the left arm, the X axis extends from the back to the front, and the Z axis extends from the feet to the head). As can be seen, the quadrant system is established by a vertical line 99 and a horizontal line 98 centered at the center of the ear canal 106 (or, in an alternate embodiment, line 99 represents the plane in and out of the page that is the coronal plane (the location may be different relative to the ear canal, at least the real ear canal)) and line 98 represents the transverse plane (again the location may be different relative to the ear canal), at whatever that depth is from the surface (the extrapolated surface) of the skull, where the lines 99 and 98 are normal to a longitudinal axis of the ear canal and/or the theoretical ear canal (which is orthogonal to the sagittal plane, as the real ear canal is slightly angled) as extrapolated at the local location of the depth. In an exemplary embodiment, the quadrant system lies on a plane that is normal to the local longitudinal axis of the ear canal (real or theoretical, where the theoretical ear canal is orthogonal to the sagittal plane—any disclosure herein of the longitudinal axis corresponds to a disclosure of the real or theoretical unless otherwise noted, provided that the art enables such) at a location that is less than or equal to or greater than 0 (and thus at—there can be no less than here), 0.25, 0.5, 0.75, 1.0, 1.25, 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5 or 15 mm or any value or range of values therebetween in 0.05 millimeter increments from an extrapolated outer surface of the skull, and the longitudinal axis of the actuator lies on that plane. These lines establish four quadrants about the ear canal: Q1, Q2, Q3, and Q4. (Q1 and Q2 are anterior, and Q3 and Q4 are posterior, and Q1 and Q4 are superior and Q2 and Q3 are inferior.) As will be understood, these quadrants generally follow the 12 hour clock, with quadrant 1 falling between the 12 o'clock position and the 3 o'clock position, quadrant 2 falling between the 3 o'clock position and the 6 o'clock position, quadrant 3 falling between the 6 o'clock position and the 9 o'clock position, and quadrant 4 falling between the 9 o'clock position and the 12 o'clock position. Embodiments can place the actuator assembly completely or partially in any one of these quadrants, although there is utilitarian value with respect to placing the actuator assembly so that it straddles quadrant 4 and quadrant 3 (posterior). That said, embodiments can also include placing the actuator assembly in the jaw of the recipient, which would be quadrant 2.

Briefly, FIG. 24K shows a view looking at the coronal plane from the front of the human (and thus the actuator is positioned closest to the right ear). Line 909 is a line that runs through the sagittal plane (the plane runs in and out of the page). D255 is a distance measured from the centerline of the actuator assembly at the “lowest” portion of the actuator assembly. But D255 could be the middle point of the distance of the actuator along the longitudinal axis (centerline) of the actuator assembly, or could be the topmost portion. Also, D255 could be the distance closest to the sagittal plane. D255 can be 2, 2.25, 2.5, 2.75, 3, 3.25, 3.5, 3.75, 4, 4.25, 4.5, 4.75, 5, 5.25, 5.5, 5.75 or 6 inches depending on the size of the human head at issue or any value or range of values therebetween in 0.01 inch increments from the sagittal plane. FIG. 24L shows the angle of the actuator assembly (the longitudinal axis thereof) relative to the sagittal plane 909 with respect to superposition onto the coronal plane—the actuator could be in front of the coronal plane or in back of that plane.

In the embodiment of FIG. 24C, the actuator 2400 has a longitudinal axis 9191 (which can be a direction of actuation of the actuator) that is parallel with line 99 and normal to line 98. The longitudinal axis 9191 constitutes the centerline of the actuator 2400 and can be located a distance D25 from line 99 as shown. (Distance D25 can be the distance from line 99 to the lowest portion of the actuator assembly as measured on the longitudinal axis, or can be the middle portion or the top most portion. Distance D24 can be also measured from the lowest portion. In an exemplary embodiment, D25 can be less than, equal to or greater than plus or minus (where plus is as shown in FIG. 24B, minus being on the other side of line 99) 0, 0.25, 0.5, 0.75, 1.0, 1.25, 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, 15, 15.5, 16, 17, 18, 19, 20, 21, 22, 23, 24, 25, 26, 27, 28, 29, 30, 32, 32 or 33 mm or any value or range of values therebetween in 0.05 millimeter increments, but note that most embodiments will favor locating the actuator as close to the cochlea as possible, or closer rather than further from the cochlea. And to be clear, at least for some of the lower values, this would represent the actuator assembly 2400 being located akin to the manner shown in FIG. 24A, where the actuator is located completely above the top of the ear canal. And in this regard, the end closest to the cochlea of the actuator (or one end) is located a distance D24 from line 98, where D24 can be can be less than, equal to or greater than plus or minus (where plus is as shown in FIG. 24B, minus being on the other side of line 98) 0, 0.25, 0.5, 0.75, 1.0, 1.25, 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, 15, 15.5, 16, 17, 18, 19, 20, 21, 22, 23, 24, 25, 26, 27, 28, 29, 30, 32, 32 or 33 mm or any value or range of values therebetween in 0.05 millimeter increments. D26 is the length from the end closest to the cochlea of the actuator assembly (or from any end) to the location where the opposite side of the actuator assembly contacts bone (or bone cement, or alternative interface). In almost all embodiments, both ends have equal output. In reality, as a technical matter, both ends are output ends. In an embodiment, the actuator assembly is positioned evenly in the excavation. In an embodiment, the distance from one end of the actuator assembly to the opposite facing bone equals the distance from the opposite end of the actuator assembly to the respective opposite facing bone (which is opposite the previously noted opposite facing bone). In an embodiment, a distance on one side is between 65-135, 70-130, 75-125, 80-120, 85-115, 90-110, 95-105%

D26 is the overall length of the actuator assembly with respect to the portions that contact bone (or contact bone cement—this may not be the overall length of the actuator assembly, such as where a portion extends beyond an attachment point with bone but does not contact bone, such as that seen in FIG. 24C). Distance D27 is the distance from one end (here, the inferior output end, which can be an inferior point) of the actuator assembly to a middle of the actuator assembly (middle with respect to the contact points, not the overall length necessarily). D28 is a distance from line 98 to the middle of the actuator assembly. D27 can be less than, greater than and/or equal to 0 (which means it cannot be less than), 5, 10, 15, 20, 25, 30, 35, 40, 45, 50, 55, 60, 65, 70, 75, 80, 85, 90, 95, 100, 110, 120, 130, 140, 150, 175, 200, 225, 250, 275, 300, 350 or 400% or more or any value or range of values therebetween in 1% increments of any value of D24 noted above.

Jumping ahead a bit, FIG. 24H shows actuator positioning lower in the X direction than that depicted above vis-à-vis FIG. 24C. Here, FIG. 24H shows the “top” of the actuator assembly at the level of axis 98. FIG. 24I shows the “top” of the actuator assembly at the level of the top of the ear canal 102. In an embodiment, the “top” of the actuator assembly is located a distance D33 from axis 98. In an embodiment, D33 can be any of the values D24 noted above.

Instead, measurements can be made from the top most portion of the excavation. FIG. 24J shows this, where distance D34 is the distance from axis 98, where D34 can be any of the values of D33 and/or any of those values plus 0.1, 0.2, 0.3, 0.4, 0.5, 0.6, 0.7, 0.8, 0.9, 1.0, 1.25, 1.5, 1.75, 2, 2.25, 2.5, 2.75, 3, 3.25, 3.5, 3.75, 4, 4.25, 4.5, 4.75, 5, 5.25, 5.5, 5.75 or 6 mm or any value or range of values therebetween in 0.01 mm increments.

As can be seen, in some embodiments, the top of the actuator assembly or the top of the excavation is parallel to a top of the ear canal. There are embodiments that have utilitarian value to having cortical or otherwise high impedance bone tissue all around the actuator or at least at the ends thereof. In an embodiment, no preload is applied because of the high impedance bone tissue being so present.

FIG. 24D shows another embodiment where the actuator is parallel and concentric with line 98. Here, the force of the actuator, or at least the direction of extension of the actuator (the force could be offset from the direction of extension) is outputted in a vector that intersects an interior of the ear canal 102 (note that ear canal as used herein with respect to measurements and spatial location refers to the inner surface of the bone that creates the ear canal, as opposed to the surface of the skin that overlies the bone). This as opposed to the embodiment of FIG. 24C shown above. In this regard, this can be considered the embodiment of FIG. 24A rotated 90° or, more accurately, orbited about the centerline of the ear canal 102 where the actuator assembly is tidally locked, where the rotational and orbital periods are locked with the ear canal or otherwise has synchronous rotation with the ear canal.

FIG. 24E shows that the longitudinal axis 9191 of the actuator assembly need not be aligned with the ear canal. Here, the longitudinal axis 9191 is parallel with line 98, and offset by distance D25. The forwardmost portion of the actuator (from where output is provided) is a distance D24 from line 99. The values can be those detailed above. And the other values/dimensions noted above with respect to FIG. 24C can be applicable here, albeit rotated 90 degrees, and are not reproduced here for the purposes of textual economy. D24 of FIG. 24E can be measured from the forward most portion or the rearmost portion or from the center of the actuator assembly, as located on the longitudinal axis.

And with respect to orbiting the actuator, FIG. 24F shows an example of the actuator assembly having a longitudinal axis 9191 obliquely angled relative to the lines 99 and 98. Here, for simplicity, the coordinate system utilizing lines 98 and 99 is rotated by the angle A5, where A5 is less than, greater than and/or equal to 0 (which is no rotation), 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175 or 180 plus or minus (plus is shown in the FIG. 24F) or any value or range of values therebetween in 1 degree increments), resulting in lines 98′ and 99′ offset from lines 98 and 99 by that angle (line 99′ is offset by angle A7 from line 99, where 99′ is normal to 98′, and all are centered on the centerline of the ear canal 102 at the local location). Here, the actuator, or more accurately, the longitudinal axis 9191, is parallel with the line 98′, and the longitudinal axis 9191 for the actuator is offset by a value of D25 from the line 98′, and the distance D24 from line 99′ can be any of the values noted above, and the value D25 can be any of those above. As with the embodiment of FIG. 24E, the other dimensions detailed above can be transposed to this embodiment. The orbiting here is about the real or theoretical axis of the ear canal. If lines 98 and 99 represent the transverse and sagittal, the angles and measurements can be made accordingly.

Thus, in view of the above, embodiments can include an actuator assembly that has a piezoelectric stack that is stacked parallel to a surface of the skull (the local surface) as opposed to the orthogonal configurations detailed in prior embodiments. The piezoelectric stack can be partially or fully recessed into bone.

Embodiments can include an in-line arrangement instead of an eccentric arrangement as shown in FIG. 24. The two interface portions of the actuator can be potted in bone cement and/or glue. Bone regrowth may integrate with the cement. This can result in a sufficiently solid connection to the body, and in some instances, a very solid connection to the body. The stiffness of this arrangement is utilitarian for the two-point fixation stack so as to provide utilitarian performance as noted above. Indeed, a stiffness (of the cement/adhesive for example, brother fixation component) equal to or higher than the stiffness of the bone itself is utilized in this embodiment as well. Conversely, at least one portion in between the two contact points of the actuator assembly that are not secured to bone, can be coated with silicone to allow for axial expansion, again in accordance with some of the embodiments described herein. Conversely, the interface components can be coated with a material that facilitates osseointegration, such as with titanium oxide by way of example. That is, the securement components have stiffnesses equal to or higher than the bone, and any other components that connect the actuator with the bone have stiffnesses that are lower than the bone (e.g., at least 30, 35, 40, 45, 50, 55, 60, 65, 70, 75, 80, 85, 90, 91, 92, 93, 94, 95, 96, 97, 98 or 99% less than the bone and/or the other connectors at the output).

As seen above, orientations of the parallel stack can be vertical, horizontal, or angled relative to the ear canal. Utilitarian value with respect to the embodiment of FIG. 24A can be, by way of example only and not by way of limitation, a relatively simple surgical procedure, where drilling/excavation occurs in the skull surface only, and there is no deep recess to reach the lateral canal area in this embodiment. In an embodiment, the above-noted depths of the excavation are the deepest drilling/excavation that occurs. Implementation can be consistent across patients, as there may be low variability from patient to patient and this will depend on the area where the actuator is finally positioned. This can have utilitarian value with respect to encouraging surgeons to adopt the practice according to the teachings or otherwise implement the teachings with less likelihood of deleterious results.

Embodiments can include the teachings associated with the embodiment of FIGS. 24A, etc., in a pediatric situation. Embodiments include applying the teachings detailed herein to a human that is less than 18, 17, 16, 15, 14, 13, 12, 11, 10, 9, 8, 7, 6, 5, 4, 3, 2 or 1 years old or any value or range of values therebetween in 0.1 year increments.

Embodiments include implementing the teachings herein with no separately mounted bone anchored implants/parts to connect the stack to the bone, while in other embodiments there are such separately mounted bone anchored implants.

Embodiments thus include an apparatus, comprising an actuator, a first tissue interface device and a second tissue interface device spaced away from the first tissue interface device, wherein the apparatus is at least a partially (and in some embodiments a totally) extra-middle ear cavity dual bone interface force based implantable tissue stimulation portion of a hearing prosthesis. In some embodiments, the apparatus is configured to be mounted on a surface of a skull bone between the bone and skin of a person of which the skull bone is a part, as is the embodiment of FIG. 24. In an embodiment, all parts of the actuator and/or the actuator assembly of which the actuator is apart are located within a distance less than and/or equal to 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, or 15 mm or any value or range of values therebetween in 0.01 mm increments of an outer surface and/or an extrapolated outer surface of a skull of a human.

In some embodiments, the apparatus is configured to be transversely mounted relative to an ear canal of a recipient of the apparatus.

In an embodiment, there is an apparatus, comprising a piezoelectric actuator, a first tissue fixation device and a second tissue interface device spaced away from the first tissue fixation device, wherein actuation of the actuator moves the first tissue fixation device relative to the second tissue interface device, the first tissue fixation device is attached to a first portion of skull bone of a recipient of the actuator, the second tissue interface device abuts a second portion of skull bone that is fixed relative to the first portion of skull bone, and at least one of: (i) the first portion of the skull bone and the second portion of the skull bone is a same part of the skull; (ii) the first tissue fixation device is above a natural outer surface of the skull or within 10 mm of the natural outer surface of the skull; (iii) all of the apparatus is located at least 5 mm away from a cochlea of the recipient; or (iv) the bone to which the first tissue fixation device is attached and/or the bone to which the second tissue fixation device abuts has a thickness of at least 2, 3, 4, 5, or 6 mm or any value or range of values therebetween in 0.1 mm increments directly beneath (underneath, as opposed to the thickness in the direction of the ends) the respective devices. That said, in some embodiments, there is at least 3, 4, 5, 6, 7, 8, 9, 10, 11, 12, 13, 14, 15 mm or any value or range of values therebetween in 0.1 mm increments in the direction of actuation at one or both ends. In an exemplary embodiment of this apparatus, the apparatus is mounted so that relative to a plane extending parallel to and lying on a general axis of an ear canal of the recipient (e.g., a plane extending into and out of the page through line 98 of FIG. 24C, for example, or line 99 for example), the first tissue interface is on one side of the plane and the second tissue interface is on another side of the plane. In an exemplary embodiment, the apparatus is attached to the skull so that a direction of actuation of the actuator is generally normal to a general longitudinal axis of an ear canal of the recipient (e.g., FIGS. 24A-24F). That is, considering the ear canal as a pipe, the actuator “points” to the side of the pipe. In an exemplary embodiment, the direction of actuation is parallel to and concentric with a longitudinal axis of the actuator (and visa-versa for the embodiments herein). In an exemplary embodiment, the direction of actuation is within ±10, 9, 8, 7, 6, 5, 4, 3, 2 or 1 degrees or any value or range of values therebetween in 0.1° increments from a line that is 90, 85, 80, 75 or 70 degrees from the general longitudinal axis of the ear canal and bisecting that general longitudinal axis and/or offset by less than, greater than and/or equal to 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, or 15 mm or any value or range of values therebetween in 0.01 mm increments from that line.

In an embodiment, the longitudinal axis of the ear canal is the local longitudinal axis as measured at a location that corresponds to where a plane bisects that axis, which plane is established by the longitudinal axis and/or the direction of actuation of the actuator when implanted.

In an exemplary embodiment, the apparatus is implanted so that a direction of actuation of the actuator is pointed into an ear canal of the recipient. That is, the vector of actuation extends through the ear canal. That said, in another embodiment, a direction of actuation the actuator is not pointed into an ear canal of the recipient. In an embodiment, direction of actuation of the actuator is pointed in a direction that is less than, greater than and/or equal to 1.5, 1.75, 2, 2.25, 2.5, 2.75, 3, 3.25, 3.5, 3.75. 4, 4.25, 4.5, 4.75, 5, 5.25, 5.5, 5.75, 6, 6.25, 6.5, 6.75. 7, 7.25, 7.5, 7.75, 8, 8.25, 8.5, 8.75, 9, 9.25, 9.5, 9.75, 10, 10.25, 10.5, 10.75, 11, 11.5, 12, 12.5, 13, 13.5, 14, 14.5, or 15 mm or any value or range of values therebetween in 0.01 mm increments from the ear canal (and, for example, less than 15 mm can include passing through the ear canal, while in other embodiments, those distances exist without passing through the ear canal).

In an exemplary embodiment, an axis extending from a center of the first tissue fixation device and a center of the second tissue interface device extends in a direction transverse to an ear canal of a recipient of the apparatus. In an exemplary embodiment, that axis can have the angle values just noted with respect to the direction of actuation vis-à-vis being within 10° or less from a line that is normal or within 70° from the general longitudinal axis of the ear canal.

In an embodiment, there is an apparatus, comprising an actuator; a first tissue interface device; and a second tissue interface device spaced away from the first tissue fixation device, wherein the apparatus is an implantable portion of an active transcutaneous bone conduction device configured to operate over an output range up to at least 10 kHz, when the apparatus is in free space, the first tissue interface device moves relative to the second tissue interface device when the actuator is actuated, the second tissue interface device is a bone penetrating component, the second tissue interface device being a front end interface device relative to the actuator, and output of the actuator is between the first tissue interface device and the second tissue interface device. In this embodiment, apparatus is implanted in a recipient so that a vector of actuation of the actuator extends through an ear canal of the recipient or extends according to any of the regimes detailed herein. In an embodiment, the first tissue interface device is a second bone penetrating component, and the bone penetrating component and the second bone penetrating component extend generally normal (including normal) to a direction of actuation of the actuator (which can be the longitudinal axis of the actuator). In an embodiment, the first tissue interface device is a second bone penetrating component, and the bone penetrating component and the second bone penetrating component extend within 20, 15, 10, 9, 8, 7, 6, 5, 4, 3, 2 or 1 degrees or any value or range of values therebetween in 0.1 degree increments from normal of a direction of actuation of the actuator.

With regard to methods, in an embodiment, there is a method, comprising capturing ambient sound with a sound capture device and actuating an actuator assembly implanted in a human based on output of the sound capture device that is based on the captured ambient sound, wherein the actuation of the implanted actuator evokes a hearing percept in the human by applying force to two separate high impedance portions of the human's skull without using a seismic mass and without an airgap between the two portions. An example of the two separate high impedance portions are the respective portions at the bone cement 2018 and at the spring 2212B of FIG. 22B (the bone at the bone cement 2018 is a single high impedance portion, even though the bone surrounds three sides of the bone cement (with respect to the cross-sectional view of the drawing—it would surround the bottom and the side, but not the side opposite the bottom). This as distinguished from, for example, a single high impedance portion that extends all the way around an actuator interface where the actuator interface surrounds the actuator (such as seen in FIG. 24G, where the bone cement fills the cavity 2198 as shown). Put another way, in an exemplary embodiment, the actuator assembly interfaces have gaps in between them, or more accurately, there are gaps between one portion of a high impedance portion of the bone and another portion of the high impedance portion of the bone vis-à-vis attachments of the actuator thereto. In this regard, there is only one high impedance portion of the human skull to which forces applied in the arrangement of FIG. 24G, whereas there are two high impedance portions of the human skull to which forces are applied in the embodiment of FIG. 21.

In an embodiment, a direction of actuation of the actuator assembly is at least generally parallel to a surface of the skull (a local surface or an extrapolated surface). In an embodiment, the direction of actuation of the actuator is within 20, 19, 18, 17, 16, 15, 14, 13, 12, 11, 10, 9, 8, 7, 6, 5, 4, 3, 2 or 1 degrees or any value or range of values therebetween in 1 degree increments of a surface of the skull (local or extrapolated).

In an embodiment, a direction of actuation of the actuator assembly is at least generally parallel to a surface of the skull, and a vector of the direction of actuation extends through an ear canal of the human (while in other embodiments, the vector does not so extend). In other embodiments, the direction of actuation can be any of those described herein, and the vector direction can be any of those described herein.

In an embodiment, the actuator assembly is mounted in a posterior vertical orientation, and in an embodiment, the actuator assembly is mounted in a posterior horizontal orientation. In an embodiment, a direction of actuation of the actuator is vertical, horizontal or oblique relative to a direction of gravity when the human is upright. In an embodiment, the direction of actuation can be any of those detailed herein. The actuator assembly can be located in the skull so that bone is positioned at a first end of the actuator assembly and a second end of the actuator assembly, as noted above. And in an embodiment, the actuator assembly is bone foundationally mounted at two ends. (This as opposed to, for example, the embodiment of FIG. 22C, where there is only a bone foundation at one end, the idea being that foundations are directly in line with forces, as opposed to on the sides.)

In an alternate embodiment, there is a method, comprising capturing ambient sound with a sound capture device and actuating an actuator assembly implanted in a human based on output of the sound capture device that is based on the captured ambient sound, wherein the actuation of the implanted actuator evokes a hearing percept in the human by applying force to two separate portions of the human's skull in a direction at least generally parallel to a surface of the skull. In an embodiment, the direction can be within 25, 20, 19, 18, 17, 16, 15, 14, 13, 12, 11, 10, 9, 8, 7, 6, 5, 4, 3, 2 or 1 degrees or any value or range of values therebetween in 1 degree increments of a surface of the skull (local or extrapolated).

Embodiments can include an apparatus, comprising a piezoelectric actuator, a first tissue interface device; and a second tissue interface device spaced away from the first tissue fixation device, wherein actuation of the actuator moves the first tissue interface device relative to the second tissue interface device, the first tissue interface device interfaces with a first portion of skull bone of a recipient of the actuator, the second tissue interface device abuts a second portion of skull bone that is fixed relative to the first portion of skull bone, and at least one of: (i) the entirety of the actuator is within 15, 14, 13, 12, 11, 10, 9, 8, 7, 6, 5, 4 or 3 mm or any value or range of values therebetween in 0.25 mm increments of an upper surface of the skull bone; (ii) the movement of the first tissue interface device relative to the second tissue interface device is at least generally parallel to the upper surface of the skull bone (or within any of the values herein in other embodiments); or (iii) the first tissue interface device and the second tissue interface device are respective bone penetrating components that extend generally normal to a direction of actuation of the actuator (or within 25, 20, 19, 18, 17, 16, 15, 14, 13, 12, 11, 10, 9, 8, 7, 6, 5, 4, 3, 2 or 1 degrees or any value or range of values therebetween in 1 degree increments of the direction). With regard to the latter, the longitudinal direction of screw 1618 of FIG. 17 is parallel to and concentric with the direction of extension of the actuator 1610, and thus within any of those values. If the longitudinal axis was offset by 10 degrees from the embodiment depicted, the first tissue interface would extend within 10 degrees of the direction of actuation. With respect to the utilization of two tissue interface devices, the arrangement of FIG. 24B, etc., can enable the utilization of such tissue interfaces, because screws for example can be inserted in directions parallel to the surface of the skin at either end of the excavation as noted above.

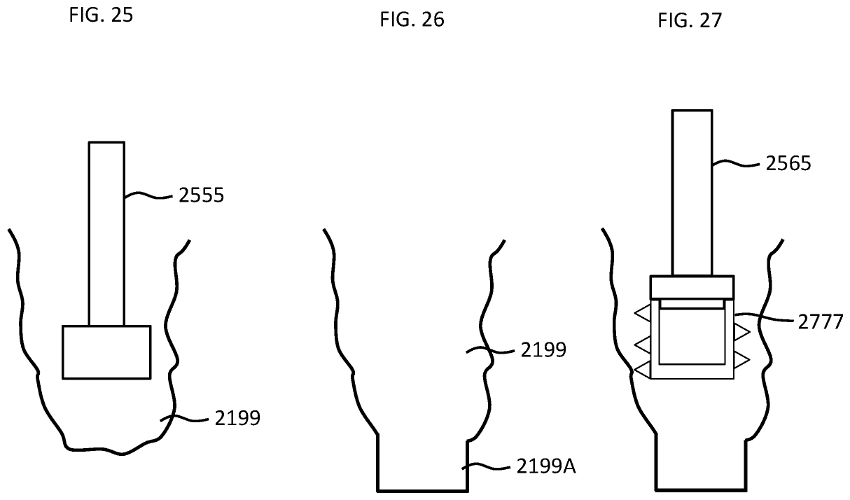

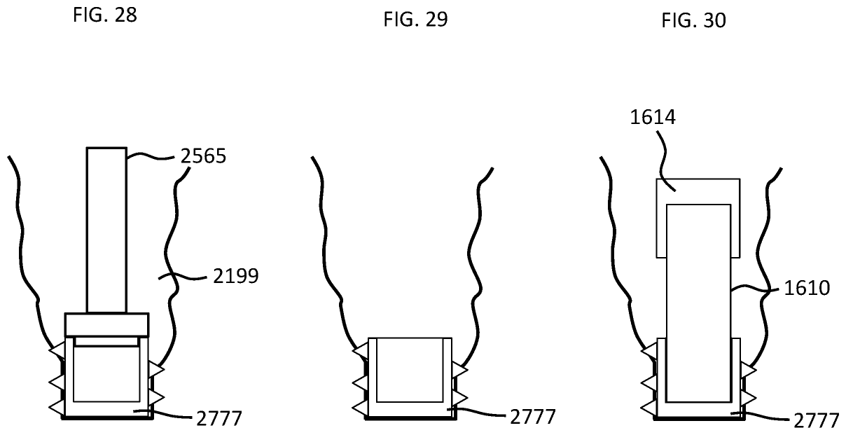

FIGS. 25-30 provide images of an exemplary method of implanting a first end (end closest to the cochlea) fixture 2777 (which functions as a fixture, but because it is configured to adhere to the bone by itself, it is a fixture) as well as images of the fixture 2777 and the actuator attachment thereto. More specifically, FIG. 25 shows the cavity/excavation 2199 (having been previously drilled using a ball drill for example) prior to the drilling of an additional cavity for the end closest to the cochlea fixture. Also shown is an exemplary drill bit 2555 being lowered into the cavity 2199. The drill bit 2555 is utilized to drill fixture cavity 2199A at the bottom of the excavation 2199 is shown in FIG. 26. Then, fixture 2777 is lowered into the cavity by a fixture holder 2565 as shown in FIG. 27. Here, fixture 2777 has self-tapping drill threads. The fixture holder 2565 is configured to apply a torque to fixture 2777 and otherwise turn fixture 2777 relative to the cavity 2199. This as a fact of screwing fixture 2777 into fixture cavity 2199A as shown in FIG. 28. Fixture holder 2565 is subsequently detached from fixture 2777 and removed from the cavity 2199, as shown in FIG. 29. Then, piezoelectric actuator 1610 is fitted into the hollow portion of the fixture 2777 as shown in FIG. 30. The piezoelectric actuator 1610 can have fixture 1614 attached thereto prior to the attachment of the actuator 1610 to fixture 2777. The second end fixture can then be attached to fixture 1614, or more accurately, to the adjustment screw thereof concomitant with the teachings above so as to provide the two point fixation for the actuator 1610.

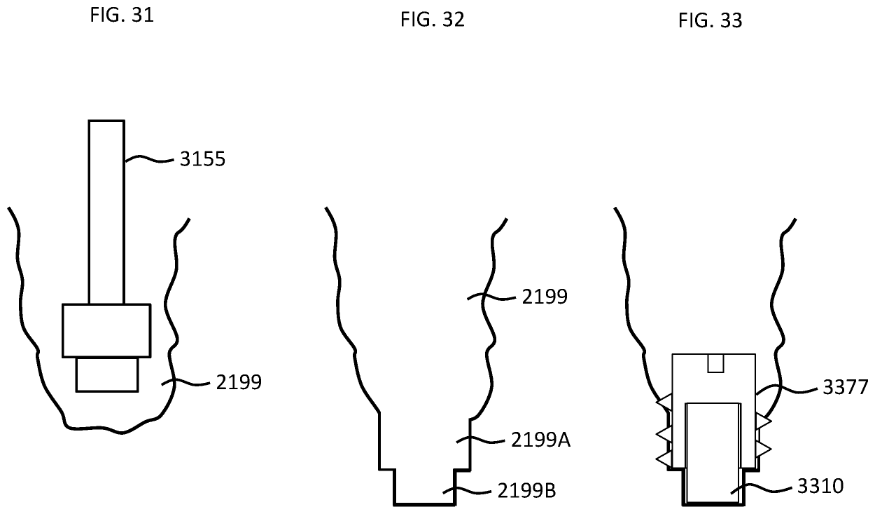

FIGS. 31 to 33 provide an alternate exemplary embodiment of an exemplary method of implanting a compact device according to an exemplary embodiment, as well as images of that device. More specifically, FIG. 31 shows the cavity/excavation 2199 (having been previously drilled using a ball drill for example) prior to the drilling of an additional cavity for the device with a compound drill bit 3155 being lowered into the cavity 2199. FIG. 32 shows the resulting cavities drilled with the drill bit 3155, showing a first hollow subportion 2199A and a second hollow subportion 2199B. FIG. 33 shows the fixture 3377 screwed into the first hollow subportion 2199A and a piezoelectric actuator 3310 located in the hollow portion of the fixture 3377. The fixture 3377 has self-tapping screw threads and includes a screw driver socket to enable the fixture 3377 to be screwed into the hollow subportion 2199A, and also “trapping” piezoelectric actuator 3310 between the fixture 3377 and the bottom of the hollow subportion 2199B. In an exemplary embodiment, when the piezoelectric actuator 3310 is actuated, the force will be imparted in the vertical direction on to the bottom of the hollow subportion 2199B in a manner concomitant with the teachings above. In the embodiment of FIG. 33, the piezoelectric stack is pretty indicated into the bone implant (the fixture 3377).

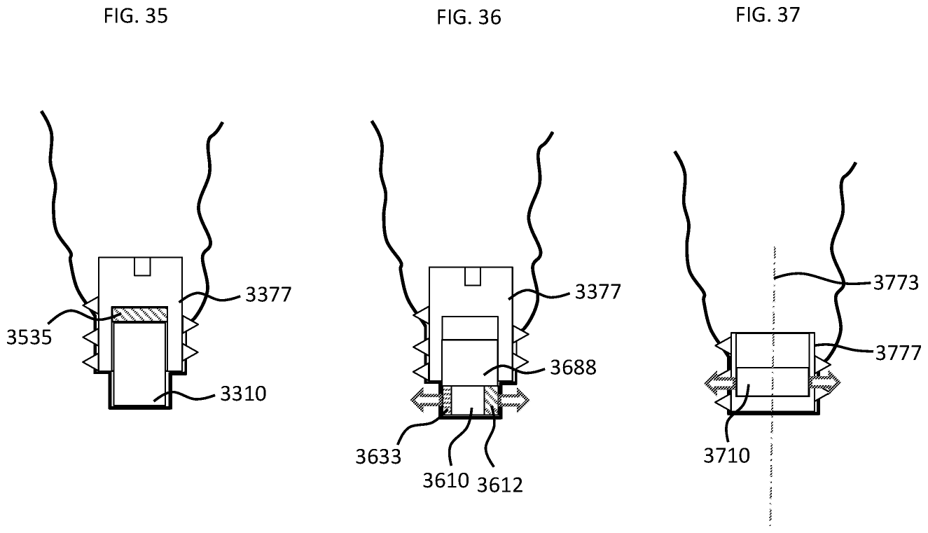

It is noted that zero internal clearance can also be used. There are a number of ways to achieve zero clearance. For example, cavities 2199A and B are designed in way that when fixture 3377 is screwed against the countersink, a preload is generated to the stack (zero clearance principle for stroke transfer). This can also be obtained by adding/injecting a hardening (shape adapting) matrix (cement or glue for example) inside and/or below cavity 3310. This can increase the density of the bone and adapt to the shape of actuator 3310 (injection is before inserting 3310 and 3377). In a variant of FIG. 33, there can be a spring as that used between element 3310 and element 3377 (shown in FIG. 35 for example). Also, osseointegration can be used, where the bone grows back up to the surface of actuator 3310. In some embodiments, to achieve zero clearance at the back end, with reference to FIG. 33, the skull growth (or the need for adaptable system) is less of an issue as the back-end and front-end locations to the bone are closer to each other than detailed above.

FIG. 33 does not show a spring, but in an embodiment, there can be a spring component between element 3310 and 3377. The spring could be a leaf spring or a bevel spring located at the top of actuator 3310 (the actuator could be sized less tall to accommodate the spring, or the fixture 3377 would simply be a bit higher than that shown).

In some embodiments, the piezoelectric material is biocompatible and can be applied directly against the bone. In some embodiments, there is a biocompatible coating over the piezoelectric material, and this coating is in direct contact with the bone. Still, in some other embodiments, the piezoelectric stack is located in a housing that has sufficient flexibility and/or expandability so that the force generated by the expansion of the piezoelectric stack can be transmitted to the bone.

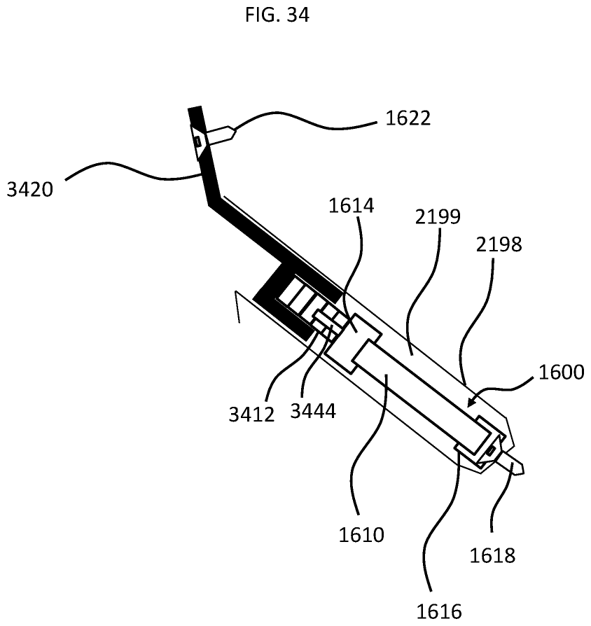

While the embodiments above have focused on the utilization of an adjustment screw or a set screw to preload the actuator, other embodiments can utilize a spring apparatus to provide the preloading. In this regard, FIG. 34 shows an exemplary actuator apparatus that utilizes a spring 3412 to provide the preloading. Here, bracket 3420 varies from fixture 1620 detailed above, in that the portion of the fixture that fits into the excavation 2199 has a female portion that “cups” a portion of the spring 3412 and holds the spring 3412 in the lateral direction with respect to the bracket 3420. Also as can be seen, a guide cylinder 3444 is connected to fixture 1614. The guide cylinder 3444 fits inside the hollow portion of the spring 3412 and holds the spring in the lateral direction with respect to the fixture 1614. In an exemplary embodiment, instead of having a surgeon or otherwise a healthcare professional adjust the set screw to provide the preload on the actuator, the action of attaching the bracket 3420 to the bone so that the end portion of the bracket is inside the passageway 2199 provides a compression force onto the spring 3412, which compression force then loads the actuator number 1610. Thus, it is the action of the surgeon using his or her hands or otherwise a tool to push the bracket 3420 on to the spring 3412 (or pushing the bracket and spring on to the guide cylinder 3444) that provides the preloading. That said, in an embodiment, a combination of an adjustable component, such as a set screw, and a spring can be utilized to provide the preloading and/or any of the other preloading techniques described herein.

In an exemplary embodiment, the k value of the spring and/or the amount of compression of the spring that exists when the bracket 3420 is fully in place results in a force on the fixture 1614, and thus the actuator 1610 that is sufficient to provide an amount of preloading that is utilitarian and otherwise sufficient to maintain this preloading during actuation of the actuator 1610, or, more accurately, is sufficient so that when the actuator is actuated, a sufficient amount of energy is imparted into the bone as opposed to being absorbed by the spring. In an exemplary embodiment, the preloading force is greater than or at least equal to that which would exist with the adjustable screw.

In an exemplary embodiment the preloading is 0.5, 1, 1.5, 2, 2.5, 3, 3.5, 4, 4.5, 5, 5.5, 6, 6.5, 7, 7.5, 8, 9, 10, 11, 12, 13, 14, 15, 16, 17, 18, 19, 20, 21, 22, 23, 24, 25, 26, 27, 28, 29 or 30 Newtons or any value or range of values therebetween in 0.1 N increments.

Note further that the spring need not necessarily always have a constant k value, at least after implantation. By way of example only and not by way of limitation, the spring can be utilized as an implantation aid and, after the actuator is positioned, the spring can be “frozen” in place or otherwise the spring can be stiffened beyond that which was the case during implantation. Thus, the spring will be sufficiently compliant at a first level to allow the surgeon or otherwise healthcare professional (and note that robotic insertions are also contemplated—executing one or more of the functions herein corresponds to an alternate disclosure of a robot performing such action, either automatically or under the control of a human or combination thereof) to position the bracket and the actuator, and then, the compliances significantly reduced or otherwise change to a second compliance level, higher than the first level, which effectively changes the assembly to a rigid assembly more along the lines of the adjustment screw embodiments. In an exemplary embodiment, an epoxy or the like (a biocompatible matrix/epoxy derivative for example) can be injected into the cavity where the spring is located to prevent the spring from moving in the longitudinal direction or otherwise require a much greater force to permit the spring to move in the longitudinal direction. That said, in an embodiment, where there is the injection of a matrix in the cavity/capsule, instead of the spring, a temporary screw could also apply the preload, then cement/or stiff material is added (after that the temporary screw may be removed). It may be material that expands when it cures, thus adding more preload. (Note that preload is a feature that is used in at least some embodiments, in a sense that it may disappear over time—this is one of the reasons that there can be utilitarian value in non-preloaded concepts where the stack is parallel to the skull surface, completely or partially in the hard cortical layer.) Also, element 3310 may also be sitting on an intermediate part such as element 3688 in FIG. 36 which is screwed downwards after element 3377 is fixed in the bone. After that the to be cured (and potentially expanding) matrix can be added in the cavity/capsule.

FIG. 35 presents an alternate exemplary embodiment that utilizes a spring 3535 to preload the actuator 3310. Here, a spring 3535 is located in between the fixture 3377 and the actuator 3310.

Embodiments above have focused on the utilization of a longitudinally extending and contracting actuator, or, more accurately, an actuator that applies a force generally in the longitudinal direction of the actuator and/or the longitudinal direction of the cavity created in the bone (the parallel actuator mounted on the surface of the bone being exception). An alternative embodiment applies a shear force or otherwise a lateral force to the bone. FIG. 36 presents an exemplary embodiment where the piezoelectric element(s) 3610 generates a sideways force. A bone interface 3633 can be located on one or more ends of the piezoelectric element 3610 to accommodate the curved interior of the sub cavity 2199B. Shown there is also a spring 3612 which preloads the piezoelectric stack 3610. The outer surface of the spring 3612 can also accommodate the curved surface of the sub cavity 2199B. As shown, a piezoelectric stack holder 3688 is located in the cavity of the fixture 3377, this holder 3688 can be a piece of titanium a biocompatible material such as PEEK, etc., and can be screwed into the cavity of the fixture 3377. The piezoelectric element 3610 can be as easily bonded to the holder 3688 or the housing in which the piezoelectric element is located can be bonded to the holder 3688. In an exemplary embodiment, the bond can be temporary so that once the piezoelectric element is located in the sub cavity 2199B, and the piezoelectric element(s) is actuated, the bond breaks thus permitting the actuator to move in the lateral direction, and the clamping force that results from fixture 3377 in combination with the holder 3688 is utilized to hold the actuator in place in the longitudinal direction (at least via the application of pressure to the stack—note that a plate can be placed between the stack and the bottom of the cavity so that the pressure is reacted against with another support material instead of raw bone).

A compliant component located between the bone and the actuator housing applying a preload can be implemented to facilitate osseointegration of the actuator front end and/or back end interface to the bone, and/or can be used to adapt to retracting bone or skull growth. In some embodiments, this may also prevent the application of too much mounting pressure, which could potentially damage tissue or damage sensitive and/or thinner bone structure, such as in the vicinity of semicircular canals—embodiments contemplate a front end tissue interface within 10, 9, 8, 7, 6, 5, 4, 3, 2, or 1 mm of the semicircular canals.

The compliant component can be a dilatant material (or equivalent principle/mechanism) which typically deforms when forces are applied at very low frequencies (i.e., changing its own shape when the surrounding bone structures adjust/adapt over time, or in the process of mounting the back- and or front-end of the transducer), but which behaves as a stiff component (equal or higher stiffness than the bone stiffness, in range of 5-10 GPa for example) when forces are applied above certain frequency rates (applicable for hearing stimulation frequencies). In an embodiment, this can also be applicable to element 3535.

If a mechanical spring (or equivalent) component is used, a high spring stiffness in the range of the piezo stack spring stiffness (blocking force/maximum displacement) can be used in some embodiments. Lower spring stiffnesses can be applied in some embodiments, however. In an exemplary embodiment, the spring stiffness (or the compliant material stiffness) is at least and/or equal to 50, 55, 60, 65, 70, 75, 80, 85, 90, 95, 100, 105, 110, 115, 120, 130, 140, 150, 160, 170, 180, 190, 200, 250, or 300%, or any value or range of values therebetween in 1% increments of the stiffness of the piezoelectric stack.

It is noted that piezoelectric stacks are used herein in at least some of the embodiments. This as opposed to a single piezoelectric element. Thus, embodiments include a plurality of piezoelectric elements “stacked” or located adjacent to one another. The two or more elements expand and/or contract to achieve a “force multiplier” effect. The embodiments above have extension/force outputs that are limited to separate areas that are not contiguous. This as opposed to, for example, a contiguous “hoop” force extending outward in a 360 degree direction.

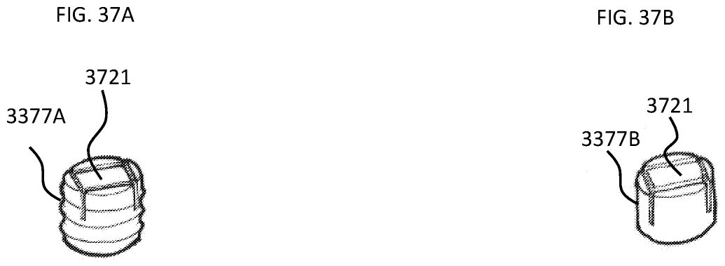

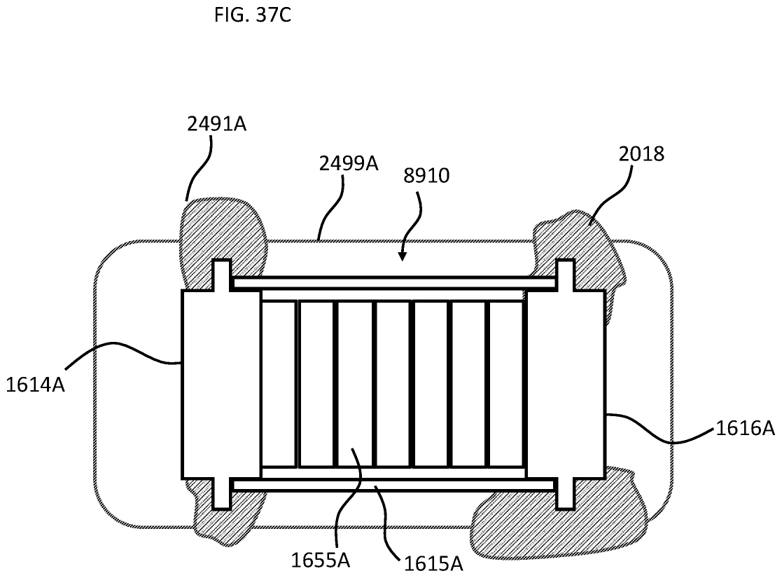

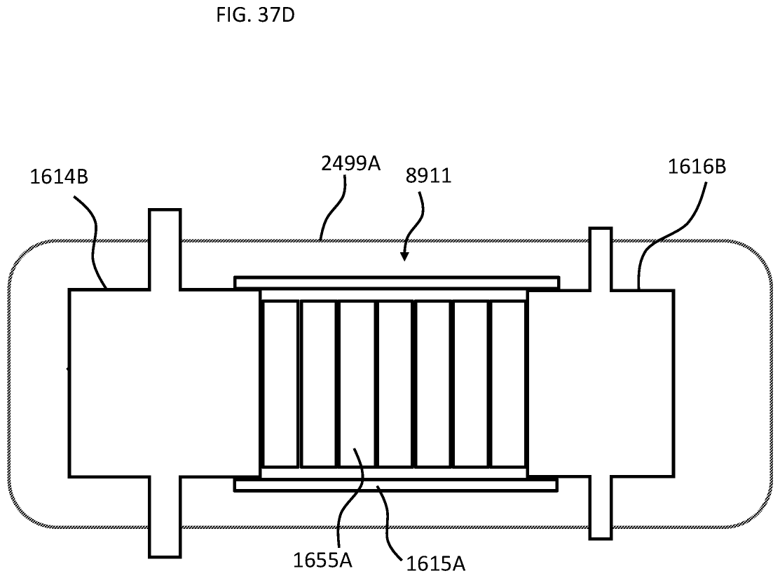

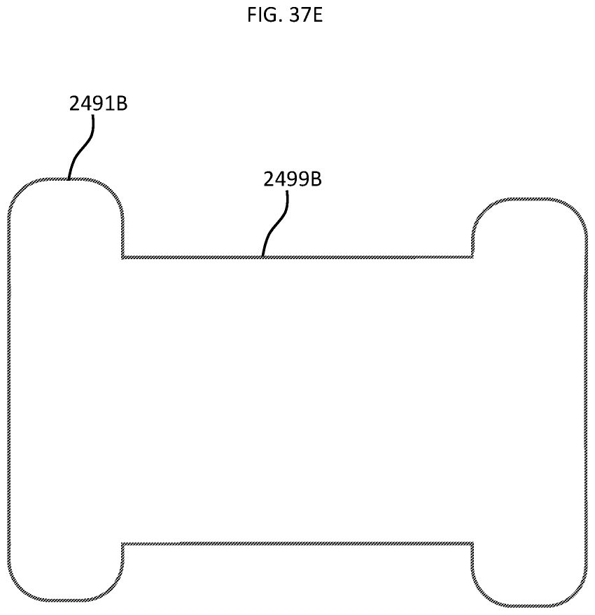

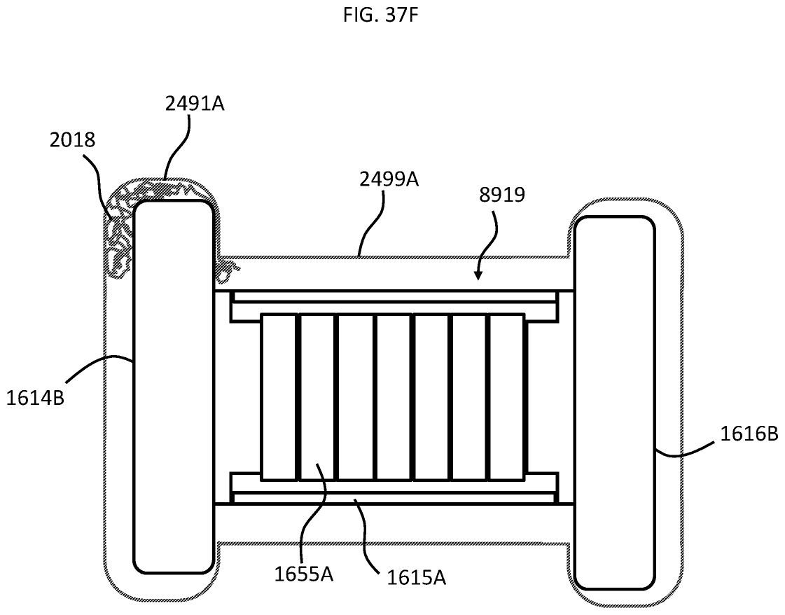

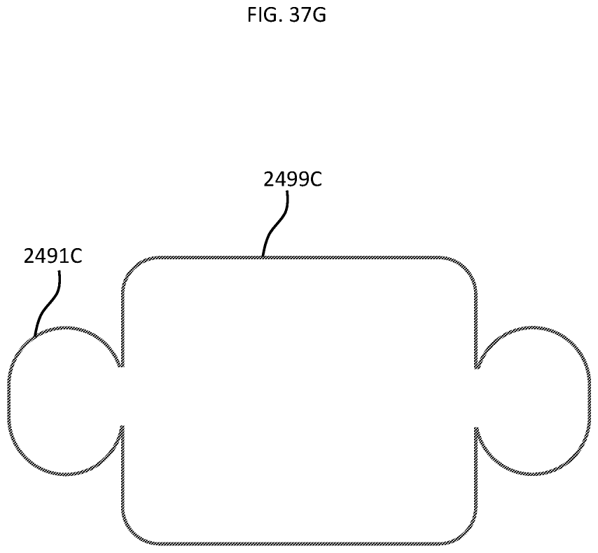

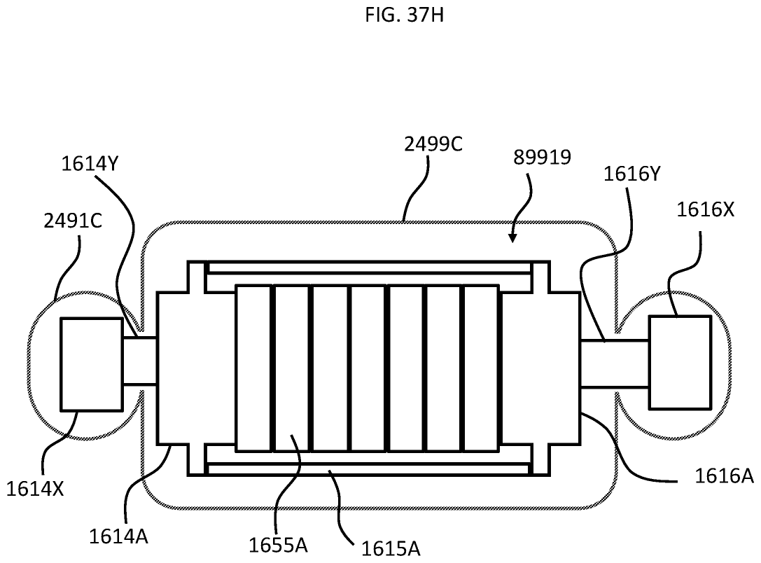

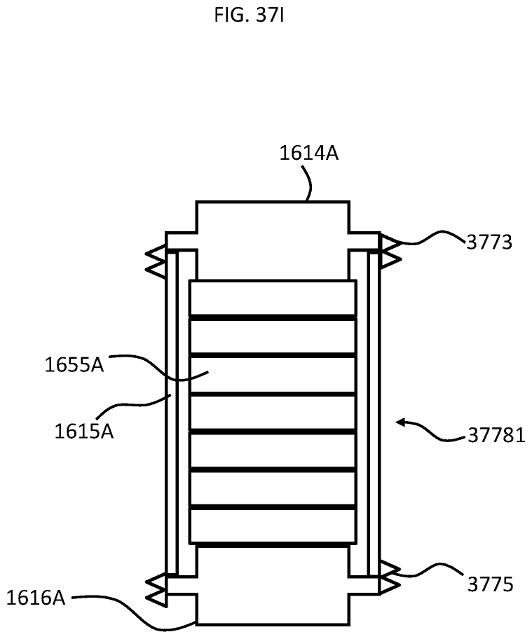

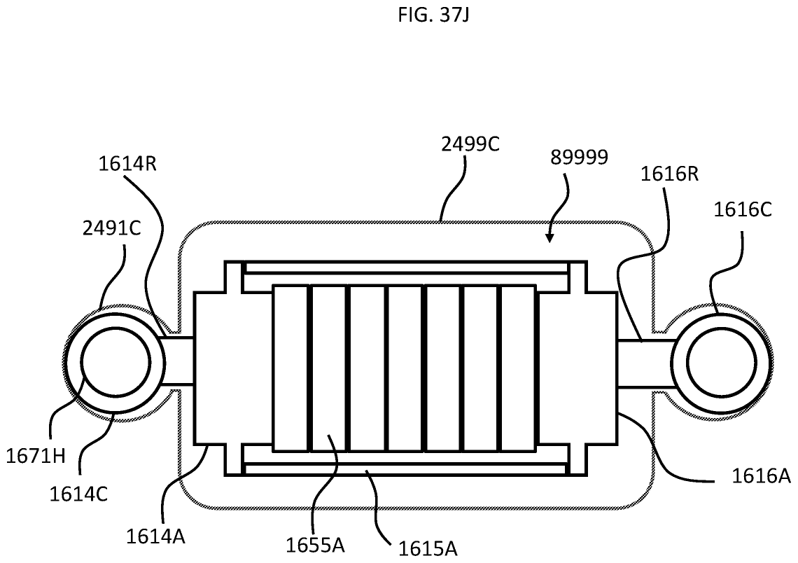

FIG. 37 provides another exemplary embodiment of the laterally oriented piezoelectric stack 3710, which in some embodiments does not use a piezoelectric element/stack that has a round outer section and/or expands laterally. Here, the stack is contained in the fixture 3777. The fixture 3777 differs from the other fixtures detailed above in that the sidewalls are relatively thin and thus flexible (the thinness can be the overall full surface or can be only local portions, depending on the utilitarian value thereof). In this regard, in an exemplary embodiment, the expansion and contraction of the piezoelectric stack expands the sidewalls 3777 as well, which expansion is conveyed to the bone in the direction of the arrows. This embodiment uses a stack that applies force at two separate and opposite locations, but not the bone in between those locations (at least not directly). Conversely, in an embodiment, a disk piezoelectric element (an element that has a disk shape) can be used to apply a force about a longitudinal axis 3773 fixture. This embodiment can have a single tissue interface device. That said, it could be that a two point arrangement could be implemented (the walls of the housing could extend away from the circumference of the disk at at least two locations so that there is space for expansion, and thus does not impart energy into the bone at those locations. A stack having a longitudinal axis could be oriented so that the longitudinal axis is parallel to the surface of the bone, and the housing could be disk shaped or cylindrical shaped, and expansion would apply a radial force at two portions of the disk (and not in between). And the wall of the disk could be weakened with local slots or areas of relative less material relative to the other locations of the disk. In an embodiment, an outer ring (forming sides of the housing) can be TiO blasted titanium which has utilitarian value with respect to osseointegration. A threaded option could have a higher contact force with the bone to maximize the osseointegration process relative to that which would otherwise be the case. On the other hand, the concept without thread could be press-fitted in a controlled bony hole (in that case the entering edges could be chamfered). In an embodiment, the stack is pre-mounted in the ring, and in some embodiments there is no need for cement (at least when osseointegration is to occur). In an embodiment, the arrangement of FIG. 37 can have a top to allow screwing into the bone with the appropriate driver. Note that in an embodiment, where the piezoelectric element(s) expands in the longitudinal axis, the piezo can be a round (cylindric) stack, or could be rectangular shaped (with a two point fixation as opposed to a single point fixation).

FIG. 37I shows an exemplary embodiment of an actuator 37781 that is a hybrid of the various devices herein. This can be utilized for the longitudinal actuator/the actuators that are inserted in a direction that is normal to the outer surface of the skull. That is, in an exemplary embodiment, this can be inserted into the passageway 2199 detailed above (e.g., the passageway of FIG. 34). Here, elements 3773 and 3775 are screw threads, and in some embodiments, self-tapping screw threads. In an exemplary embodiment, actuator 37781 is screwed into the passageway 2199. The threads act as the interface between the actuator and the skull bone. Actuation causes the top threads 3773 to move away from the bottom threads 3775 and vice versa. This has a similar principle of operation as the embodiments where the force of the actuator is outputted at the bottom surface. But here, the force of the actuator is outputted through the threads to the lateral sides of the passageway. The output is still compression in the longitudinal direction, it is just located on the sides. Still, in an embodiment, the end closest to the cochlea could include a bone interface body, such as a partial spherical titanium body that would interface with the bone. In this embodiment, the threads 3775 might be dispensed with, and instead there are only threads 3773. This arrangement can have utilitarian value with respect to ease of implantation. In an embodiment, the top end could include a screw driver interface, or an Allen wrench interface. This can be used to enable such tools to apply a torque to the actuator to the actuator can be screwed into the passageway and thus seated for proper utilization.

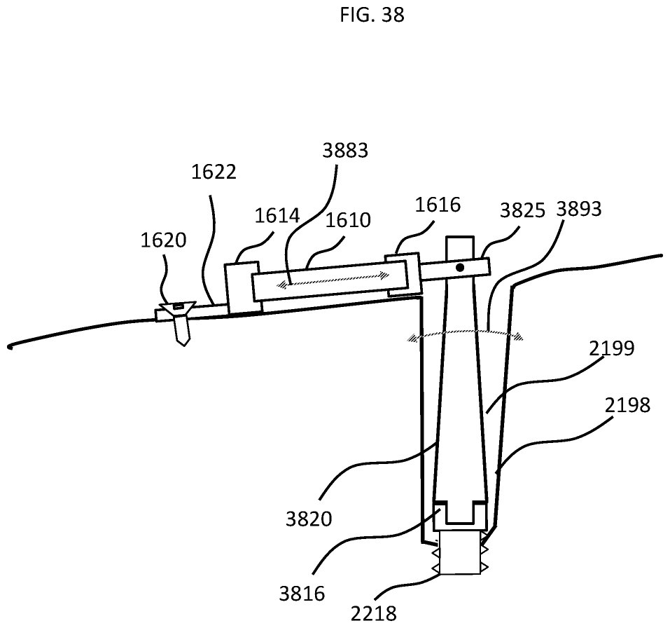

FIG. 38 presents another exemplary embodiment, where a horizontally mounted piezoelectric actuator 1610 (basically parallel to the surface of the skull) is utilized to impart a rocking motion on to a bone fixture 2218. More specifically, as shown, there is a back end bracket 1622 that is fixed to the skull by a bone screw 1620. The bracket 1622 is connected to another fixture 1614 which fixture holds the piezoelectric actuator 1610 at the back end. At the opposite end of the actuator 1610 is fixture 1616, which is connected to a lever arm interface 3825, which can be a fixture that has a hole therethrough through which lever arm 3820 extends in a slidable manner. In an exemplary embodiment, a pin is located through the lever arm interface 3825 and through the lever arm 3820 to enable the lever arm to pivot relative to the lever arm interface 3825. The reciprocating movement of the actuator 1610 in the longitudinal axis represented by arrow 3883 imparts a rocking motion on the lever arm 3820, represented by arrow 3893. This rocking motion is then imparted to fixture 3816 which is rigidly connected to bone fixture 2218. Because fixture 3816 is rigidly connected to the lever arm 3820, the rocking motion is transferred to the bone fixture. This loss imparts energy into the bone at a location near the cochlea concomitant with the above noted embodiments that utilize the actuator in the vertical position/more normal direction relative to the surface of the bone. In an embodiment, the piezoelectric component 3710 is a stack, as opposed to a round component that expands radially in all directions (the stack expands along a line axis). In an embodiment where there is a longitudinal stack, the walls of 3777 can be weakened by local slots at the location of the piezo front and back end (and be locally thinner as well). In this concept the outer ring can be TiO blasted titanium, and thus configured for optimization for osseointegration. In this regard, an embodiment that uses threads can have a higher contact force with the bone to maximize the osseointegration process. FIG. 37A shows such an embodiment vis-à-vis device 3377A. That said, the concept without thread could be press-fitted in a controlled bony hole (in that case the entering edges could be chamfered), such as device 3377B of FIG. 37B. In an embodiment, the stack is pre-mounted in a ring body, and there is no need for cement. Embodiments include a feature at the top of the implant that can interface with a screw driver or a wrench (e.g., an Allen wrench) to permit the device to be screwed into a hole in the bone, such as opening 3721. In an embodiment, there is thus an apparatus that is mounted in a bore in a skull, the bore having a circular cross-section lying on a plane normal to a longitudinal axis of the bore, where the bore can be established using a drill bit and/or a reamer (instead of a ball drill). In an embodiment, the bore can be established using standard practice for the implantation of a bone fixture for a percutaneous bone conduction device or an implantable portion of a transcutaneous bone conduction device. Indeed, in an embodiment, the device 3777A, etc., can be a self tapping device. In an embodiment, the entire deice “fits” within a cylinder that has a diameter that is less than 15, 14, 13, 12, 11, 10, 9, 8, 7, 6 or 5 mm or any value or range of values therebetween in 0.1 mm increments and/or having a length that is less than 10, 9, 8, 7, 6, 5, 4, or 3 mm or any value or range of values therebetween in 0.1 mm increments. In an embodiment, these dimensions are applicable to the hole in the bone that is created for the device.

FIG. 37C presents an actuator assembly 8910 of another embodiment located in the excavation 2499A, parallel to the surface of the skull, although this embodiment could be used with the embodiments that are more perpendicular to the surface of the skull. (Note that the receiver coil and the implanted electronics that receive the signal from the coil and develop a control signal for the actuator are not shown—embodiments can use the receiver/receiver coil of the implants of the embodiments of FIGS. 2-6 noted above/use the configuration of FIG. 17.) The actuator assembly 8910 has parallels to the device of FIG. 18 above. In this embodiment, the piezoelectric stack 1655A expands and/or contracts to move end fittings 1616A and 1614A at the ends of housing wall 1615A. The stack is located inside a housing 1615A (the components of FIG. 37C have circular cross-sections and/or square or rectangular or oval shape cross-sections (any cross-section that has utilitarian value can be used), and are symmetric about the longitudinal axis of the actuator). In some embodiments, the housing 1615A is a closed cylinder fit to fittings 1614A and 1616A, where the housing is sufficiently flexible to enable the expansion and contraction of the piezoelectric stack 1655 to expand/contract the locations of the fittings relative to each other. In an exemplary embodiment, the housing 1615A is an open cylinder (top and/or bottom) and the piezoelectric stack comes into direct contact with the fittings 1616A and/or 1614A. The housing is sufficiently structurally weak (where the phrase weak is not utilized as a pejorative, but simply to differentiate from something that is structurally very strong) or otherwise sufficiently compliant so that the housing will expand with the expansion of the piezoelectric stack.

The fittings can be made of titanium, or any suitable material. Any material that can have high mechanical impedance (such as equal to or higher than the bone to which it interfaces) can be used in some embodiments. As seen, the fittings have flanges/protrusions jutting out beyond the walls of the housing. In an embodiment, the apparatus 8910 is placed into an excavation 2499A which has four (4) “indentation” 2491A as seen. In practice, bone cement 2018 is placed in the indentations and around the protrusions to “lock” the actuator apparatus in place in the excavation. Here, this provides bone cement in the form of a lateral support as opposed to the longitudinal support arrangement described above. As seen, the indentations may not be uniform in the bone. The indentations can be uniform in the bone in some embodiments.

In an embodiment, bone cement can be used at the longitudinal ends as well.

FIG. 37D shows another embodiment of an actuator assembly 8911, where the fixtures 1614B and 1616B have protrusions that fit into the sides of the bone by forcing those protrusions into the bone, thus providing reaction points for the actuator assembly. Bone cement could also be used in some embodiments. Indeed, in an embodiment, bone cement is provided on the sides and the ends of the fixtures.

FIG. 37E presents a bone excavation/cutout according to an embodiment, where a surgeon utilizes a ball drill or a router drill bit in a template to carveout the shape shown. In this regard, the view of FIG. 37E is looking downward on to the surface of the skull, wherein this embodiment, this is an excavation for a parallel mounted actuator. As seen, the excavation includes an elongate section 2499B and laterally extending sections 2491B which extend further out past the lateral sides of the elongate section. In an exemplary embodiment, there is an actuator assembly 8919 of another embodiment located in the excavation, as seen in FIG. 37F, again, parallel to the surface of the skull, although this embodiment could be used with the embodiments that are more perpendicular to the surface of the skull. (Note that the receiver coil and the implanted electronics that receive the signal from the coil and develop a control signal for the actuator are not shown—embodiments can use the receiver/receiver coil of the implants of the embodiments of FIGS. 2-6 noted above/use the configuration of FIG. 17.) The actuator assembly 8919 has parallels to the device of FIG. 18 above. In this embodiment, the piezoelectric stack 1655A expands and/or contracts to move end fittings 1616B and 1614B at the ends of housing wall 1615A. The stack is located inside a housing 1615A (the components of FIG. 37F have circular cross-sections and/or square or rectangular or oval shape cross-sections (any cross-section that has utilitarian value can be used), and are symmetric about the longitudinal axis of the actuator). In some embodiments, the housing 1615A is a closed cylinder fit to fittings 1614B and 1616B, where the housing is sufficiently flexible to enable the expansion and contraction of the piezoelectric stack 1655 to expand/contract the locations of the fittings relative to each other. In an exemplary embodiment, the housing 1615A is an open cylinder (top and/or bottom) and the piezoelectric stack comes into direct contact with the fittings 1616B and/or 1614B. Features of the housing and piezoelectric component can be the same as described above.

The fittings can be made of titanium, or any suitable material. Any material that can have high mechanical impedance (such as equal to or higher than the bone to which it interfaces) can be used in some embodiments. As seen, the fittings have flanges/protrusions jutting out beyond the walls of the housing. In an embodiment, the apparatus 8919 is placed into the excavation of FIG. 37E, which has the laterally extending openings. In practice, bone cement 2018 is placed in the laterally extending excavation portions and around the protrusions to “lock” the actuator apparatus in place in the excavation (see FIG. 37F). In this embodiment, the bone cement is placed at four discrete locations, one of which is shown in the interests of economy (the concept of the bone cement would be duplicated the three other protrusions). That said, in an embodiment, the bone cement could extend from one side of the actuator to the other side of the actuator essentially for all intents and purposes filling the end portions of the excavation, and this would be duplicated for the other end of the actuator as well.

FIG. 37G shows another excavation according to another exemplary embodiment, again for a parallel actuator. Here, there is an elongate section 2499C, and two oval or generally cylindrical (with respect to a direction into the bone) sections 2491C. (This could be done with a ball-drill, but could end up oval. There could be a neck portion between cavity 2491C and 2499C. In an exemplary embodiment, the sections can be drilled utilizing a router or a drill or the like. And to be clear, while the embodiments show a generally uniform excavation with smooth surfaces, the surfaces can be more rough/less uniform. For example, the excavations can be made by making a series of plunging actions with a circular drill bit, in which case the sidewalls might be moon shaped or partial circular shaped, etc., or at least would have clear evidence where the drill was respectively driven into the skull. In any event, as can be seen, there are narrower channels between the main excavation and the two side excavations. That said, in some embodiments, this may not necessarily be the case. Still, in some embodiments, these channels provide utilitarian value with respect to “locking” the actuator in place. And in this regard, FIG. 37H shows an exemplary actuator 89919 that has features that correspond to the embodiments described above with respect to similar reference numbers, except that the respective end fixtures include two cylinders. On the left side, a cylinder 1614Y extends from fixture 1614A. Attached to that cylinder is a cylinder 1614X (the cylinders extend about the longitudinal axis of the actuator). On the opposite side, there is cylinder 1616 Y to which is attached cylinder 1616X. The cylinders 1614Y and 1616Y a sufficiently narrow to fit into the opening between the elongate excavation 2499C and the end excavations 2491C. The outboard most cylinders 1614X and 1616X have a diameter that is larger than the passageway as can be seen. In an exemplary embodiment, the actuator is fitted in through the top opening of the excavation, and then bone cement is placed in to the excavations 2491C. In an embodiment, the excavations 2491C are filled with bone cement. In an embodiment, some bone cement can enter the excavation 2499C. Indeed, in an embodiment, the bone cement could flow out of the end excavations into the elongate excavation around the actuator to the sides of the actuator. The bone cement could extend along the sides a bit. Indeed, in an exemplary embodiment, all the excavations can be filled with bone cement. In an embodiment, the sides of the actuator have a surface that is smooth and is nonstick or otherwise is of a low friction character so that when the actuator expands and contracts, the forces are not transferred to the lateral sides of the excavation, or at least the forces that are transferred are de minimus. Conversely, because the cement at the ends or otherwise the cement that is located within the shadow of the actuator (when viewed longitudinally—the cement at the ends that would be eclipsed by the actuator when looking longitudinally) will be in compression when the actuator is actuated, the force will be transferred from the actuator into the cement and then into the bone. Put another way, the actuator effectively slides in a tunnel of bone cement, but “smacks into” the bone cement at the ends. Thus, in an embodiment, there is an actuator that includes interface arms (the cylinders 1614X and 1614Y shown in FIG. 37H, which can be TiO blasted cylinders) that fit into the predrilled holes.

FIG. 37J presents a variation of the embodiment of FIG. 37H. Here, the actuator 89999 includes rectangular extensions 1614R and 1616R as opposed to cylindrical extensions. These extensions are connected to cylinders 1614C and 1616C, which cylinders have their longitudinal axis normal with the surface of the skull. In this exemplary embodiment, the actuator 89999 is press fitted into the excavations ever so slightly (or the greatest amount that can be achieved while permitting the actuator to be put therein by a surgeon) or slip fitted therein. In an exemplary embodiment, the excavations 2491C are established utilizing a drill template having bushings that are precisely aligned with each other and are sized and dimensioned to result in a bone excavation at those two locations that creates the after mentioned slight interference fit and/or slip fit (the bushings would have their longitudinal axis normal to the surface of the skull, or relatively normal thereto in some embodiments). The excavations 2491C are thus cylindrical (resulting from the drill bit/boring tool being drilled into the skull at two locations at the two drill bushings). Embodiments thus include a drilling template that has two bushings precisely and rigidly retained relative to one another and aligned so that the bushings, which can be drill bushings, will guide a drill bit into the bone to establish the excavations 2491C as cylinders precisely aligned with each other and precisely distanced from each other. After this, a more course operation can be utilized to establish the excavation 2499C and the openings there from into the excavations 2491C. As seen in this exemplary embodiment of FIG. 37J, there can be neck portions between the excavations 2491C and the excavation 2499C, and these necks can be loosely tolerance or otherwise “sloppy”, as with the excavation 2499C, thus making the excavation process relatively simple and straightforward (after the cylinder holes 2491C are drilled, a ball drill of smaller diameter than the cylinders can be inserted into the holes 2491 and then drilled outward to form the neck and the excavation 2499C. In this exemplary embodiment, because the excavations 2491C will be precisely drilled relative to each other, and thus relative to the actuator, when the actuator is placed into the excavations, the cylinders 1614C and 1616C will contact the sidewalls of the excavations 2491C, or be relatively very close.

In an embodiment, the cylinders have holes 1671H therein (in other embodiments they do not). In an exemplary embodiment a screw or a press fit slug or cylinder or bolt can be placed into the holes to expand the outer diameter of the cylinders 1614C and or 1616C. This will create an interference fit or otherwise establish the cylinders against the bone of the excavations 2491C is shown in FIG. 37J. This can create radial preloading of the cylinders 1614C and 1616C. This can have utilitarian value with respect to simplifying or otherwise making the excavation process relatively straightforward while still providing a high level of accuracy.

Thus, in view of the embodiment of FIG. 37D for example, embodiments include an apparatus, wherein the first tissue interface has laterally spaced protrusions, the second tissue interface has laterally spaced protrusions, the apparatus is configured to connect with bone via the protrusions. The apparatus can include a first tissue interface that is a lateral tissue interface and a second tissue interface that is a lateral tissue interface. Conversely, in view of FIG. 38J, there is an apparatus, wherein the first tissue interface has an axial spaced protrusion, the second tissue interface has an axial spaced protrusion and the apparatus is configured to connect with bone via the protrusions. The apparatus can include a first tissue interface that is an axial interface, and a second tissue interface that is an axial interface. This arrangement may or may not utilize bone cement. In embodiments that utilize bone cement, the bone cement will not be in compression per se, or otherwise the amounts will be in more limited compression than that which would be the case if the bone cement was completely between the actuator and the bone. In some embodiments, the bone cement simply holds the actuator in place as opposed to providing a reaction body that transfers the forces of the actuator to the bone. In an embodiment, the screws do not necessarily hold the actuator in place per se (the screws may not extend into the bone—in an embodiment, they are more bolts than screws—these are components that are utilized to increase the outer diameter of the cylinders), while in other embodiments, the screws provide a limited amount of stability to the actuator, but are not utilized to impart forces on to the bone when the actuator is actuator.

While embodiments above have focused on the utilization of a screw or a slug to expand the cylinders (the slug could be conical, and thus wedging the cylinder surfaces outward as it is inserted, or the slug could be chilled to fit into the hole, and then as it warms, the slug expands, thus expanding the cylinder), in other embodiments, the actuator could be chilled to cause shrinkage, or the piezoelectric stack could be contracted by an amount that would not normally exist or otherwise would never exist during normal operation of the actuator (say applying a higher voltage than would be used by the device when evoking hearing percepts). Thus, the overall dimensions of the actuator would be reduced relative to that which would be the case in its normal operating state or normal passive state, and thus would permit the aforementioned slight interference fit or slip fit. Any arrangement that can have utilitarian value that can enable the teachings detailed herein can utilize at least some exemplary embodiments.

In an embodiment, the surfaces of the cylinders 1614C can be roughened or otherwise provided with a feature that enhances osseointegrated. TiO blasting of the surface could be executed. In an embodiment, threads or grooves etc. can be located on the outside of the cylinders, although the threads are not utilized in the traditional manner. In this regard, when the cylinders are expanded, the threads could “dig into” the bone, thus creating additional stability and otherwise potentially enhancing osseointegration. Any surface treatment that can have utilitarian value with respect to enhancing the securement or otherwise the interface between the actuator and the bone can be utilized in at least some embodiments.

It is briefly noted that while the embodiment of FIG. 37J shows holes in the cylinders, in other embodiments, those holes are not located therein. In an embodiment, the cylinders are solid and very hard components. Still, embodiments include bodies that can be radially preloaded to “press” the actuator to the sides of the bone (so that when the actuator is non-energized/at rest/at its most contracted position that will exist during normal use, the actuator is always under compression by the bone).

In the embodiment of FIG. 38, the components of the bone fixture, the fixture attached thereto, and the lever arm are all very stiffly connected relative to one another so that the apparatus moves essentially as a single unit. Also as can be seen, the lever arm 3820 is tapered so as to limit any bending of the lever arm. In an exemplary embodiment, instead of a taper, a full width lever arm can be utilized in such will limit bending to a degree that is utilitarian to outweigh the increased material weight associated with such a lever.

The point is that the horizontal movement of the piezoelectric stack can be converted to a rocking movement near the cochlea which can provide for bone conduction vibrations in accordance with the teachings detailed herein.

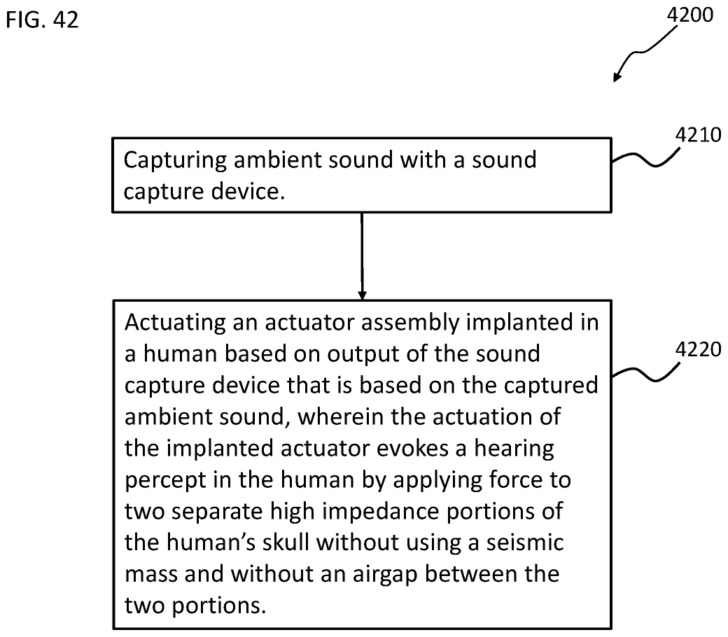

FIG. 42 shows an exemplary algorithm for an exemplary method, method 4200, which includes method action 4210, which includes the action of capturing ambient sound with a sound capture device. This can be executed with the external component microphone or in the case of a totally implantable hearing prostheses, an implanted microphone. Method 4200 further includes method action 4220, which includes actuating an actuator assembly implanted in a human based on output of the sound capture device that is based on the captured ambient sound, wherein the actuation of the implanted actuator evokes a hearing percept in the human by applying force to two separate high impedance portions of the human's skull without using a seismic mass and without an airgap between the two portions. In an embodiment, the actuator assembly is an implanted seismic-massless and airgapless actuator assembly (airgapless in the actuation direction/between the two points of fixation—this as distinguished from the actuator of FIG. 9, where there is an airgap between the seismic mass and the bone (or more accurately, the direction of movement towards and away from the bone/output direction) and distinguished from an electromagnetic actuator where there is an airgap that enables actuation—it is noted that a spring is not an airgap, as there is solid material in the path between the “moving” part (the stack does not move much at all) and the fixation locations) implanted in a human based on output of the sound capture device that is based on the captured ambient sound, wherein the actuation of the implanted actuator evokes a hearing percept in the human by applying force to two separate high impedance portions of the human's skull (separate by distance/physically separated). In at least some of these exemplary embodiments, the hearing percept that is evoked is a bone conduction hearing percept.

With regard to airgaps, a seismic mass based actuator, such as a type 1 actuator, will have an airgap in the direction of movement of the mass—the force outputted requires the mass to accelerate and then decelerate over a distance, to create output force, and thus there must be clearance for the mass to move (and thus the piezoelectric bender to move or the moving component of an electromagnetic actuator, such as that disclosed in U.S. Patent Application Publication No. 2019/0215625, to Kristian Asnes of Sweden, published on Jul. 11, 2019—this patent application shows the outboard mass/yokes moving upward and downward—that requires the airgap). Further, with respect to the type 1 actuators, that are stroke based, the electromagnetic vibrator moves in a manner similar to the just-mentioned publication, and with a piezoelectric actuator, there is still a need for movement (to achieve the stroke), and thus there will be an air gap. This as contrasted to the actuators herein, which move minimally. Indeed, in an embodiment, because of the lack of airgap, a total expansion of the piezoelectric component at a given voltage (including a maximum voltage applyable by the implant), is at least 50, 60, 70, 80, 90, 91, 92, 93, 94, 95, 96, 97, 98 or 99% or more or any value or range of values therebetween in 0.1% increments less than that which would be the case if one or both fixation ends were free (effectively simulating an air gap). Again, the high mechanical impedance limits the movement (if one or both ends were connected to low impedance components, there would be more movement).

As seen above, there is no seismic mass associated with the actuator. This is distinguished from, for example, the mass 553 of the component 550 FIG. 8 above. Granted, the actuator 250 above with respect to the middle ear implant is a seismic massless actuator. However, as shown above, the output is not applied to two separate high impedance portions of the human's skull (more on this in a moment).

In an exemplary embodiment, the total mass of the actuator assembly that is moved amounts to the mass of the piezoelectric stack and potentially one or both of the fixture that support the piezoelectric actuator, and maybe the actuator housing. In another embodiment an external mass (outside the actuator housing) could be added at the back-end fixation or to the casing. There is s an embodiment where an adjustable screw is inserted through a bone implant to apply preload to the actuator/stack. Subsequently a mass is fixed on top of the bone implant.

All of these components are de minimus with respect to seismic mass and would not be considered a seismic mass as that phrase is understood in the art.

With respect to an airgapless actuator, again we refer to the implantable component 550 of FIG. 9 for the purposes of distinguishing this feature where there is a gap between the mass 553 and the wall of the housing 554, the ramifications thereof as clearly being seen in FIG. 9. Without the air gap the device will not work. This is completely different from the device of FIG. 16 for example.

With respect to high impedance tissue, again by contrast, the end closest to the cochlea of the actuator of the embodiment of FIG. 2A is attached to a movable component, the window of the cochlea, and the embodiment of FIG. 2B is attached to the ossicles which also move. These are low impedance tissue components. Soft tissue is also low impedance tissue component.

In an exemplary embodiment, a Young's modulus of the tissue where the actuator assembly makes contact is at least and/or equal to 1, 2, 3, 4, 5, 6, 7, 8, 9, 10, 11, 12, 13, 14, 15, 16, 17, 18, 19, 20 MPa, or any value or range of values therebetween in 0.1 MPa increments (e.g., 5 to 10 MPa). Indeed, in an embodiment, a Young's modulus of cortical bone can bet between 5 to 25 GPa (inclusive) or any value or range of values therebetween in 0.1 GPa increments. At least some of these values can correspond to high impedance tissue.

In an exemplary embodiment, if the tissue was moved by 125, 150, 175, 200, 250, 300, 350, 400, 450, or 500% or more of the amount moved by the actuator during normal operation, permanent fracture and/or deformation (plastically) would result. Conversely, if the actuator contemplated herein were applied to soft tissue or a moving tissue such as the ossicles), no problems would result/no permanent deformation or fracture would exist.

In an exemplary embodiment, the two separate high impedance portions are separated by at least 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 mm, or more or any value or range of values therebetween in 0.1 mm increments. The distances can be measured from the portions directly beneath the geometric centers of the tissue interface surfaces and/or can be measured from the closest boundaries of the tissue interface surfaces. In at least some exemplary embodiments, the back end of the implanted actuator applies a force to a portion of the skull that has mechanical impedance higher than or equal to the other portion of the skull.

In at least some exemplary embodiments, actuation of the actuator includes expanding the actuator by a first distance to move a first bone interface component and a second bone interface component rigidly linked to the actuator by a second distance, the second distance being at least 95% of the first distance.

Also, in at least some exemplary embodiments, actuating the actuator is executed in a d33 mode (or any other type of mode in some other embodiments)/to achieve a d33 effect, to deliver an output of at least +−1, 1.5, 2, 2.5, 3, 3.5, 4, 4.5, 5, 5.5, 6, 7, 8, 9, 10, 15, 20, 25 or 30 N/V, or any value or range of values therebetween in 0.1 N/V increments over a frequency range extending from 500 Hz to 20,000 Hz or any value or range of values therebetween in 1 Hz increments (e.g., 200 to 2,000 Hz, 500 to 5,000 Hz, etc.). In an embodiment, the device is a dedicated low frequency range device, such as a device having frequencies in the range of 300 to 1000 Hz (inclusive). In an embodiment, the device is a medium or high frequency device (dedicated medium or high frequency device/medium frequency range/high frequency range device). This as distinguished from a device that merely can operate at all frequencies. Note that a dedicated device can still operate at other frequencies. It simply is designed/optimized to operate best (focus) at certain frequencies.

In view of the above, it can be seen that in some embodiments, there is, compared to existing piezo bender-mass and/or electromagnetic concepts, a compact actuator with a relatively very small formfactor that is a relatively robust actuator (with relatively high shock, impact and handling resistance, no sensitive front-end).

Note that in some embodiments, the teachings herein are fully MRI compatible, with respect to the entire actuator and/or the actuator assembly, at least for a 1 T, 1.5 T, 2 T, 2.5 T, 3 T, 3.5 T, 4 T, or 4.5 T MRI, or any value or range of values therebetween in 0.1 T increments.

The teachings herein provide an actuator that has a reduced number of components and complexity relative to the actuators of FIGS. 2-9, and provide for relatively high levels of shock and RF damping scenarios. Also seen is that high force generation at high and low frequencies (there will be less at mid frequencies in some embodiments) over a wide audio range can be provided relative to at least type 1 actuators, and, in some embodiments, there is no or at least substantially limited (relative) eigenfrequencies. The teachings herein provide for relative high coupling (and performance) consistency and relative consistent surgical implementation (coupling between stable points—as opposed to coupling to a moving tissue) without the risk of damaging sensible mechanical structures (e.g., ossicles).

The teachings herein can be utilized in a recess in the skull to address more effective stimulation sites closer to the cochlea, such as, for example, the lateral semicircular canal (LSSC), or the site superior to Stylomastoid Foramen (SSF). The SSF site allows for fixation of a bone screw or bone implant which can provide an even more stable coupling of the actuator front-end, this is rather exceptional for a deep recessed actuator concept sitting close(r) to the cochlea.

The teachings herein also provide for local (and deeper-in-skull) bone stimulation relative to the embodiments of the type 1 actuator noted above.

Embodiments include utilizing the actuator assemblies detailed herein as part of a hybrid system/multi-modal system that includes another type of hearing prostheses, such as a cochlear implant and/or a middle ear implant and/or even another type of bone conduction device and/or an acoustic hearing aid. In an exemplary embodiment, high-frequency and/or medium frequency stimulation is done electrically, such as by a cochlear implant, and low-frequency stimulation and/or medium frequency stimulation is applied with an embodiment of the actuator assemblies detailed herein. Further, by applying the surgical solutions detailed herein, the operation occurs close of the cochlea, concomitant with the access that would be required for a cochlear implant. Indeed, the same mastoidectomy/posterior tympanotomy access actions used for cochlear implant implantation can be utilized to implant the actuator assemblies detailed herein. Still, in other embodiments, there will be separate excavations in the bone, one for the piezoelectric actuator, and one for the cochlear implant. Still further, in embodiments, there are less invasive surgical procedures that might be implemented for implanting the cochlear implant, and thus the teachings herein can be combined with such procedures. Accordingly, embodiments include a multimode or a hybrid hearing prosthesis that includes a cochlear implant electrode array and otherwise a cochlear implant in combination with an embodiment of the actuators detailed herein. That said, the prostheses can be two separate prostheses entirely, that are simply used with one another simultaneously. Still, embodiments include a central sound processor/a shared sound processor, that processes the captured sound and then divides up the stimulation output depending on what frequencies are desired to be outputted by the different hearing evoking devices, or at least a shared microphone or sound capture system. In an exemplary embodiment, the frequencies at and/or below 500, 600, 700, 800, 900, 1000, 1250, 1500, 1750, 2000, 2250, 2500, 2750, 3000, 3250, 3500, 3750 or 4000 Hz or any value or range of values therebetween in 1 Hz increments are provided to the recipient by the actuator device described herein, and those above by a cochlear implant, whether separately as separate prostheses or as an integrated prostheses. In an embodiment, there can be overlap between the frequencies (the actuator is limited by the just-noted frequencies or the cochlear implant is so limited). In an embodiment, there can be a 100, 200, 300, 400, 500, 600, 700, 800, 900, 1000, 1250, 1500, 1750 or 2000 Hz or any value or range of values therebetween in 1 Hz increments overlap between the two.

Also, pediatric implementations can be utilized, at least with a compliant component (e.g., spring)-loaded and/or adjustable anchor point(s).

Any disclosure of a device and/or system detailed herein also corresponds to a disclosure of otherwise providing that device and/or system and/or utilizing that device and/or system.

Any disclosure of an embodiment that has a functionally corresponds to a device configured to have that functionality, and also corresponds to a method that results in the functionality/includes the actions associated with the functionality, and vice versa.

Any embodiment or any feature disclosed herein can be combined with any one or more or other embodiments and/or other features disclosed herein, unless explicitly indicated and/or unless the art does not enable such. Any embodiment or any feature disclosed herein can be explicitly excluded from use with any one or more other embodiments and/or other features disclosed herein, unless explicitly indicated that such is combined and/or unless the art does not enable such exclusion.

Any function or method action detailed herein corresponds to a disclosure of doing so an automated or semi-automated manner.

Any disclosure herein of any component and/or feature can be combined with any one or more of any other component and/or feature disclosure herein unless otherwise noted. Providing that the art enables such. Any disclosure herein of any component and/or feature can be explicitly excluded from combination with any one or more or any other component and/or feature disclosed herein unless otherwise noted, providing that the art enables such. Any disclosure herein of any method action includes a disclosure of a device and/or system configured to implement that method action. Any disclosure herein of a device and/or system corresponds to a disclosure of a method of utilizing that device and/or system. Any disclosure herein of a manufacturing method corresponds to a disclosure of a device and/or system that results from the manufacturing method. Any disclosure of a device and/or system corresponds to a disclosure of a method of making a device and/or system.

While various embodiments of the present invention have been described above, it should be understood that they have been presented by way of example only, and not limitation. It will be apparent to persons skilled in the relevant art that various changes in form and detail can be made therein without departing from the spirit and scope of the invention.

1. An apparatus, comprising:
an actuator;
a first tissue interface device; and
a second tissue interface device spaced away from the first tissue interface device, wherein
the apparatus is at least a partially extra-middle ear cavity dual bone interface force based implantable tissue stimulation portion of a hearing prosthesis.

2. The apparatus of claim 1, wherein:
the apparatus is a totally extra-middle ear cavity implantable tissue stimulation portion of the hearing prosthesis.

3-5. (canceled)

6. The apparatus of claim 1, wherein:
the actuator includes a piezoelectric stack that is at least 5 mm in length.

7. The apparatus of claim 1, wherein:
the apparatus is configured to compensate for and/or enable at least minimally invasively compensate for pediatric growth of the skull and/or bone adaptation to the apparatus.

8. (canceled)

9. The apparatus of claim 1, wherein:
the apparatus is a bone conduction device.

10-14. (canceled)

15. The apparatus of claim 1, wherein:
the first tissue interface is a lateral tissue interface; and
the second tissue interface is a lateral tissue interface.

16. (canceled)

17. The apparatus of claim 1, wherein:
the first tissue interface is an axial interface; and
the second tissue interface is an axial interface.

18. An apparatus, comprising:
a piezoelectric actuator;
a first tissue fixation device; and
a second tissue interface device spaced away from the first tissue fixation device, wherein
actuation of the actuator moves the first tissue fixation device relative to the second tissue interface device,
the first tissue fixation device is attached to a first portion of skull bone of a recipient mammal of the actuator,
the second tissue interface device abuts a second portion of skull bone that is fixed relative to the first portion of skull bone, and
at least one of:
the first portion of the skull bone and the second portion of the skull bone is a same part of the skull;
the first tissue fixation device is above a natural outer surface of the skull or within 10 mm of the natural outer surface of the skull;
all of the apparatus is located at least 5 mm away from a cochlea of the recipient; or
the bone to which the first tissue fixation device is attached and/or the bone to which the second tissue fixation device abuts has a thickness of at least 4 mm directly beneath the respective devices.

19. The apparatus of claim 18, wherein:
the part of the skull is the temporal part of the skull.

20-22. (canceled)

23. The apparatus of claim 18, wherein:
the first portion is located outside a middle ear cavity of the recipient.

24-25. (canceled)

26. The apparatus of claim 18 wherein the apparatus is mounted so that relative to a plane extending parallel to and lying on a general axis of an ear canal of the recipient, the first tissue interface is on one side of the plane and the second tissue interface is on another side of the plane.

27. The apparatus of claim 18 wherein the apparatus is mounted so the first tissue interface is on one side of a coronal plane and/or a transverse plane of the recipient, and the second tissue interface is on another side of the coronal plane and/or the transverse plane.

28. The apparatus of claim 18 wherein the apparatus is attached to the skull so that a direction of actuation of the actuator is generally normal to a general longitudinal axis of an ear canal of the recipient.

29-31. (canceled)

32. The apparatus claim 18 wherein the apparatus is mounted in a skull excavation that has a length that is longer than a width.

33. (canceled)

34. An apparatus, comprising:
an actuator;
a first tissue interface device; and
a second tissue interface device spaced away from the first tissue fixation device, wherein
the apparatus is an implantable portion of an active transcutaneous bone conduction device configured to operate over an output range up to at least 10 kHz,
when the apparatus is in free space, the first tissue interface device moves relative to the second tissue interface device when the actuator is actuated,
the second tissue interface device is a bone penetrating component, the second tissue interface device being a front end interface device relative to the actuator, and
output of the actuator is between the first tissue interface device and the second tissue interface device.

35. The apparatus of claim 34, wherein:
the bone penetrating component is a bone screw.

36. The apparatus of claim 34, wherein:
the bone penetrating component is a bone fixture, with or without thread; and
the bone fixture is configured to promote osseointegration.

37-39. (canceled)

40. The apparatus of claim 34, wherein:
the apparatus is a stroke output and force output apparatus.

41. The apparatus of claim 34 wherein the apparatus is implanted in a recipient so that a vector of actuation of the actuator extends through an ear canal of the recipient.

42. (canceled)

43. The apparatus of claim 34 wherein the apparatus is implanted in a recipient in an artificial cavity in a skull, wherein at least two opposite sides of the apparatus are mechanically decoupled from the skull.

44-63. (canceled)
